(19) United States
(12) Patent Application Publication
(10) Pub. No.: US 2015/0378674 A1
(43) Pub. Date: Dec. 31, 2015

(54) CONVERTING NUMERIC-CHARACTER STRINGS TO BINARY NUMBERS

(71) Applicant: John W. Ogilvie, Sandy, UT (US)

(72) Inventor: Eric J. Ruff, Charlotte, NC (US)

(21) Appl. No.: 14/846,953

(22) Filed: Sep. 7, 2015

Related U.S. Application Data
(63) Continuation-in-part of application No. 14/425,046.
(60) Provisional application No. 62/058,362, filed on Oct. 1, 2014.
(60) Provisional application No. 61/701,630, filed on Sep. 15, 2012.
(60) Provisional application No. 61/716,325, filed on Oct. 19, 2012.

(51) Int. Cl. G06F 5/00

(52) U.S. Cl. CPC G06F 5/00

(57) ABSTRACT

Improvements to the functioning of computers include algorithms and data structures for specific focal aspects of conversion from character strings to numeric values. Tables used include a Doubles10 table, BaseTbl, TensTbl, and others. Algorithms convert floating-point character strings into doubles or integers; process whitespace, signs, leading zeroes, and invalid characters; use addition instead of multiplying or shifting; use particular processor registers to advantage; eliminate some overflow testing; use few MULTIPLY commands and avoid DIVIDE instructions; create stub functions that call a core function as herein described; avoid carry-producing instructions; count digits before converting; use only aligned reads to access a memory via multiple-byte; and/or utilize other focal aspects.

### MATERIAL INCORPORATED BY REFERENCE

The present document incorporates by reference the entirety of the following U.S. patent applications: application No. 61/701,630 filed Sep. 15, 2012, application No. 61/716,325 filed Oct. 19, 2012, application No. 61/716,325 filed Oct. 19, 2012, application No. 62/058,362 filed Oct. 1, 2014, and application Ser. No. 14/425,046 filed Mar. 1, 2015. Both text and drawings are incorporated by reference; drawing sheets and reference numbers may be renumbered to avoid ambiguity. In particular, and without excluding any material, the present application includes all material which the above-identified applications include and/or incorporate by reference, e.g., pursuant to the United States Patent and Trademark Office Manual of Patent Examining Procedure §502.05, all material in the following previously filed American Standard Code of Information Interchange (ASCII) text file is incorporated herein by reference: file name “Listing-Appendix_{—}6058-2-3A.txt”, file creation date is Aug. 29, 2013, file size in bytes is 85,487 (size on disk may differ). To the full extent permitted by applicable law, the present document also claims priority to each of these incorporated applications.

### COPYRIGHT AUTHORIZATION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

In particular, and without excluding other material, this patent document contains original assembly language listings, tables, C and C++ code listings, pseudocode, and other works, which are individually and collectively subject to copyright protection. All copyrights, including in particular all copyrights in material marked as “Copyright NumberGun LLC, 2012, All Rights Reserved”, belong to the assignee John W. Ogilvie.

### BACKGROUND

Many software applications and computing systems at some time display numbers, on a display screen, in printed reports, on web pages, or elsewhere. Many programs use floating-point and/or integer numbers which are converted from their native binary format into a human-readable decimal format. Such applications run on desktop computers, laptops, mainframes, and servers, for example.

### SUMMARY

One or more focal aspects (defined hereafter) may be part of a given embodiment for converting character strings into numeric values, such as using particular tables and/or performing particular scanning, detecting, skipping, avoiding, filtering, testing, converting, adding, aggregating, and/or other steps. Embodiments are not mathematical abstractions, and do not cover or preempt string-to-number conversion overall. Instead, they use specific algorithms and tables, for example, to improve the performance of computer systems in particular limited but worthwhile ways.

The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description. The innovation is defined with claims, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating a computer system having at least one processor and at least one memory which interact with one another under the control of software and/or circuitry, and other items in an operating environment which may be present on multiple network nodes, and also illustrating configured storage medium (as opposed to a mere signal per se) embodiments;

FIG. 2 is a block diagram illustrating some aspects of architectures for string-to-number conversion; and

FIG. 3 is a flow chart illustrating steps of some process and configured storage medium embodiments

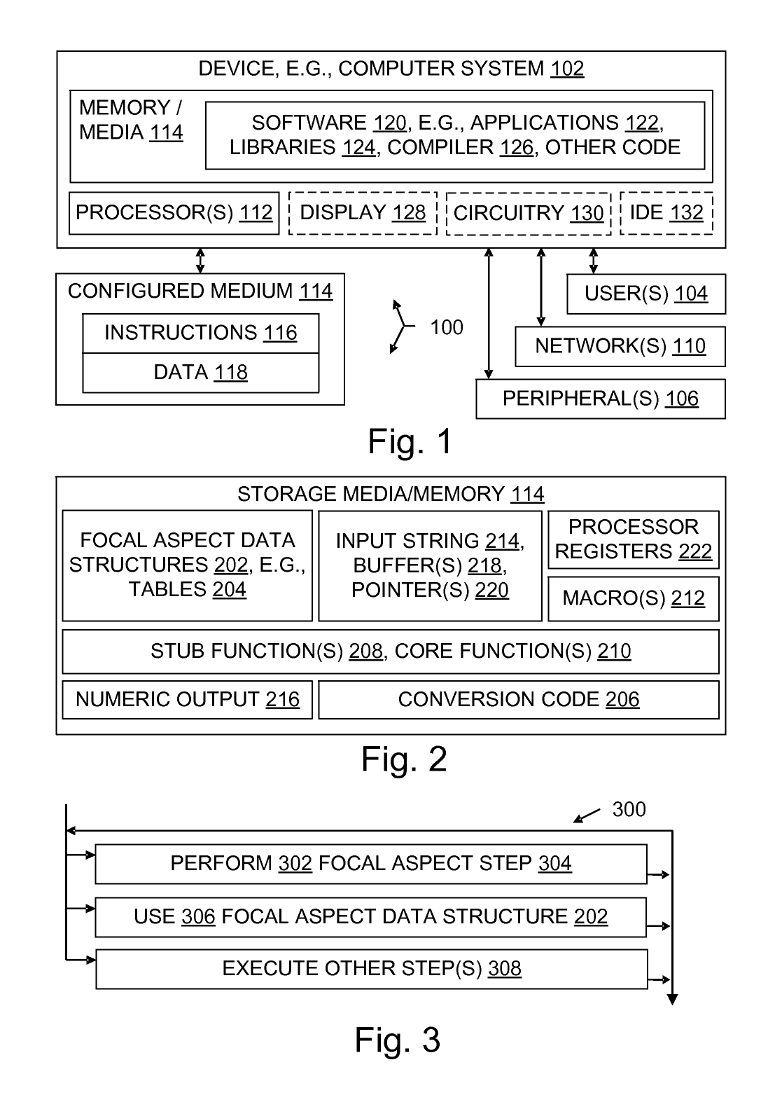

### DETAILED DESCRIPTION

### Some Definitions

_i64=long long, a 64-bit signed integer.
_u64=unsigned long long, a 64-bit unsigned integer.
Accumulator=a register or variable used to gather and combine data bits; there can be more than one accumulator in use.
Alphabet=the set of valid digits for a specific base.
Char=character; can be 8 bits or 16 bits wide. Most descriptions in the present disclosure assume 8-bit chars, although a skilled implementer can modify the algorithms to handle 16-bit chars.
GTE=greater than or equal to.
LTE=less than or equal to.
MAX_DIGITS=the maximum number of decimal digits to be converted for 64-bit integers; this is 18 when converting the parts of a floating-point character string, otherwise it is 20.
Most-significant digit=the left-most valid non-‘0’ digit character found in a numeric-character string.
Negative string=a numeric string having a valid minus ‘−’ sign; if none is found, the string is positive.
Numeric-character string=a character string made of characters that can be converted into a valid integer or floating-point number, includes valid digit characters for a specific number base and an optional sign character; numeric-character strings can have preceding whitespace characters; these strings can be either Unicode8 or Unicode16 characters.
Plain-number string=a numeric-character string with digits only and a possible plus or minus sign; floating-point plain-number strings may also have one optional decimal point (which in the U.S. locale is the period ‘.’ character) to separate the whole portion to the left from the fractional portion to the right. A plain-number string does not include an exponent value (as do exponential-notation strings, also known as scientific-notation strings).
Significant digit=the most-significant digit and all valid digit characters thereafter until an invalid character is found or until MAX_DIGITS is reached.
SIMD=Single Instruction Multiple Data command that can operate in parallel on byte, word, double word, etc., units; these instructions can execute multiple multiplications, additions, and other operations in the same amount of time it normally takes to process just one such unit, and include instructions from SSE, SSE2, SSE3, SSSE3, SSE4, AVX, AVX2, and other instruction-extension sets as documented by Intel, AMD, and others from time to time. The xmm and ymm registers are example of SIMD registers.
Unicode8=single-byte characters; also refers to ASCII and UTF8 characters and strings.
Unicode16=double-byte characters.
Whitespace=space (0x20), horizontal-tab (0x09), line-feed (0x0a), vertical-tab (0x0b), form-feed (0x0c), and carriage-return (0x0d) characters that may precede the first digit in a numeric-character string. Unicode16 can also include other characters, considered to be whitespace, from the Unicode standard.

Whenever reference is made to data or instructions, it is understood that these items configure a computer-readable memory 114 and/or computer-readable storage medium 114, thereby transforming it to a particular article, as opposed to simply existing on paper, in a person's mind, or as a mere signal being propagated on a wire, for example. No claim covers a signal per se, and any claim interpretation which states otherwise is not reasonable. A memory or other computer-readable storage medium is not a propagating signal or a carrier wave outside the scope of patentable subject matter under United States Patent and Trademark Office (USPTO) interpretation of the In re Nuijten case.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory are not propagating signal or carrier wave computer readable media. Unless expressly stated otherwise, “computer readable medium” means a computer readable storage medium, not a propagating signal per se.

“Focal aspects” include certain steps 304, certain data structures 202, and certain code 206. Status as a focal aspect is limited to the items which are (a) listed in this paragraph, (b) functionally equivalent to at least one source code listing given herein, and/or (c) have a reference designation comprising one of the following: 202, 204, 208, 210, 212, 304. One or more of the following focal aspects may be part of an given embodiment: Using 304A a Doubles10 table 204A for converting 304B a floating-point character string 214 into double 216; Combined scanning 304C over whitespace, detecting 304D sign, and skipping 304E leading zeroes; Using 304F signReg 210A for initial testing 304G of whitespace, thereby speeding up process of extracting 304H any valid sign char 224; Using 304I BaseTbl 204B to filter 304J whitespace, signs, digits, and invalid characters 224; Using 304K TensTbl 204C or its functional equivalent to convert characters into integer 216 by adding 304L entries from the table instead of multiplying or shifting; Using 304M TensTbl 204C or equivalent thus where all entries are 8-byte entries; Using 304N TensTbl 204C or equivalent thus with 64-bit general-purpose registers 222 in 64-bit execution environment 100; Using 304O 16-byte entries in TensTbl 204C or equivalent, with ymm registers 222, for processing 128-bit integers; When converting 304P strings 214 with more than nine significant digits, converting the lower nine digits first, thereby eliminating 304Q the need to test for overflow when each digit is converted; When converting 304R strings with 19 or fewer digits, eliminating 304Q the test 304R for overflow when aggregating 304S digit values; When converting 304T base-2 strings 214, shifting 304U the accumulator by 4 bits in one instruction to allow for the insertion 304V of 4 data bits from 4 consecutive source bytes; When converting 304W a numeric string 214 to floating point 216, using any one of (or two or three of) the following procedures or their functional equivalent: SkipWsAndZeroes 210B, CountValidBase10Digits 210C, CountB10Digits 210D, Atou64_Exact 210E, Atou_Mult 210F, any Coreto64_B10 210G or Atou64_Lea 210H or Coreu64 210I or any derivatives; When converting 304W a numeric string 214 to floating point 216, using 304X no more than two MULTIPLY commands to convert the WholePart into an unsigned integer, while avoiding 304Y all DIVIDE instructions; When converting 304W a numeric string 214 to floating point 216, using 304Z no more than two floating-point MULTIPLY commands to convert the FracPart into an unsigned integer, while avoiding 304Y all DIVIDE instructions; Determining 304AA, after skipping 304C over any whitespace characters, whether a numeric-character string is positive or negative by preserving 304BB the next character 224 of the plain numeric string (whether that character is a sign character or a valid digit), and then once the unsigned value is aggregated 304S, testing 304CC that character 224 to determine if the string 214 should be negated; Using 304DD the 512-byte BaseTbl.b16_word table 204D or equivalent that allows faster conversion of hexadecimal strings to integer; Using 304EE the .b16_word table 204D or equivalent to directly OR 304FF a value into the low 4 bits of a register 222 and to also OR 304FF a value into the next 4 bits of a register 222, with only two instructions; Identifying 304GG hexadecimal signature after filtering whitespace, sign, and leading ‘0’ chars; creating 304HH stub functions 208 that call a core function 210_{—} as herein described; Creating 304II a core function that services 304JJ multiple stub functions, e.g., Using one core 210J that can service: atoi, atou, strtou, and strtoi versions of the function; The Coreto64_B10 method 304KK and derivatives or equivalents, e.g., When adding 304LL values indicated by valid digits, purposely avoiding 304MM carry-producing instructions (such as ADC) when possible, even when it is known, or is possible, that the value 216 will require more than 32 bits (or more than 64 bits when producing a 128-bit value in 64-bit execution environments 100); The Atou64_Lea methods 304NN and derivatives or equivalents; The Atou64_Exact methods 304OO and derivatives or equivalents; The Atou64_B2Xmm method 304PP and derivatives or equivalents; The Atou_Mult method 304QQ and derivatives or equivalents; The Coreto64_B16 method 304RR and derivatives or equivalents; Any of the Strtou64 methods 304SS and derivatives or equivalents; Using 304TT the “lea skeleton” 204E taught herein or equivalent to convert a numeric string, e.g., using 304UU the SkipWsAndZeroes process, and/or using 304VV a method similar to CountValidBase10Digits, in conjunction with LEA instructions as herein explained; While converting 304WW a hexadecimal string 214 into a 32-bit or larger integer 216: use CPU instructions to shift 304XX a multi-byte accumulator register 222 4 bits to the right, to OR it with another, thereby producing from 1 to 8 (or more) result bytes that can then be reordered 304YY, to produce 304ZZ the unsigned equivalent of a numeric string; Using 304AAA the (V)PCMPGTB and (V)PMOVMSKB instruction (or equivalents) to help count 304BBB the number of valid digits, or to find the first invalid digit, of a numeric string; Using 304CCC any of the .bx, .b2, .b8, .b10, .b16, or .b16_word tables 204_{—} or equivalents; Using 304DDD TensTbl with 8-byte entries; Identifying 304EEE more than 4 (or more than 8, or more than 16) valid digits in a first pass 304FFF, then aggregating 304GGG the valid-digit counts in a second pass; Counting 304BBB digits before converting, thereby allowing use 304HHH of TensTbl with ADD or PADDQ instructions (or other flavors of ADD); Conversely, using 304III SUB and derivatives; Processes used in Coreto64_B16 algorithm 304JJJ, particularly .b16 table 204F with .invalid bit at offset 7 of each byte; using 304KKK (V)PTEST instruction to test up to 16 bytes (or more, if wider registers 222 are used) simultaneously for invalid instructions, and/or using 304LLL (V)PMOVMSKB to extract information to count number of valid digits; When using TensTbl, subtracting 304MMM the value (0x30*8=384) from the offset portion of the memory reference to access a TensTbl entry; When converting numeric strings for any base, using only aligned reads 304NNN to access the memory 114 via multiple-byte accesses by converting 304GGG the string into three portions: header, main body, and footer; Doing 304PPP this aligned read 304NNN access via (V)MOVDQA and (V)PALIGNR (and derivatives); Doing 304QQQ this aligned read 304NNN access via (V)MOVDQA and either (V)PSHUFB or (V)PSRLLQ (and derivatives); Using 304RRR a single 256-byte conversion table 204G to handle all numeric-string conversions for any base from base 2 through base 36; Determining 304SSS the length of a null-terminated string, using 304TTT the (V)PCMPGTB instruction to identify values greater than 0x7e; When 304GGG identifying parameter indicators, using the (V)PCMPGTB and (V)PMOVMSKB instructions to determine the offset in the format string of the next indicator; The ngStrlen function to determine 304SSS the length of a null-terminated string (can also be used to find the first occurrence of any character); Using 304VVV no more than four instructions in the inner loop, one such instruction being (V)PCMPEQB and another being (V)PTEST, and processing 16 or more bytes per iteration; Unrolled version of ngStrlen; Using 304WWW the (V)PTEST instruction in the inner loop, without having to use (V)MOVMSKB and BSF commands until the loop is exited; Using 304YYY Hybrid functions as described herein, where at least one of the specific methods described for 1, 2, or 3 bytes are used; Using 304XXX the (V)PMOVMSKB instruction to gather 304ZZZ data bits from 8 or more source bytes at a time in order to convert base-2 numeric strings to integers.

An operating environment 100 for a computer-implemented embodiment may include a computer system 102. The computer system may be a multiprocessor computer system, or not. An operating environment may include one or more machines in a given computer system, which may be clustered, client-server networked 110, and/or peer-to-peer networked 110. An individual machine is a computer system, and a group of cooperating machines is also a computer system. A given computer system may be configured for end-users, e.g., with applications, for administrators, as a server, as a distributed processing node, and/or in other ways.

Human users 104 may interact with the computer system by using displays 128, keyboards, and other peripherals 106, via typed text, touch, voice, movement, computer vision, gestures, and/or other forms of I/O. A user interface may support interaction between an embodiment and one or more human users. A user interface may include a command line interface, a graphical user interface (GUI), natural user interface (NUI), voice command interface, and/or other interface presentations. A user interface may be generated on a local desktop computer, or on a smart phone, for example, or it may be generated from a web server and sent to a client. The user interface may be generated as part of a service and it may be integrated with other services, such as social networking services. A given operating environment includes devices and infrastructure which support these different user interface generation options and uses.

Natural user interface (NUI) operation may use speech recognition, touch and stylus recognition, gesture recognition both on screen and adjacent to the screen, air gestures, head and eye tracking, voice and speech, vision, touch, gestures, and/or machine intelligence, for example. Some examples of NUI technologies include touch sensitive displays, voice and speech recognition, intention and goal understanding, motion gesture detection using depth cameras (such as stereoscopic camera systems, infrared camera systems, RGB camera systems and combinations of these), motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (electroencephalograph and related tools).

One of skill will appreciate that the foregoing aspects and other aspects presented herein under “Operating Environments” may also form part of a given embodiment. This document's headings are not intended to provide a strict classification of features into embodiment and non-embodiment feature classes.

As another example, a game may be resident on a game server. The game may be purchased from a console and it may be executed in whole or in part on the server, on the console, or both. Multiple users may interact with the game using standard controllers, air gestures, voice, or using a companion device such as a smartphone or a tablet. A given operating environment includes devices and infrastructure which support these different use scenarios.

System administrators, developers, engineers, and end-users are each a particular type of user 104. Automated agents, scripts, playback software, and the like acting on behalf of one or more people may also be users. Storage devices and/or networking devices may be considered peripheral equipment in some embodiments. Other computer systems may interact in technological ways with the computer system or with another system embodiment using one or more connections to a network via network interface equipment, for example.

The computer system includes at least one logical processor 112. The computer system, like other suitable systems, also includes one or more computer-readable storage media 114. Media may be of different physical types. The media may be volatile memory, non-volatile memory, fixed in place media, removable media, magnetic media, optical media, solid-state media, and/or of other types of physical durable storage media (as opposed to merely a propagated signal). In particular, a configured medium such as a portable (i.e., external) hard drive, CD, DVD, memory stick, or other removable non-volatile memory medium may become functionally a technological part of the computer system when inserted or otherwise installed, making its content accessible for interaction with and use by processor. The removable configured medium is an example of a computer-readable storage medium. Some other examples of computer-readable storage media include built-in RAM, ROM, hard disks, and other memory storage devices which are not readily removable by users. For compliance with current United States patent requirements, neither a computer-readable medium nor a computer-readable storage medium nor a computer-readable memory is a signal per se.

The medium is configured with instructions 116 that are executable by a processor 112; “executable” is used in a broad sense herein to include machine code, interpretable code, bytecode, and/or code that runs on a virtual machine, for example. The medium is also configured with data 118 which is created, modified, referenced, and/or otherwise used for technical effect by execution of the instructions. The instructions and the data configure the memory or other storage medium in which they reside; when that memory or other computer readable storage medium is a functional part of a given computer system, the instructions and data also configure that computer system. In some embodiments, a portion of the data is representative of real-world items such as product characteristics, inventories, physical measurements, settings, images, readings, targets, volumes, and so forth. Such data is also transformed by backup, restore, commits, aborts, reformatting, and/or other technical operations. Data may include data structures such as tables, lists, strings, buffers, pointers, characters, numbers, and combinations thereof . Code (including instructions 116) may be considered a form of data, e.g., as data consumed (source) or produced (executable) by a compiler 126.

Although an embodiment may be described as being implemented as software instructions executed by one or more processors in a computing device (e.g., general purpose computer, cell phone, or gaming console), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, an embodiment may include hardware logic components such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of an embodiment may be grouped into interacting functional modules based on their inputs, outputs, and/or their technical effects, for example.

In some environments, software 120 includes one or more applications 122, libraries 124, and tools such as a kernel, IDE 132, compiler 126, and/or other code. The code and other items may each reside partially or entirely within one or more hardware media, thereby configuring those media for technical effects which go beyond the “normal” (i.e., least common denominator) interactions inherent in all hardware—software cooperative operation. In addition to processors (CPUs, ALUs, FPUs, and/or GPUs), memory/storage media, other circuitry 130, display(s), and battery(ies), an operating environment may also include other hardware, such as buses, power supplies, wired and wireless network interface cards, and accelerators, for instance, whose respective operations are described herein to the extent not already apparent to one of skill. CPUs are central processing units, ALUs are arithmetic and logic units, FPUs are floating point processing units, and GPUs are graphical processing units.

In some embodiments peripherals 106 such as human user I/O devices (screen, keyboard, mouse, tablet, microphone, speaker, motion sensor, etc.) will be present in operable communication with one or more processors and memory. Software processes may be users.

In some embodiments, the system includes multiple computers connected by a network 110. Networking interface equipment can provide access to networks, using components such as a packet-switched network interface card, a wireless transceiver, or a telephone network interface, for example, which may be present in a given computer system. However, an embodiment may also communicate technical data and/or technical instructions through direct memory access, removable nonvolatile media, or other information storage-retrieval and/or transmission approaches, or an embodiment in a computer system may operate without communicating with other computer systems.

Some embodiments operate in a “cloud” computing environment and/or a “cloud” storage environment in which computing services are not owned but are provided on demand.

Any step stated herein is potentially part of a process embodiment. In a given embodiment zero or more stated steps of a process may be repeated, perhaps with different parameters or data to operate on. Steps in an embodiment may also be done in a different order than the order that is stated in examples herein. Steps may be performed serially, in a partially overlapping manner, or fully in parallel. The order in which steps are performed during a process may vary from one performance of the process to another performance of the process. The order may also vary from one process embodiment to another process embodiment. Steps may also be omitted, combined, renamed, regrouped, or otherwise depart from the stated flow, provided that the process performed is operable and conforms to at least one claim of this or a descendant disclosure.

Examples are provided herein to help illustrate aspects of the technology, but the examples given within this document do not describe all possible embodiments. Embodiments are not limited to the specific implementations, arrangements, displays, features, approaches, or scenarios provided herein. A given embodiment may include additional or different technical features, mechanisms, and/or data structures, for instance, and may otherwise depart from the examples provided herein.

Some embodiments include a configured computer-readable storage medium 114. Medium may include disks (magnetic, optical, or otherwise), RAM, EEPROMS or other ROMs, and/or other configurable memory, including in particular computer-readable media (as opposed to mere propagated signals). The storage medium which is configured may be in particular a removable storage medium 114 such as a CD, DVD, or flash memory. A general-purpose memory, which may be removable or not, and may be volatile or not, can be configured into an embodiment using items such as conversion code 206 (many examples of which are given in listings herein) and custom data tables 204_, in the form of data and instructions, read from a removable medium and/or another source such as a network connection, to form a configured medium. The configured medium is capable of causing a computer system to perform technical process steps as disclosed herein. Examples thus help illustrate configured storage media embodiments and process embodiments, as well as system and process embodiments. Additional details and design considerations are provided below. As with the other examples herein, the features described may be used individually and/or in combination, or not at all, in a given embodiment.

When coding, some sections of code can be moved around, different registers 222 can be used, and/or code fragments shown herein can be shortened. Instead of adding a value, the negative of that value could be subtracted, producing an equivalent result. Such changes as these can be made by one skilled in the art without departing from the spirit of the teachings herein.

It is possible bugs or errors may exist in the sample code 206 and pseudo-code in the present disclosure, though that should not detract from the inventions described herein. In some cases where such code is shown, due to formatting issues comments will sometimes spill over to the next line (although the actual code should not have a carriage return at the point the comment spills over); one skilled in the art can easily detect this issue.

Numeric-Characters Strings

Various mark-up languages, such as HTML and XML, are used to encode documents and files that are both human- and computer-readable and which contain numeric-character strings. Various data-interchange formats, such as JSON, have been created to allow data to be transmitted which, again, is both human- and computer-readable. Numeric-character strings are also found in many other forms and places: in log files, as the result of OCR processes, in text or word-processing files and data, in source code, as the result of printf and other formatting commands, in many types of web-related files, in report files, etc. Any time such data contains numeric information that is both human- and computer-readable, if that numeric information is to be used by a computer process, it is first parsed and then converted into binary numbers which are more easily manipulated by the computer.

Numeric-character strings can be comprised of numbers, letters, and/or symbols, and numbers can be represented in various bases; while base 10 (decimal) may be the most common base used, strings can also be represented in binary (base 2), octal (base 8), and hexadecimal (base 16) form. Other bases can also be used. When letters are used in such numeric strings (such as hexadecimal numbers), often no distinction is made based on the case of the letter (e.g., ‘b’ and ‘B’ both represent the value 11 in base 16). Also, in bases greater than base 10, the character set ‘a’-‘z’ (or ‘A’-‘Z’) can be used to represent values 10 through 35.

Numeric strings are either positive or negative. Computer functions that parse and convert such strings may encounter a possible leading ‘+’ or ‘−’ to indicate the sign; in some embodiments, the sign trails (i.e., it is the last valid character). A string is negative when a valid minus sign is found; otherwise, the number is deemed to be positive.

Such numeric strings may contain leading whitespace characters such as spaces, tabs, or line feeds. While the numeric portion of the string contains no such characters, it is possible that such characters (spaces and tabs especially) precede the first digit character or the sign of the numeric string. Functions to convert numeric strings are commonly designed to identify and skip over whitespace characters until finding the first character representing the number; the characters of the number are then parsed and converted into a valid binary number the computer can more readily use.

In general, a conversion function skips over any whitespace characters until finding either a ‘+’ or ‘−’ sign or a digit; the sign character, if found, is processed and/or remembered. It then processes the digits that come next, stopping the conversion as soon as an invalid character is encountered. In some situation, leading ‘0’ characters are found before the first non-‘0’ digit; it would be desirable to quickly identify and then skip over these leading ‘0’ characters, which lend little or no information to the conversion process (leading ‘0’ chars can be safely ignored; if no other digits are found, the value is equal to 0).

Many programming languages have a function or method to convert numeric-character strings into a binary number (either integer or floating-point). Such strings can be composed of single-byte characters (“Unicode8 strings”) or double-byte characters (“Unicode16 strings”). A typical example from the C programming language is the ‘atoi’ function, short for ‘ASCII to integer’. Such functions can convert decimal-character strings into signed integer (‘atoi’), unsigned integer (‘strtoull’), float (‘atof’) , or double (‘atod’) formats; there are many variations of these functions in many different programming languages. The Unicode8 or Unicode16 strings to be converted are often created by formatting functions similar to the ‘printf’ and ‘itoa’ functions. Such strings can also represent numbers in different number bases; the most common bases are base 2 (‘binary’), base 8 (‘octal’), base 10 (‘decimal’), and base 16 (‘hexadecimal’).

Converting a numeric string to integer requires much variability for a programmer to consider. The number base may be determined first. Whitespace is identified and skipped over (or not, depending on the needs of the algorithm). A valid plus or minus sign is detected and noted, then skipped (or not, depending again on the needs of the algorithm). If desired, leading ‘0’ chars can be skipped. At a certain point, a potential digit character is encountered. All consecutive valid digits are validated and, if valid, aggregated into a suitable accumulator. When an invalid digit is encountered, being invalid due to its not belonging to the base's alphabet or because it represents more digits than the maximum permitted, the process is finished and the result is returned to the caller (and converted to a negative number, if that is required). In some cases overflow is detected; if found, either the maximum or the minimum valid value is returned depending on the aggregated value and the sign of the string.

Some numeric bases allow for quick and easy validation of characters (for example, base-2 strings use only ‘0’ or ‘1’ as valid digits; and base-10 uses the contiguous range of ‘0’ through ‘9’), while others are more difficult (base-16 strings allow characters from the ranges ‘0’ through ‘9’, ‘A’ through ‘F’, and/or ‘a’ through ‘f’). In some cases where more than the maximum number of valid digits occurs in sequence, the end of the valid digits is still searched for and the position of the halt character returned to the caller (the halt character is the first character encountered that is not part of the base's alphabet).

In the present disclosure, various algorithms are discussed. One of skill who is also familiar with patent laws understands these algorithms to be statutory processes, more than mere abstract ideas or mere mental steps, implemented by software and hardware operating together in a computing system which includes at least one processor and digital memory, and/or as instructions and data configuring a statutory (not mere signal per se) computer readable medium, memory, or device. Each of the algorithms can appear inside different functions; the different functions all convert a numeric string to an integer, but some of the functions do a bit more work. Atoxxx functions such as Atou64_Lea, for example, convert numeric strings to 64-bit integers, returning the value of the converted string. Strtoxxx functions such as Strtou64 Add and Strtou64_Lea, do all that the Atoxxx functions do, plus they also return a pointer to the character that halted the conversion. For all these functions, there can be both unsigned and signed counterparts. Stubxxx functions are designed to be called by both Atoxxx and Strtoxxx (and other types of) functions and do the majority of the conversion work. For more information, see the section “Stub Functions”.

Modern compilers can tighten and speed up the processing needed to execute these conversion functions of strings from different bases. But there is a better, quicker way, as is detailed in the present disclosure.

Integers, Doubles, and Valid Digits

To properly convert a numeric string into a binary number, the target type and base of the number will be known. The type specifies the bit size and whether it is an integer (either signed or unsigned) or floating-point. The algorithms described in the present disclosure are designed to convert numbers into either 64-bit integers or into 64-bit floating-point double format; one skilled in the art can modify these to handle numbers of other bit sizes. When converting numbers, there are various rules and/or embedded character flags that help identify the type and base of the number.

For example, it is usually assumed that, lacking any other information, the numeric string represents a positive decimal base-10 number. If the letter ‘h’ immediately follows the last valid digit, or if the string starts with the prefix “0x” or “0X”, it may be a hexadecimal base-16 number; if the letters ‘a’-‘f’, or ‘A’-‘F’, appear in the numeric string, that could also indicate a hexadecimal number.

In the case of binary base-2 numeric strings, the lower-case letter ‘b’ may occur immediately at the end of a string of ‘0’ and ‘1’ digit characters . . . or it may not; but if any other digit characters occur in the string, it may not be a binary number (or, it may be a binary number that ends right next to the non-binary digit). And in some cases, it is assumed that if the first digit is a ‘0’, the string represents an octal base-8 number.

Some numeric strings contain formatting characters, such as the dollar sign ‘$’, commas used to separate the thousands groupings to the left of the decimal point, and the period to separate the number into its whole (on the left) and fractional (on the right) parts; this is common in the U.S. locale. Other locales may switch use of the comma and period, or use other characters for formatting.

In any event, in order to convert numeric strings containing extra formatting characters, such formatting characters are either removed prior to converting the number or skipped over during the conversion process. It has been found useful to separate the process of filtering the formatting characters from the number into a separate process, the end result of which can be a plain numeric string that is easier to convert. During such filtering, the actual format can be validated against the rules of the target locale, if desired; a copy of the string can then be created which is then converted.

The implementer of the algorithms described in the present disclosure should understand the concepts of shifting and masking bits; such a skilled implementer can be known as a “bit twiddler”. A programmer not sufficiently experienced in such matters may not be sufficiently skilled to implement or to customize, as needed, the algorithms herein described.

When processing numeric strings, as soon as a character is encountered that is invalid for that base, it can be determined that the end of the number has been reached, and the value calculated to that point can be returned. In some embodiments, the conversion function may first skip all non-valid characters until it finds a valid character; in other embodiments the first character encountered should be valid, otherwise the conversion is halted and a default value (such as 0 or −1) may be returned.

The valid characters for each base are specified below (the plus ‘+’, minus ‘−’, decimal point ‘.’, and comma ‘,’ characters can also be valid, depending on the needs of the conversion):

| | |
|---|---|
| Base 2: | 0 1 |
| Base 8: | 0 1 2 3 4 5 6 7 |
| Base 10: | 0 1 2 3 4 5 6 7 8 9 |
| Base 16: | 0 1 2 3 4 5 6 7 8 9 A B C D E F a b c d e f |

As an example, here is what the number 125 can look like when formatted as a decimal string in each of these bases:

| | |
|---|---|
| Base 2: | 01111101 |
| Base 8: | 175 |
| Base 10: | 125 |
| Base 16: | 7d or 0x7d or 7dh or $7d (or any of the preceding |
| with | |
| | ‘d’, ‘x’, or ‘h’ in uppercase) |

The present disclosure describes new, non-intuitive algorithms for converting base-2, base-8, base-10, and base-16 into a 64-bit integer. Additionally, the base-10 conversion algorithms can be adapted to quickly convert numeric strings into floating-point numbers, as described in the section “Converting Floating-Point Numeric-Character Strings to Double”.

Each base requires its own conversion table. Also, the algorithm Strtou64_b16 can be modified by one of skill to handle unsigned values of any base, from base 2 up to base 64; for each base, a separate BaseTbl lookup table can be used, containing information about which characters are valid digits, and the value each such valid digit represents. A similar process can be used to return signed values (say, a similar or identical function named Strtoi64_b16).

The examples and descriptions herein described assume the plain numeric strings to be converted are strings of Unicode8 characters; one of skill can modify the algorithms to handle Unicode16 strings and other bases and other locales, without departing from the teachings herein. Some of the examples are shown in pseudo code that is similar to C/C++, while other examples are shown using FASM assembly code (Flat Assembler is an assembly-language compiler, freely available at FlatAssembler dot net). In addition, the examples show conversion to 64-bit integers (signed and/or unsigned) and floating-point numbers. A skilled implementer can readily modify these algorithms to handle smaller-bit sizes, and can also extend the examples to handle larger types (such as 128-bit integers or 128-bit floating point) by allowing for the capture of additional bits. The inventions in the present disclosure can be coded in any of several different languages, including C, C++, C#, Java, assembly, and others.

Conversion Tables Used

When converting numeric strings, whitespace often is first identified and skipped over, and a valid numeric sign is identified if it exists. A 256-byte lookup table, BaseTbl.ws, is used to identify whitespace and sign characters. Each entry is 8 bits; a table suitable for Unicode8 characters occupies 256 bytes. When modifying this table to handle Unicode16 strings, a skilled implementer would realize that there are additional Unicode characters that are considered whitespace and that can be filtered and skipped. Using 8-bit entries in a table for identifying whitespace when processing Unicode16 character strings is helpful; such a table should be properly initialized to identify all characters deemed to be whitespace characters, and would contain 65,536 entries and require 64 k of memory. (If desired, the skilled implementer could shrink this table to contain one, two, or four bits per entry; however, this would require a shift operation for each character to be checked.)

The lookup tables are located in memory starting at the base address BaseTbl, and the bit positions and values that can be tested are as follows (examples use FASM instructions). Note that in the FASM assembly language, any label starting with a period will inherit the name of the most-recent preceding label that does not start with a period; thus, the label “.invalid” will expand to the full name “BaseTbl.invalid”, the label “.ws” will expand to the name “BaseTbl.ws”, “.b2” will expand to “BaseTbl.b2”, etc.

| align 4 | |
|---|---|
| label BaseTbl byte | ; Base tables for bases 2, 8, 10, 16 |

| | |
|---|---|
| .invalid = 10000000b | ; any invalid char, including null |

; this sets sign bit for invalid byte

| | |
|---|---|
| .isSign = 01000000b | ; character is ‘+’ or ‘−’ |
| .isWs = 00100000b | ; is whitespace |
| .isZero = 00010000b | ; ‘0’ |

| | |
|---|---|
| .plus = .isSign | ; ‘+’ |
| .minus = .isSign | ; ‘−’ |

| .fastSkip = .isSign + .isWs + .isZero | |
|---|---|
| .hexMask = 0xf0 | ; check if any upper-nibble bits |

are set

Some flag characteristics above are shown in binary notation (note the ‘b’ at the end of the value specified for .invalid, .isSign, .isWs, and .isZero). Characteristics can be combined by either ADDing or ORing them together since each occupies a different bit space; the value BaseTbl.fastSkip is used to identify any byte that is either a sign, a whitespace char, or a ‘0’ digit.

The whitespace table, BaseTbl.ws 204H, is created in part by using the following macros 212 (TblSetInit and TblSet are also used to create each base table, as shown below):

; Macros used when creating tables (FASM code)...
macro TblSetInit name {

_mTblName equ name }

macro TblSet loc, val {

store byte val at _mTblName+loc }

macro TblSetWhiteSpace {

; Identify whitespace chars
TblSet 0x09, .isWs
TblSet 0x0a, .isWs
TblSet 0x0b, .isWs
TblSet 0x0c, .isWs
TblSet 0x0d, .isWs
TblSet ‘ ’, .isWs

}

The above macros store specific values at specific locations in the tables; this causes the value of each digit to be stored at that digit's relative offset of the table. The actual BaseTbl.ws table is created with the following instructions:

| label .ws byte | | |
|---|---|---|
| times 256 db | .invalid | ; default is .invalid |
| TblSetlnit | .ws | ; table to work with |
| ; Identify whitespace chars | | |
| TblSetWhiteSpace | | |
| ; Identify sign chars | | |
| TblSet ‘+’, | .plus | |
| TblSet ‘−’, | .minus | |

This creates the table by first setting all 256 bytes to the value ‘.invalid’, then calling TblSetWhiteSpace to set all normal whitespace chars to identify them as such, and then setting the proper identification flags for the sign characters. BaseTbl.ws is used as shown in the section “Filtering Whitespace and Leading Zeroes”.

If desired, one of skill could merge the information contained in this table with each of the base-conversion tables further described below. However, that could complicate the handling of Unicode16 character strings, and may limit the bases that could be converted (e.g., if 4 upper bits are needed to signal various characteristics of whitespace, sign, and invalid characters, that leaves only 4 lower bits to contain the value represented by the byte, which would limit the tables to handling no base higher than base 16).

Since each base uses a different alphabet, each has its own conversion table; in the present disclosure, such tables are given a name comprised of “BaseTbl.b” plus the number representing the base. For example, the base-10 table is BaseTbl.b10 and the base-16 table is BaseTbl.b16. Each base-conversion table can also be used to either identify invalid digits or to convert a valid digit character to its proper value. Shift-based algorithms can be used for bases that completely fill the bit space utilized by the base and whose values are contiguous (such as base 2 and base 8; refer to the sections “Converting Base-2 Character Strings” and “Converting Base-8 Character Strings”). Lea-based algorithms can be used for any base (see Atou64_Lea for more information).

For some algorithms with certain bases, as described in the “Converting Base- . . . ” sections and below, a bit pattern can be tested instead of using the BaseTbl to determine validity of all bytes. In some cases, a value is first subtracted from, or added to, each byte being tested; this process can be sped up with the use of SIMD instructions, as shown in the details below, which allow the processing of multiple bytes in parallel.

Similar to the way BaseTbl.ws is created, when creating the base tables (as shown below), all bytes of each table are first set to ‘.invalid’; the entries for valid characters are then modified to have the proper value. Each valid digit will contain the value that digit represents; this value is used by several of the base-conversion processes. In some cases, the table is used only to identify valid digits; in others, it is used both to validate digits and to quickly determine the value represented by that digit.

For certain base conversions, such as when converting base-10 numeric strings, the value represented by valid digits can be obtained by using a shortcut available when using memory-addressing features available on Intel and other CPUs. The proper value for each digit is obtained by subtracting the value 0x30 from the valid digit (which is a zero-added-cost, or “free”, memory-offset address for many Intel CPU instructions). For base-10 strings, some algorithms explained in the present disclosure use SIMD instructions to quickly process a block of characters in parallel to identify valid base-10 digits without using conversion tables; other base-10 algorithms use the BaseTbl.b10 table.

Base-conversion tables can be created for any base.

The following FASM code creates the .b2 table. This table is grouped under the BaseTbl name (as are the other base-conversion tables described in the present disclosure).

| label .b2 byte | |
|---|---|
| ; Base-2 conversion table, unsigned | |
| ; max # sig. digits allowed before overflow | |
| .b2.maxDigits = 64 | |
| times 256 db .invalid | ; default is .invalid |
| TblSetlnit .b2 | ; table to work with |
| ; Identify valid digits | |
| TblSet ‘0’, 0 | |
| TblSet ‘1’, 1 | |

The above creates a 256-entry table referenced as BaseTbl.b2. Each entry is 8 bits wide, and there is one entry for each valid digit (the digits ‘0’ and ‘1’).

The table BaseTbl.b8 is created with the following FASM instructions:

| label .b8 byte | ; start of BaseTbl.b8 table here |
|---|---|
| ; Base-8 conversion table | |
| .b8.maxDigits = 22 | ; NOTE: only lo bit of last digit can be |
| valid! | |
| times 256 db .invalid | ; default is .invalid |
| TblSetlnit .b8 | ; table to work with |
| ; Identify valid digits | |
| TblSet ‘0’, 0 | |
| TblSet ‘1’, 1 | |
| TblSet ‘2’, 2 | |
| TblSet ‘3’, 3 | |
| TblSet ‘4’, 4 | |
| TblSet ‘5’, 5 | |
| TblSet ‘6’, 6 | |
| TblSet ‘7’, 7 | |

The following FASM commands create the BaseTbl.b10 table:

| label .b10 byte | ; start of base-10 table |
|---|---|
| ; Base-10 conversion table, signed | |
| .b10.maxDigits = 20 | |
| times 256 db .invalid | ; default is .invalid |
| TblSetlnit .b10 | ; table to work with |
| ; Identify valid digits | |
| TblSet ‘0’, 0 | |
| TblSet ‘1’, 1 | |
| TblSet ‘2’, 2 | |
| TblSet ‘3’, 3 | |
| TblSet ‘4’, 4 | |
| TblSet ‘5’, 5 | |
| TblSet ‘6’, 6 | |
| TblSet ‘7’, 7 | |
| TblSet ‘8’, 8 | |
| TblSet ‘9’, 9 | |

The following FASM commands create the BaseTbl.b16 table:

| label .b16 byte | | ; start of BaseTbl.b16 table here |
|---|---|---|
| ; Base-16 conversion table | | |
| .b16.maxDigits = 16 | | |
| times 256 db | .invalid | ; default is .invalid |
| TblSetlnit | .b8 | ; table to work with |

```
  ; Identify valid digits
  TblSet ‘0’, 0
  TblSet ‘1’, 1
  TblSet ‘2’, 2
  TblSet ‘3’, 3
  TblSet ‘4’, 4
  TblSet ‘5’, 5
  TblSet ‘6’, 6
  TblSet ‘7’, 7
  TblSet ‘8’, 8
  TblSet ‘9’, 9
  TblSet ‘A’, 10
  TblSet ‘B’, 11
  TblSet ‘C’, 12
  TblSet ‘D’, 13
  TblSet ‘E’, 14
  TblSet ‘F’, 15
  TblSet ‘a’, 10
  TblSet ‘b’, 11
  TblSet ‘c’, 12
  TblSet ‘d’, 13
  TblSet ‘e’, 14
  TblSet ‘f’, 15
```

For each of the above conversion tables, any entry with its upper bit set is invalid; a clear upper bit means a valid digit, and the lower bits represent that digit's value. In the .b10 table, all the values are contiguous and in sequence, which allows using other processing to quickly identify valid digits without using the table. On the other hand, the .b16 table contains three distinct groups of valid digits which are not contiguous; therefore, using the .b16 table in converting base-16 numeric strings is helpful.

Another table, TensTbl, is used for algorithms that convert numeric strings by adding values from a table; it is explained in detail in the “Coreto64_B10 Core Function” section.

If desired, a single comprehensive table (named .bx, for example) could be created; this allows a single 256-byte conversion table to be used for all base conversions. To create this table, use the pattern shown above for the .b16 table. Extend the alphabetic ranges to cover the range ‘A’-‘Z’ and ‘a’-‘z’, with the values ranging from 10-35 for each respective range. The .bx table can then be used to validate any base as follows. For each character to be validated, use it to index the .bx table; if the value accessed from the table is less than the base, the char is valid; otherwise, it is invalid. For example, assume the character to be validated is NewChar and the base used for the conversion is CurBase (assume any base from base 2 through base 36). Then, if BaseTbl.bx[NewChar]<CurBase, the character is valid, else it is invalid.

Note that is is also possible to use the SIMD (V)PCMPESTRI, (V)PCMPESTRM, (V)PCMPISTRI, and/or (V)PCMPSTRM instructions to validate a block of characters in one instruction; these instructions can simultaneously determine, for each byte in a block, if it is in the desired range, without using the base-conversion table. For example, these instructions can be used to determine the number of valid base-16 digits; the ranges ‘0’-‘9’, ‘A’-‘F’, and ‘a’-‘F’ can be simultaneously checked, for each character, to then determine how many valid consecutive digits exist. Note, however, that each character must still be processed by accessing the .b16 table to obtain the proper value represented by the character.

Some algorithms use other tables, which are described in the sections where they are used.

Overview of Converting Numeric Strings

The numeric-conversion process for each base has three main sections: scanning to find the first significant digit; for each significant digit, converting it to its proper value and aggregating the values in an accumulator; and final processing and cleanup before returning to the caller. The first part, scanning and finding the first significant digit, can be the same for all conversions, no matter the base and whether signed or unsigned values are created. A very fast, non-intuitive method to do this is explained in the section “Filtering Whitespace and Leading Zeroes”. Note that for some functions, this step is skipped (for example, when converting floating-point numeric strings; see “Converting Floating-Point Numeric-Character Strings”).

The second part is unique to each base, and is different depending on whether signed or unsigned values are returned to the caller. The process is described for each base as signified in the section headings below. When possible, MULTIPLY and DIVIDE instructions are avoided and replaced with more-efficient ADD, LEA, or SHIFT instructions. Note that some of the speed of the algorithm is obtained by custom assembly-language instructions that may not be automatically created when non-assembly languages are compiled, thus execution speed from non-assembly implementations may be slower. However, all the algorithms herein described can be implemented by skilled implementers of C, C++, Java, or other languages that provide robust bit-manipulation instructions; this can provide significant speed improvement over other methods, especially when intrinsics are used to take advantage of assembly-language instructions (those skilled in the art will understand how to select and use intrinsics available within the high-level language being used).

Execution speed is not the only reason to implement the present invention. Although speed is important in many cases, so is the impact on battery life, especially for mobile devices. A fast-running program does not necessarily make the CPU run at a faster clock rate as compared to a slow-running program; both may run at the same processor speed. But if a program can be redesigned to use a different algorithm, that algorithm may be faster if it can accomplish the same task with fewer instructions. The methods described in the present disclosure can often run 6× to 12× faster than competing algorithms, resulting in less battery drain while accomplishing the same task; this can be meaningful when hundreds of thousands (or more) conversions are to be performed quickly.

The third part of the process occurs immediately after a converted number has been obtained, and this can be the same for each conversion process (although in some cases, such as when converting floating-point strings, this step is handled differently as explained elsewhere in the present disclosure). For example, if during the first part of the conversion process a negative sign is found and the string is therefore determined to be negative, the obtained value is made negative before being returned to the caller. If the value to be negated can fit in 32 bits, a slightly faster negation method can be used compared to negating a 64-bit number (this applies to 32-bit execution environments and can be extended to other execution environments, such as when negating a 64-bit portion of a 128-bit number in a 64-bit execution environment).

For example, assume the just-converted value actually fits within 32 bits and is to be negated (which impacts all 64 bits). Returning this as a negative 64-bit number in the edx:eax register pair, which is standard, can be done in two instructions:

| neg | eax | | |
|---|---|---|---|
| or | edx, | −1 | ; or use ‘mov edx, −1’ |

But if the value requires more than 64 bits, a different sequence is required:

| neg | edx | |
|---|---|---|
| neg | eax | |
| sbb | edx, | 0 |

In some portions of some of the algorithms in the present disclosure, it is inherent in the algorithm as to which of the above methods can be used, without needing to programmatically test the scenario to determine which method could be used (needing to test completely undermines this ability . . . to executed multiple instructions in order to save one). And the fewer the instructions, the less battery life consumed . . . and the faster the execution will be.

Accumulators

During the conversion process, data is accumulated in one or more accumulators. An accumulator is a register or memory location, and is typically 32 bits or more; multiple registers can be used together to create a larger accumulator. In both 32- and 64-bit execution environments where SIMD instructions are available, larger 64-, 128-, and possibly larger-bit registers may be used as accumulators.

When an accumulator is too small to hold all captured data, additional accumulators are used, and/or the data from the accumulator is stored and then the accumulator is reused to accumulate additional data. Eventually, the accumulated data is combined (for example, by ADD, LEA, MULTIPLY, OR, and/or SHIFT operations) in a way that ensures that, when the final result is obtained, all data bits are in proper order, there are no gaps and no lost data bits, and the lowest-order bit is at offset 0 of the returned value.

Filtering Whitespace and Leading Zeroes

Numeric character strings may contain various whitespace characters such as spaces, tabs, line-feed, or other such characters. These are identified and skipped over in order to find the first valid digit to convert. Additionally, a ‘+’ or ‘−’ sign character could also be found prior to the digits. There could also be multiple leading ‘0’ characters before the first significant digit. The structure of a plain numeric-character string is described as:

{whitespace}{sign}{leading ‘0’s}{digits}{halt char}
where whitespace represents 0 or more whitespace characters; sign is an optional sign character, which is ‘+’ or ‘−’; leading ‘0’s represents 0 or more consecutive ‘0’ characters; digits represents valid digit characters from the alphabet of the number base in question; and halt char represents a character that is not a valid digit and which signals the end of the valid-digit string (it could be a null character, a whitespace or sign character, or any character or digit invalid for the base). Note that some numeric-character strings may have additional formatting characters and/or monetary characters; to convert such numeric-character strings, all such formatting and other characters are first removed. In some embodiments, a length of the string may be specified, which can eliminate the need to detect a halt char.

Identifying the above pattern requires the following: scanning to identify and then skip over whitespace characters; then identifying if a sign is present before the first digit and, if so, obtaining the sign; then identifying and skipping over all leading zeroes before the first significant digit; and finally positioning a pointer to the first valid digit (or the halt char if there are no valid digits). This takes time and is computationally intensive; it would be useful to have an algorithm that accomplishes this very quickly.

Consider the following string (StrA):

### StrA db ‘-01234ABC’, 0

The above numeric string has two whitespace characters (both are space chars), a minus sign, one leading ‘0’, and the most-significant digit is ‘1’. The halt char is the ‘A’ char near the end. Below, the timings mentioned were obtained from testing on the inventor's Intel Core2 Duo 2.66 GHz laptop.

The following algorithm, shown in a FASM macro using Intel-compatible assembly-language code, is a straight-forward algorithm to find the first significant digit of a string after skipping over whitespace, leading zeroes, and identifying a sign (if one exists):

macro SkipWsAndZeroesSimple ptrReg, signReg {
; Skip over w/s, grab sign, skip over zeroes

| tbl equ BaseTbl.ws | | | | ; set equal to whitespace |
|---|---|---|---|---|
| table! | | | | |
| | movzx | | signReg, byte [ptrReg] ; use signReg, saves a | |
| later step | | | | |
| | test [tbl+signReg], BaseTbl.fastSkip | | | |
| | jz | .done | | ; nothing to check, so |
| continue quickly! | | | | |
| | jmp | .start | | ; jmp into middle |
| @@: | inc | ptrReg | | |
| | movzx | | signReg, byte [ptrReg] | |
| .start: | | | | |
| | test [tbl+signReg], BaseTbl.isWs | | | |
| | jnz | @b | | ; keep checking while whitespace |
| | ; See if sign | | | |
| | test [tbl+signReg], | | | BaseTbl.isSign ; is this a sign |
| char? | | | | |
| | jz | .check0 | | ; not a sign, so see if 0 |
| @@: | inc | ptrReg | | |
| .check0: | | | | |
| | cmp | byte | [ptrReg], | ‘0’ |

| | | |
|---|---|---|
| je | @b | ; keep looping while '0' chars |

.done:
restore tbl
}

The above SkipWsAndZeroesSimple algorithm can skip over whitespace and leading ‘0’ chars at a rate of from 0.2 GBytes/sec (when there is only to skip) to over 1.1 GBytes/sec (when there are 20 or more). When the above process completes, the register used as ptrReg points to the first significant digit of the string (or the halt char, if there is not a most-significant digit), and the register used as signReg will be equal to ‘−’ if there is a valid minus sign, else it is some other character.

The above can be unrolled to produce faster results. The unrolled version shown below, SkipWsAndZeroes, operates from 4% to 7% faster when skipping over whitespace chars, and from 21% to 42% faster when skipping over leading ‘0’ chars; this is estimated to be from 3× to 8× faster than the equivalent code used within library functions in MSVS Pro 2013. The algorithm SkipWsAndZeroes is shown as a FASM macro using Intel-compatible assembly-language code. It is more complex than the ‘Simple’ version above, and the entire code is shown in five sections as follows.

| macro SkipWsAndZeroes ptrReg, signReg { | |
|---|---|
| ; This code does the following: | |
| ; - skips over all whitespace chars | |
| ; - assigns first “legal” char to signReg (so it can be | |
| inspected for sign later) | |
| ; - skips over any leading ‘0’ chars | |
| ; - and it does it FAST!! | |
| local tbl, .checkWS, .cz, .cz4, .cz3, .cz2, .cz1, .c4, | |
| .c3, .c2, .c1, .c1b, .d3, .d2, .d1, .done | |
| tbl equ BaseTbl.ws | ; set equal to whitespace |
| table! | |

This first part defines the macro and its parameters. This macro uses the BaseTbl.ws table described earlier, which is a 256-byte table that contains information regarding whitespace, sign, and ‘0’ characters. ptrReg is a CPU register that points to the front of the numeric-character string; it will be adjusted at the end to point to the first valid non-‘0’ digit, or to the character halting the conversion if no non-‘0’ digit is found. signReg is the register that will contain a byte indicating the sign of the string at the end of the algorithm (if it is ‘-’ the string is negative, otherwise it is positive). Both registers (ptrReg and signReg) are different; if they are the same register, the algorithm will fail. When working with Unicode16 strings, a 64 k whitespace table could be used, allowing all Unicode whitespace characters to be specified; the skilled implementer will adjust the code, as needed, to handle 16-bit chars. (This paragraph also applies to the ‘Simple’ version listed above.)

Various labels are created and used when the macro is activated; all such labels are listed on the ‘local’ line to ensure they are unique in the event the macro is used more than once. The symbolic constant ‘tbl’ is set equal to the BaseTbl.ws table. The next part tests bytes of the string to see if they are whitespace, as follows:

; If first char not whitespace, sign, or zero, we are
done

| | |
|---|---|
| movzx | signReg, byte [ptrReg] |

test [tbl+signReg], BaseTbl.fastSkip ; is first digit

| valid? | | |
|---|---|---|
| jz | .done | ; yes, so exit and do nothing |

```
.checkWS:
  ; skip over whitespace chars
  ; using signReg here eliminates need to save
```

| | |
|---|---|
| separately! | |
| movzx | signReg, byte [ptrReg] |

test [tbl+signReg], BaseTbl.isWs ; is whitespace?

| jz | .c4 | ; if not, goto .c4 |
|---|---|---|
| movzx | signReg, byte [ptrReg+1] | |
| test | [tbl+signReg], | BaseTbl.isWs |
| jz | .c3 | |
| movzx | signReg, byte [ptrReg+2] | |
| test | [tbl+signReg], | BaseTbl.isWs |
| jz | .c2 | |
| movzx | signReg, byte [ptrReg+3] | |
| add | ptrReg, 4 | ; add unroll value |
| test | [tbl+signReg], | BaseTbl.isWs |
| jnz | .checkWS | ; wrap if still whitespace |

A byte is first loaded into signReg. signReg is then used to index ‘tbl’ to see if the first char could be a valid most-significant digit (.i.e., not a whitespace, sign, or ‘0’ char); if so, control jumps to the end. Otherwise, signReg is loaded with the next byte to test for a whitespace char. This loop processes bytes as long as whitespace chars are found. When a first non-whitespace char is found, control branches to the appropriate point below. Note that the testing instructions are unrolled 4 times. One of skill could change the current unrolling level (to more or fewer than 4 times) if desired. Note that by using signReg for this initial process, we are guaranteed that the byte that reflects the sign character will be in signReg, without having to explicitly move it somewhere else for storage to enable the remainder of the process to continue; this saves some execution time.

For each next byte, the index is not initially adjusted; instead, a constant value (from 1 to 3) is added to ptrReg to effectively advance it to allow inspection of the next byte. If the inspected byte is whitespace (the zero flag will be clear), control flows to the next instruction; otherwise, control jumps to the appropriate next section where the sign is determined and leading ‘0’ characters are checked for. Since this main loop is unrolled 4 times, the branch location is matched with the equivalent unrolled section that inspects the sign and scans for ‘0’ characters. Note, for example, that after the first byte is tested, if it is not whitespace, that byte is inspected to see if it is a sign char. Branching to .c4 means that this byte will then be tested to see if it is a sign; if so, the ptrReg is adjusted to skip one char, and then up to 4 more bytes are scanned for leading ‘0’ chars. If none are found, control loops back to .cz where up to 4 bytes are scanned each iteration; it exits the loop only when a non-‘0’ char is found.

The code may be complex, but it is designed to match the unrolled loop of scanning for whitespace with the unrolled loop of scanning for leading zeroes, with a simple skip adjustment made if a sign is detected. At the bottom of .c4, .c3, .c2, and .c1, if the last char inspected was a ‘0’, control loops back to the top of .c4, and execution stays in this loop until a non-‘0’ is found. As soon as the first non-‘0’ char is found, control branches to the proper location to adjust ptrReg so that it points exactly at that character; that character will either be the most-significant character of the numeric string, or it will be the halt char.

| ; Found end of whitespace at most recent char, | | |
|---|---|---|
| ; so test next char for sign | | |
| test [tbl+signReg], BaseTbl.isSign ; is this a sign | | |
| char? | | |
| jnz | .cz | ; yes, so skip |
| ; last was not sign char, see if ‘0’ | | |
| cmp | signReg, ‘0’ | |
| jne | .c1b | ; not zero, found first sig digit |
| .cz: | | |
| ; Start checking for ‘0’ | | |
| .cz4: | | |
| cmp | byte [ptrReg], ‘0’ | |
| jne | .done | |
| .cz3: | | |
| cmp | byte [ptrReg+1], ‘0’ | |
| jne | .d3 | |
| .cz2: | | |
| cmp | byte [ptrReg+2], ‘0’ | |
| jne | .d2 | |
| .cz1: | | |
| cmp | byte [ptrReg+3], ‘0’ | |
| lea | ptrReg, [ptrReg+4] | |
| je | .cz | ; keep skipping over ‘0’ chars |
| ; last char was not zero, so prepare to exit | | |
| dec | ptrReg | |
| jmp | .done | |

At the top, 3 whitespace chars were just found, but the last char to be inspected for whitespace was not whitespace, so it is then tested to see if it is a sign. The proper value from ‘tbl’ is inspected and if it's a sign char, it is skipped and ‘0’ chars are then scanned for. This loop continues until a non-‘0’ is found, meaning the next char is either a valid digit or a halt char.

| .c4: | ; check for sign, then up to next 4 chars for ‘0’ | | |
|---|---|---|---|
| | test [tbl+signReg], BaseTbl.isSign | | |
| | jnz | .cz3 | ; was sign, check next 3 for ‘0’ |
| | ; Was not sign, check next 4 for ‘0’ | | |
| | cmp | byte [ptrReg], ‘0’ | |
| | jne | .done | |
| | cmp | byte [ptrReg+1], ‘0’ | |
| | jne | .d3 | |
| | cmp | byte [ptrReg+2], ‘0’ | |
| | jne | .d2 | |
| | cmp | byte [ptrReg+3], ‘0’ | |
| | lea | ptrReg, [ptrReg+4] | |
| | je | .cz | ; keep skipping over ‘0’ chars |
| | ; last char not zero, so done | | |
| | dec | ptrReg | ; adjust back one char |
| | jmp | .done | |

This address (.c4) is where control branches if, at the top of the whitespace loop (.checkWS), the first char is not whitespace. It adjusts for a sign, if found, and then skips over leading zeros. The remaining code handles the other branches when scanning over whitespace, provides other needed code to scan over leading zeroes, and ensures the pointer register points to either the first significant digit or the halt char:

| .c3: | ; check for sign, then up to next 3 chars for ‘0’ | | |
|---|---|---|---|
| | test | [tbl+signReg], | BaseTbl.isSign |
| | jnz | .cz2 | ; was sign, check next 2 for ‘0’ |
| | cmp | byte [ptrReg+1], ‘0’ | ; no sign, check for ‘0’ |
| | jne | .d3 | |
| | cmp | byte [ptrReg+2], ‘0’ | |
| | jne | .d2 | |
| | cmp | byte [ptrReg+3], ‘0’ | |
| | lea | ptrReg, [ptrReg+4] | |
| | je | .cz | ; keep skipping over ‘0’ chars |
| | dec | ptrReg ; last char not zero, so adj by 1, exit | |
| | jmp | .done | |
| .c2: | ; check for sign, then up to next 2 chars for ‘0’ | | |
| | test | [tbl+signReg], BaseTbl.isSign | |
| | jnz | .cz1 | ; was sign, check next 1 for ‘0’ |
| | cmp | byte [ptrReg+2], ‘0’ | ; no sign, check for ‘0’ |
| | jne | .d2 | |
| | cmp | byte [ptrReg+3], ‘0’ | |
| | lea | ptrReg, [ptrReg+4] | |
| | je | .cz | ; keep skipping over ‘0’ chars |
| | dec | ptrReg | ; adjust back one char |
| | jmp | .done | |
| .c1: | ; check for sign, then next char for ‘0’ | | |
| | test | [tbl+signReg], BaseTbl.isSign | |
| | jnz | .cz | ; was sign, so check next 4 for ‘0’ |
| | cmp | byte [ptrReg-1], ‘0’ | ; no sign, check for ‘0’ |
| | lea | ptrReg, [ptrReg+4] | |
| | je | .cz | ; keep skipping over ‘0’ chars |
| .c1b: | | | |
| | dec | ptrReg | ; adjust back one char |
| | jmp | .done | |
| | ; Finished, so adj ptrReg | | |
| .d2: | inc | ptrReg | |
| .d3: | inc | ptrReg | |
| .done: | | | ; all scanning done |
| } | | | |

When control reaches .done, ptrReg points to the memory location of the first valid non-‘0’ character (or to the halt char). Sign Reg is a minus sign if the string is negative, or a non-minus sign if it is positive. The signReg value is preserved in order to ensure a negative value is returned to the caller if the string is negative. One of skill could adjust the above to test 2, 4, 8, or more ‘0’ chars as a block, rather than one at a time.

However, the overhead for this is significant if there are relatively few leading ‘0’ chars; and in such a case, once a ‘0’ char is detected in a block of bytes, the bytes would then need to be successively tested to find the byte at which to exit. If the skilled implementer believes there are, on average, enough leading ‘0’ chars to justify it, then processing them in larger blocks could be substantially faster. But according to the inventor's experience, it is not common to have multiple leading ‘0’ chars; therefore, in an initial embodiment, the one-byte-at-a-time method is used.

If desired, the macro above could be converted into a function that is called to do exactly what the macro does. This would shrink total size of the code when this SkipWsAndZeroes process is needed by more than one function. If care is taken regarding which registers are used, the function call is almost as fast as the inline code (the function call requires one CALL and one RET instruction not needed by inline code). Care is taken, however, to ensure that the function using the procedure coordinates its register usage to match those used by the SkipWsAndZeroes process in order to avoid unnecessary pushing, popping, or shuffling of registers.

Finding End of Significant Digits

Two algorithms are now described to find the end of a string of valid digits for a plain string of a specific base; this is performed before any digit chars are converted and aggregated in an accumulator. This is needed for several xxx_Add and xxx_Lea functions described in the present disclosure and is especially useful when converting decimal plain strings to floating-point numbers (see “Converting Floating-Point Numeric-Character Strings to Double”). It starts as soon as a non-‘0’ digit is found (e.g., immediately after leading zeros have been skipped, which is immediately after the SkipWsAndZeroes process completes) and generates a count representing the number of valid digits to process, and care is taken to preserve the sign information in signReg at the end of SkipWsAndZeroes.

A 64-bit integer is restricted to a maximum of 20 character digits; therefore, the maximum digits normally scanned for is 20 digits. However, when processing floating-point strings, the limit may be reduced to 18 (there can be multiple versions of the code generated by this macro, such as one for a limit of 20 and one for a limit of 18). It has been found useful to set the unroll count to a number that is equal to half the maximum digits (i.e., unroll 9 times for a limit of 18, or 10 times for a limit of 20; this works when the limit is an even number). A unique feature of the design of this loop, being unrolled either 9 or 10 times, is that the test whether the maximum has been exceeded is needed at only one point: at the bottom of the loop, and not at any other branch points if the loop is exited early, thereby saving time by not having to check the calculated count more than necessary.

(Note that in some cases, such as with functions Strtoxxx functions that return the address of the halt char, the actual end of the string of valid digits is searched for. In this case, a modified algorithm is used that does not arbitrarily stop after a maximum of two loops; one of skill can readily make the required modifications.)

The following FASM macro creates the code to count the valid digits in a base-10 plain string. The table for the target base is specified as the ‘tbl’ parameter; when processing a base-10 decimal string, this table is BaseTbl.b10. This works correctly for a limit of either 18 or 20, which accommodates all integers from 8 to 64 bits in length. If so desired, one of skill could modify this algorithm to handle smaller or larger integers. Smaller integers can be handled by decreasing the limit and/or modifying the unroll count or the maximum number of loops permitted. For 32-bit integers, for example, the limit would be 10 and the unroll count could be 5 or 10. For 16-bit integers, the limit would be 5 and there would be no need for a loop; the code would process up to 5 digits inline. For larger-bit-size integers (such as 128-bit integers), the unroll size can be changed, and/or a check on the length could be applied at each branch (the “.d” branches below) to ensure the length does not exceed the specified limit. The algorithm below needs no extra checking at the “.d#” branch exit addresses if the maximum size is an exact multiple of the unroll count.

```
macro CountValidBase10Digits tbl*, ptrReg*, testReg*,
countReg*, maxOverflow*, limit* {
; tbl is the table to use, can have any name
; ptrReg points to the start position to search
; testReg is used to test values and index tbl
; countReg will have the count of significant digits
; maxOverflow is address to jmp to if maximum overflow (not
used if limit = 18)
; limit is the max # of valid digits; it is either 18 or 20
  local .unroll, .start, .done, .done2, .d1, .d2, .d3,
.d4, .d5, .d6, .d7, .d8, .d9
  ; make sure limit is a valid value
  if limit = 18
```

| | |
|---|---|
| .unroll = 9 | ; unrolled 9 times |
| else if limit = 20 | |
| .unroll = 10 | ; unrolled 10 times |
| else | |
| err limit must be 18 or 20 | |
| end if | |

This macro allows the user to specify the table to be used and the registers to be used for determining the length; ptrReg would first be initialized to point to the first character of the plain string. Also, the maximum limit is specified and tested to signal an error if the limit is exceeded (overflow is not used if limit=18); the unroll count is set to either 9 or 10.

| | | |
|---|---|---|
| xor | countReg, countReg | ; clear counter |
| .start: | | |

| ; If the very first char is non ‘0’, | |
|---|---|
| movzx | testReg, byte [ptrReg+countReg] |
| test | [tbl+testReg], BaseTbl.invalid |
| jnz | .done |
| movzx | testReg, byte [ptrReg+countReg+1] |
| test | [tbl+testReg], BaseTbl.invalid |
| jnz | .d1 |
| movzx | testReg, byte [ptrReg+countReg+2] |
| test | [tbl+testReg], BaseTbl.invalid |
| jnz | .d2 |
| movzx | testReg, byte [ptrReg+countReg+3] |
| test | [tbl+testReg], BaseTbl.invalid |
| jnz | .d3 |
| movzx | testReg,byte [ptrReg+countReg+4] |
| test | [tbl+testReg], BaseTbl.invalid |
| jnz | .d4 |
| movzx | testReg,byte [ptrReg+countReg+5] |
| test | [tbl+testReg], BaseTbl.invalid |
| jnz | .d5 |
| movzx | testReg,byte [ptrReg+countReg+6] |
| test | [tbl+testReg], BaseTbl.invalid |
| jnz | .d6 |
| movzx | testReg,byte [ptrReg+countReg+7] |
| test | [tbl+testReg], BaseTbl.invalid |
| jnz | .d7 |
| movzx | testReg,byte [ptrReg+countReg+8] |
| test | [tbl+testReg], BaseTbl.invalid |
| jnz | .d8 |

At top before entering the loop, countReg is set to 0. For either case (limit is 18 or 20), up to 9 bytes will be tested, and when an invalid character is found, control branches to one of the “.d#” targets. If limit is 20, another byte can be tested before the end of the loop is reached:

| ; Do the next only if .unroll = 10 | |
|---|---|
| if .unroll = 10 | |
| movzx | testReg, byte [ptrReg+countReg+9] |
| test | [tbl+testReg], BaseTbl.invalid |
| jnz | .d9 |
| end if | ; if .unroll = 10 |

At the bottom of the loop, the count is adjusted and control loops back if limit has not been reached:

| ; Finished a loop, see if more to do | | |
|---|---|---|
| add | countReg, .unroll | |
| cmp | countReg, limit | |
| jb | .start | ; loop back if only first loop |

What happens next depends on the limit. If limit is 18, there may be additional valid digits, but that doesn't matter; this is being used in a special case for components of a floating-point string, so only up to the first 18 digits found matter. So if limit is reached, the process is finished, and overflow is neither identified nor handled (it does not need to be handled here):

| ; 2nd loop, so we hit max; what to do next depends on | |
|---|---|
| limit | |
| if limit = 18 | ; do this for floating point, |

| doesn′t | |
|---|---|
| | ; matter what next char is |

jmp .done
end if

However, when limit is 20, maximum overflow is identified and handled:

| | |
|---|---|
| if limit = 20 | ; do this for normal conversion |

| ; check next byte - if valid, then max overflow, else | | |
|---|---|---|
| OK | | |
| movzx | testReg, byte [ptrReg+countReg] | |
| test | [tbl+testReg], BaseTbl.invalid | |
| jnz | .done | ; next not valid digit, so no |
| overflow | | |
| jmp | maxOverflow | ; too many valid digits, so |

```
  max overflow
    end if
```

At this point, limit is 20, the count is 20, and so the next digit (the 21^{st}) is inspected. If it is valid, overflow occurs and control jumps to the code path that handles the maximum overflow. Otherwise, the process is finished and the code branches to the end of the process.

When exiting the loop, each case is handled specifically to adjust the count and then jump to .done, as follows:

| .d1: | add | countReg, 1 |
|---|---|---|
| | jmp | .done |
| .d2: | add | countReg, 2 |
| | jmp | .done |
| .d3: | add | countReg, 3 |
| | jmp | .done |
| .d4: | add | countReg, 4 |
| | jmp | .done |
| .d5: | add | countReg, 5 |
| | jmp | .done |
| .d6: | add | countReg, 6 |
| | jmp | .done |
| .d7: | add | countReg, 7 |
| | jmp | .done |
| .d8: | add | countReg, 8 |
| if limit = 20 | | |
| | jmp | .done |
| .d9: | add | countReg, 9 |

end if
.done:
; countReg has the proper value
; testReg is last byte looked at
}

Note that if limit is 20, there needs to be a “.d9” branch, so that will be created by the macro when limit is 20. There is a separate branch to match each byte tested, and the code at that branch will ensure that countReg ends up having the proper value when control arrives at the .done branch.

One of skill could modify the above macro to be a little faster. For example, the next-to-last “.d#” branch could subtract one from countReg and just fall through to the next case. For example, when limit is 20, the code at .d8 could subtract 1 from, rather than add 8 to, countReg; without having to jump, the next line would add 9 to countReg, with the end result being mathematically the same (countReg will end up having a net of 8 added to it) but without the overhead of having to jump, which is an extra instruction that can require execution time.

If desired, the macro above could be converted into a function call that calls a function to do exactly what the macro does. This would shrink total size of the code when the same CountValidBase10Digits process is needed by more than one function. If care is taken regarding which registers are used, the function call is almost as fast as the inline code (the function call requires one CALL and one RET instruction not needed by inline code). Care is taken, however, to ensure that the function using the procedure coordinates its register usage to match those used by the CountValidBase10Digits process in order to avoid unnecessary pushing, popping, or shuffling of registers.

There is a faster method that uses xmm (or wider) registers. This method can validate 16 decimal digits at a time (or 32 or more with wider registers; when using wider registers, the appropriate CPU instructions would be used, as would be understood by the skilled implementer). In this method, 16 bytes are loaded into xmm0, and a value is subtracted from (or added to) each byte. And since some integers have up to 20 valid digits, the process may execute twice; in fact, the second batch of 16 bytes can also be loaded into the xmm1 so it is ready to be processed if all of the first 16 bytes are found to be valid. There is a little bit of overhead in setting up this loop, but the process takes the same amount of time when there are 0 through 15 valid digits. When there are 16 or more valid digits, a second batch of bytes is processed, increasing execution time.

CPU instructions from the SSE2, SSE3, and SSSE2 instruction sets can be used to perform these operations in parallel, as detailed below. Some of these instructions can be used, as is known to those skilled in the art, to compare multiple bytes at a time; as a result, the bytes in the destination xmm register is set to reflect the results of the test: the value 0 is used if the comparison is true, and −1 is used if it is false. The results are converted into a single general-purpose register, which can then be scanned to identify the first set bit, i.e., the position of the first invalid byte. Since the Intel CPU's BSF command is used to find the first set bit of a register, and since when scanning the bits we want to skip over any valid digits, the operations below are specifically designed such that the PCMPGTB instruction sets the byte to 0 (i.e., all bits clear) if the test for that byte is true, else to −1 (i.e., all bits set) if false.

Here is one sequence of commands that loads 16 bytes, prepares them to be tested so that valid bytes indicate 0 and invalid indicate −1, and then executes the test and scans the results. Each instruction will be explained in detail below:

| movdqu | xmm0, dqword [edx] |
|---|---|
| psubb | xmm0, dqword [.Prep0] ; subtract from each byte |
| pcmpgtb | xmm0, dqword [.TestDigits] ; compare if greater |
| than | |
| pmovmskb eax, xmm0 | |
| bsf | eax, eax |
| jz | .more ; if no bit found, all digits are valid |
| ret | |

The first instruction loads 16 bytes into xmm0. When the memory to be accessed is aligned on 16-byte boundaries, all bytes can be loaded as fast as one single byte would load from that cache line; and in that case, the MOVDQA instruction can be used. Otherwise, when all 16 bytes reside within the same cache line (or 8-byte boundaries on some CPUs, such as the inventor's Intel Core2 Duo, when the 8-byte-aligned 16 bytes straddle a cache-line boundary), the MOVDQU instruction can be used, taking up to about twice as long as the aligned MOVDQA instruction.

When a portion of the data being loaded straddles a cache-line boundary, however, the MOVDQU instruction could require up to 8 times longer to load the data, or worse. On most modern Intel CPUs a cache line is 64 bytes in length (with offsets from 0x00 to 0x3f; if the cache line changes, one of skill could easily modify this algorithm to deal with the new boundaries). Many numeric strings could have some 16-byte load operations that straddle this boundary. When the line is crossed, everything still works; but it can slow down to about the speed of loading each byte one at a time. (Note: the inventor is aware that certain CPUs, such as AMD's, have been reputed to be not nearly as susceptible to this cache-line boundary issue. Also, Intel is addressing this slowdown issue, and it should become less of any issue with next-generations CPUs. However, it has always been true that accessing unaligned data is slower than accessing aligned data, and this will likely still be the case for many years.)

It is desirable in many cases to avoid that slow down; here are some methods to do so.

First, with Unicode8 characters, up to two 21 bytes could be checked, requiring loading of two 16-byte blocks of data when using xmm registers (or one block with 32-byte ymm registers); with Unicode16, twice as many bytes could be loaded, requiring loading of three 16-byte blocks with xmm registers (or two blocks with 32-byte ymm registers). The skilled implementer can adjust the steps described below to accommodate either registers larger than 16 bytes, and/or to allow for Unicode16 characters.

The low 6 bits of the starting memory address can be checked to see if a load would cross the boundary; these bits are the offset into a 64-byte cache line. Therefore, any 16-byte load that starts at offsets 0x0 to 0x30 in the cache line will not cross that boundary (any 32-byte load will not cross the boundary if located at offsets 0x0 to 0x20). A load of 16 bytes that starts at exactly offset 0x30 will load fine; and since the next batch starts 16 bytes later, it is located at offset 0x00 of the next cache line, meaning that neither load operation accesses a block of data that straddles the cache-line boundary. Any load starting at cache-line offset 0x31 or higher will encounter the cache-line boundary. In the inventor's experience, the time spent testing for these cases has been found to more than make up for the cost of performing the tests.

On some CPUs, the LDDQU instruction can be used in place of the MOVDQU instructions for loads determined to cross the boundary (it has been found that this instruction performs the same as the MOVDQU on the inventor's Intel Core2 Duo, with no improvement when straddling the boundary). The MOVDQU instruction is used for any access that does not cross the boundary, and the LDDQU instruction is used for the others.

Alternatively, the PALIGNR command can be used in conjunction with two MOVDQA aligned accesses. Data is loaded from the nearest aligned address below the target address (by clearing the low 4 bits of the address), and also from the address 16 bytes higher using two MOVDQA instructions to load the data blocks into two xmm registers. Then, the data from the two registers is combined via the PALIGNR instruction, causing bytes to shift from the higher position into the lower, to end up having the register filled with 16 bytes as though it had been loaded with the MOVDQU command from the target address.

It should be noted that the cache-line issue affects every data access when more than a single byte is accessed at the same time, where the load would straddle a cache-line boundary (all single-byte accesses are always aligned; bytes do not straddle cache-line boundaries). Straddling a page boundary causes a much greater slowdown, but it can be ignored as long as the cache-line boundary situation is addressed.

Another method, used in some embodiments, is to simply ignore the cache-line boundary issues and to use MOVDQU instructions. This simplifies the coding, and over time, this hardware CPU-related issue will become less and less of an issue as the CPU manufacturers continue to improve access to data units that straddle cache-line boundaries.

The (V)PSUBB line prepares the bytes in the xmm register to be compared via a signed-byte comparison in the next instruction. Each byte is to be inspected to determine if it is valid. The .b10 table could be consulted, using each byte as an index to return a result indicating whether it is valid or not. But the SIMD instructions do not presently have an instruction that can inspect each byte, via another table, to determine its validity.

In a naïve test, each byte can be tested individually; if it's either lower than ‘0’ or higher than ‘9’, it is invalid. But that requires two comparisons before it is known that a character is a valid digit. It is known to those skilled in the art that, if the value ‘0’ is subtracted from a byte and the result is LTE 0x09, the character is a valid base-10 digit; otherwise it is invalid.

But this works only with unsigned integers (8-bit bytes, in this case), yet the PCMPGTB instruction treats each byte as though it were signed. So if ‘0’ (equal to 0x30) is subtracted from each byte, then the digit ‘0’, for example, would have the value 0. But in a signed comparison, there are still 128 bytes with a value less than that (the values −1 through −128), meaning that the above test, which assumes that only values greater than 9 are valid, will effectively also deem all values less than 0 as valid (all 128 possible values).

Therefore, all the bytes are adjusted so that the digit ‘0’ will be pushed to the floor, so to speak, or so it will have the value −128; for a byte, there is no lower signed value. This makes all valid digits have values from −128 to −119; any byte greater than −119 is then invalid. Therefore, the value (128+‘0’=0xb0) is subtracted from each byte via the (V)PSUBB instruction; the memory location .Prep0 consists of 16 bytes each equal to the value 0xb0. Note that a PADDB instruction could be used instead, adding the value (0x100−0xb0=0x50) to each byte.

The (V)PCMPGTB instruction then compares each byte, in parallel, with the value −119 (the 16 bytes located at .TestDigits are each equal to 0x89, which is −119 decimal). After the instruction, each byte of xmm0 will have the value −1 if the byte is not a valid digit, or the value 0 if it is valid. If all 16 bytes are valid digits, xmm0 will become 0. (As an alternative, the digits could be pushed to the ceiling, so to speak, such that the character ‘9’ will have the highest signed value of 127, causing all valid digits to be in the signed range from 118 through 127. The (V)PCMPGTB instruction can be used to then determine which bytes are valid by testing for all bytes greater than 117. The result, prior to executing the BSF instruction, should then have all bits flipped via the appropriate NOT instruction, or with the XOR instruction against a register or memory location having all bits set, so that all valid bytes are cleared, rather than set). Note that for Unicode16, the (V)PCMPGTW instruction is used, unless the characters have been converted to Unicode8.

The (V)PMOVMSKB instruction compresses the results from xmm0; it takes the high bit of each byte to create a mask in a register which can be tested. The BSF instruction scans eax, starting at offset 0, and returns a value indicating the bit offset where the first set bit was found; this causes eax to contain the offset of that bit, which is also equal to the number of consecutive valid digits found, starting at the memory location edx. (There is one exception to this; if the zero flag is set, it means no bits were set, or in other words, all the digits were valid. In this case, the next group of 16 bytes is loaded into a register and the process is repeated.) If a set bit is found, the process is complete and the value in eax is returned to the caller. If a second batch is found, the found address in eax is increased by 16 and returned to the caller. But if the second batch also contains 16 valid digits, the value 32 is returned.

Note that for purposes of converting numeric strings into 64-bit integers, there is normally no need to test more bytes; however, for larger integers, such as 128-bit integers, the algorithm is adjusted to allow for sufficient digits for the larger-bit format. When the address of the halt char is to be returned to the caller, however, the process can continue until finding the first non-valid digit; it is known that when the number of valid digits exceeds the maximum, the number has obviously overflowed, in which case no actual conversion needs to take place, and the overflow value (equal to −1) is returned.

There are other ways in which 16 bytes at a time could be tested. For example, if the operands are reversed, using the (V)PCMPGTB instruction results in the equivalent of a “less than” comparison; this can work when pushing the values “to the floor” rather than to the ceiling. Or, all bytes could be tested for equality to ‘0’ with results being placed into xmm1, for example, via the (V)PCMPGTB instruction. Then, all bytes could be adjusted so that the digit ‘1’ is at the floor of the signed-byte range (by subtracting the value 0xb1, for example); the bytes could then be tested to see if any value is greater than 8, meaning it is invalid, with the results of that test merged into xmm1. Then xmm0 could be merged with xmm1 with the (V)PANDN instruction to obtain the final results, which are then converted into a mask and tested. There are numerous other methods such as these that can merge results of two or more tests, or that can use larger registers (such as the ymm registers); but to be sufficiently quick, they need to use the (V)PCMPGTB and (V)PMOVMSKB (or equivalent) instructions.

A similar test, as outlined above, can also be used to count the number of valid base-2 or base-8 digits by adjusting for the difference in the number of valid digits in each respective base alphabet. Additionally, one could modify the above to allow for counting the number of valid base-16 digits. In such a scenario, the proper value for each byte would be first loaded into bytes of an xmm, mm, ymm, or other such register; since the valid values range from 0 to 15, the algorithm would be adjusted to account for 15 possible valid values. It might be desired to test validity of a group smaller than 16 bytes, however, to improve the speed if many smaller values are anticipated. Note that, in place of xmm registers, the skilled implementer could use any of the mm, ymm, or other registers that allow parallel operations such as has been detailed above.

The function CountB10Digits shows one implementation using xmm registers as just explained above:

;<<<<<<<<<<<<<<<<<<<<<<<<<<<<<<<<<<<<<<<<<<<<<<<<<<<<<<<<<<
; Count the number of valid base-10 digits, starting at edx
;
; int CountB10Digits(edx=ptr);
;
; Uses fast method to count the digits in a string, assumes
first
; digit is valid (if not, returns 0).

| | |
|---|---|
| ; Input: | edx is ptr to Unicode8 string to check |
| ; Output: | eax is count (0 to 31) |
| ; | trashes xmm0, possibly xmm1 (depends on method |

used)

Note: this is outside range of valid 64-bit integers (max is 20), but this helps identify if overflow occurs (any value >20 means unsigned overflow). Cache-line issues: if the access crosses a 64-byte cache line, the algorithm becomes MUCH SLOWER (up to 8X!). Can use movdqu when the full read is within the cache line, or is 8-byte aligned; movdqu takes almost twice as long as movdqa. The LDDQU instruction can be used when cache lines are split, EXCEPT that it doesn't work on Core2 CPUs—it's just the same as two movdqu instructions, and totally slows down when straddling cache-line boundary.

| align 16 | | | |
|---|---|---|---|
| CountB10Digits: | | | |
| ; Smallest method - reading 32 bytes | | | |
| ; First, see if there′s a cache-line issue, if so, do | | | |
| ′other′ algorithm | | | |
| test | edx, | 0xf | ; aligned? |

| jnz | .notAligned | |
|---|---|---|
| movdqa | | xmm0, dqword [edx] |
| .cont: | | |
| psubb | | xmm0, dqword [CountFastTbl.Prep0] |
| pcmpgtb | | xmm0, dqword [CountFastTbl.TestDigits] |
| pmovmskb eax, xmm0 | | |
| bsf | eax, | eax |

| | | |
|---|---|---|
| jz | .more | ; if no bit found, all digits |

| are valid | | | |
|---|---|---|---|
| ret | | | |
| align 16 | | | |
| .more: | | | |
| ; check next 16 bytes . . . | | | |
| movdqa | | xmm0, dqword [edx+16] | |
| .cont2: | | | |
| psubb | | xmm0, dqword [CountFastTbl.Prep0] | |
| pcmpgtb | | xmm0, dqword [CountFastTbl.TestDigits] | |
| pmovmskb eax, xmm0 | | | |
| bsf | eax, | eax | |
| jz | .tooMany | | ; too many found |
| add | eax, | 16 | |
| ret | | | |
| .tooMany: | | | |
| mov | eax, | 32 | |
| ret | | | |
| align 16 | | | |
| .notAligned: | | | |
| ; if in lower half of cache line, can use movdqu | | | |
| test | edx, | 0x20 | ; is bit set? |

| | | |
|---|---|---|
| jnz | .doPalignr | ; yes, so use PALIGNR method |

| ; OK to do movdqu . . . | | |
|---|---|---|
| movdqu | | xmm0, [edx] |
| psubb | | xmm0, dqword [CountFastTbl.Prep0] |
| pcmpgtb | | xmm0, dqword [CountFastTbl.TestDigits] |
| pmovmskb eax, xmm0 | | |
| bsf | eax, | eax |

| | | |
|---|---|---|
| jz | .notAlignedMore | ; if no bit found, all |

| digits are valid | | | |
|---|---|---|---|
| ret | | | |
| .notAlignedMore: | | | |
| movdqu | | xmm0, [edx+16] | |
| jmp | .cont2 | | |
| .doPalignr: | | | |
| ; Different beast here, need to align chunks | | | |
| mov | eax, | edx | |
| and | eax, | 0xf | ; isolate cache-line offset |

call dword [.Tbl+eax*4-4]

Now, process as above . . .

| psubb | | xmm0, dqword [CountFastTbl.Prep0] |
|---|---|---|
| pcmpgtb | | xmm0, dqword [CountFastTbl.TestDigits] |
| pmovmskb eax, xmm0 | | |
| bsf | eax, | eax |

| | | |
|---|---|---|
| jz | .morePalignr | ; if no bit found, all digits |

| are valid | | | |
|---|---|---|---|
| ret | | | |
| .morePalignr: | | | |
| push | edx | | |
| add | edx, | 16 | |
| mov | eax, | edx | |
| and | eax, | 0xf | ; isolate cache-line offset |

| call dword [.Tbl+eax*4-4] | |
|---|---|
| pop | edx |
| jmp | .cont2 |

align 4
label .Tbl dword

Need only 15 branches, since call subs 1 entry from target:

```
  dd .1, .2, .3, .4, .5, .6, .7, .8, .9, .10, .11, .12, .13,
.14, .15
  rept 16 n {
.#n:
```

| | | |
|---|---|---|
| movdqa | xmm1, dqword [edx-n] | ; read one byte to |

left of target

| | | |
|---|---|---|
| movdqa | xmm0, dqword [edx+(16-n)] | ; load last group |
| palignr | xmm0, xmm1, n | |

```
    ret
  }
align 16
label CountFastTbl byte
```

| | | | |
|---|---|---|---|
| .Prep0 | db | 16 dup (128+′0′) | ; sub this value to push |

to smallest neg number

| | |
|---|---|
| .TestDigits db 16 dup (−128+9) | ; lowest 10 values |

good, all others invalid

| .Zeroes db | | 16 dup (′0′) |
|---|---|---|
| .Fives | db | 16 dup (5) |
| .9bytes | db | 16 dup (9) |

;>>>>>>>>>>>>>>>>>>>>>>>>>>>>>>>>>>>>>>>>>>>>>>>>>>>>>>>>>>

Detecting Overflow when Converting Strings

Strings to be converted sometimes result in numbers that overflow the minimum (in the case of signed numeric types) or the maximum allowable value for the target number's bit size. In such conditions, an overflow has occurred. Whether overflow occurs depends on the number of valid digits in the string, the range of the result value, the sign of the string being converted, and/or the type of value ultimately returned to the caller (i.e., signed or unsigned). Note that in some embodiments, many of the conversion requirements are relaxed; if a number is invalid for its return type, no special effort is made to determine overflow and, therefore, undefined behavior can result. However, it is assumed in the present disclosure that it is more useful to ensure the converted number is within valid bounds for the target number type.

For any valid integer, the minimum and maximum valid values are as follows. For unsigned integers, the minimum is 0 (there cannot be a lower value; same as having all bits clear), and the maximum is equivalent to the number determined when all bits of the integer are set. For signed integers, the minimum value is equivalent to the number determined when the sign bit is set and all other bits are clear; the maximum is equivalent to the number determined when the sign bit is clear and all other bits are set.

For unsigned numbers, maximum overflow occurs if the number represented by the string has a value that exceeds the range for 64-bit unsigned integers, or 18,446,744,073,709,551,615; note that this maximum value has 20 digits. Unsigned numbers do not have a minimum overflow (zero is the lowest value for unsigned numbers).

For signed numbers, maximum overflow occurs if the unsigned value for a positive string is large enough that its high bit is set (this bit is reserved to signify signed numbers); minimum overflow occurs if the high bit of the aggregated result during conversion is already set, prior to attempting to negate the unsigned value captured for a negative string. Since it is relatively simple for the unsigned version of the conversion function to identify signed minimum overflow, it can do so (unless it is used as a stub function as explained below); but since it returns an unsigned value, it does not identify maximum overflow for signed numbers (this validation is left for the signed version). This behavior is explained in more detail below.

When designing a string-conversion function, it is helpful to first create a function to convert numeric strings to an unsigned integer of the target bit size. Then, if it is desired to have a signed-integer version, the signed version of the conversion function can be a stand-alone version replicating the functionality of the unsigned version and performing additional processing required for returning a valid signed result; or it can call the unsigned version, and then do any needed extra processing to determine whether signed overflow occurred.

The next few paragraphs describe the processes that take place within the unsigned version of the function. For this description, 64-bit unsigned integers are assumed. One of skill could adapt this information to apply to smaller- or larger-bit-sized integers. Even though the function is nominally called ‘unsigned’, it still processes the number as found in the string (any time a string is negative, the value to be returned is first negated). If there is no minus sign and the value did not overflow, the value is returned as converted, and the calling function treats the returned value as unsigned. As is known in the art, often the value “−1” is used as a shortcut to assign the maximum value to an unsigned number; when the positive number “1” is made negative, it is converted into the value 0xffffffffffffffff, which is equal to −1 when treated as a signed integer, or is otherwise the maximum value for an unsigned number.

Detecting overflow for positive strings: If there are too many digits (more than 20), the 21^{st} digit is considered invalid, and a maximum overflow occurred. If, when aggregating the values of the valid digit characters (where there are 20 characters in the string) an overflow occurs due to the aggregated value exceeding the maximum value for an unsigned integer, it is a maximum overflow. If no overflow occurs, the converted result is returned. Otherwise, maximum overflow occurred, and the maximum unsigned value −1 (0xffffffffffffffff) is returned to the caller. When there are fewer than 20 character digits, there is no unsigned overflow.

Detecting overflow for negative strings (assumes a valid minus sign in the numeric string) within the unsigned conversion function: If there are too many digits (more than 19), the 20^{th} digit is considered invalid and a minimum overflow occurred. Otherwise, the value for the number is converted and detection of minimum overflow is postponed until the sign of the string is checked near the end. Just before returning to the caller, edx:eax is tested to see if the sign bit (the highest bit of edx) is set (for 64-bit numbers, the sign bit of the lower eax portion does not matter). If the sign bit of edx is set, that means the number is too large to be a signed integer, i.e., it is outside the valid range for negative numbers, and a minimum overflow has been detected; in this case, the minimum signed value 0x8000000000000000 is returned to the caller. Otherwise, the original result is negated and then returned.

Thus, the unsigned conversion function detects maximum overflow for positive strings, and minimum overflow for negative strings. Its returned value, however, is interpreted as an unsigned integer. When implemented as further detailed in several of the conversion functions in the present disclosure, the esi register contains the address of the halt char; if desired, one of skill could modify the function to either use a different register, or the function could receive the address to be updated with the location of the halt char, and then update that position when the halt char is determined (as is done in some implementations detailed in the present disclosure).

The next few paragraphs describe the processes that take place within the signed version of the function. For this description, it is assumed that a 64-bit signed integer is to be returned to the caller. It is further assumed that the signed version calls an unsigned conversion function that initially processes the string (and modifies the return value in the event of maximum unsigned overflow). The unsigned function returns the aggregated result in edx:eax, and ecx contains a minus sign if the string was negative, else it contains any other undefined value; and esi can be assigned the address of the halt char.

Once the call to the unsigned function returns, the sign of the returned value is inspected. If the sign is set, overflow has occurred; if the numeric string is negative, negative overflow occurred, and the value 0x80000000 is returned to the caller, otherwise positive overflow occurred and the value 0x7fffffff is returned. If the sign is clear, the returned value is currently positive, and it is determined if the numeric string is negative; if so, the number is negated and then returned, otherwise the value returned to the caller is unchanged.

In alternative embodiments, the signed function does all the processing itself without first calling an unsigned function. This can be slightly faster, but at the expense of increasing the code by an amount just about equal to the size of the code that handles unsigned conversions.

Stub and Core Functions

This section describes how to design and create an unsigned Coreto64 function that is called by multiple stub functions, both signed and unsigned; the Coreto64 function works efficiently and returns or updates multiple values (the converted number, the sign found, and the address of the halt char) to the stub functions.

Assume the following four stub functions 208 are desired, all of which convert a base-10 decimal string to a 64-bit integer, and which will call the function Coreto64 to convert a numeric string into a 64-bit unsigned integer:

_i64 Atoi64(char *str);
_u64 Atou64(char *str);
_i64 Strtoi64(char *str, char **haltChar);
_u64 Strtou64(char *str, char **haltChar);

The first two stub functions return the value of a converted string. The second two, in addition to returning a string's converted value, also update a pointer that shows where that numeric string's valid digit sequence ended. (When scanning and parsing strings that have multiple components, it is useful to have each function that processes a component within the string update a pointer to show the point in the string where it stopped scanning and parsing. When converting numeric-character strings to a number, that point is usually the address of the first invalid character detected; alternately, it can be address of the first invalid character if there were too many valid characters such that the number overflowed.) The stub functions ending with “i64” return signed values, while the stub functions ending with “u64” return unsigned values.

If desired, one of skill could add a radix parameter to any of the above, allowing the called function to handle conversion to integer from bases other than decimal (assuming the needed code to do this is also added, of course); the radix value could be limited to a specific range, and/or used as an index into a jump or call table used to call the appropriate unsigned process. In addition, stub functions returning 8-bit, 16-bit, and 32-bit values can also call the Coreto64 function; they would do additional processing on the returned value to ensure it is within the proper bounds for that bit size (converting a larger to a smaller type is known to those skilled in the art).

The main work of the algorithms for each of the above functions can be identical, with each calling Coreto64 to do the main work. Immediately prior to calling Coreto64, a register (or parameter) is set to point to the numeric string, and another (such as esi when using 32-bit Intel assembly language) is set to the memory address to update if the position of the halt char is needed, or it is set to 0 if no update is needed. Coreto64 is then called; it updates the address of the halt char if esi is not 0, and it returns the converted value in edx:eax and the sign of the string in ecx (if ecx is equal to ‘−’ the string is negative; otherwise, it is positive). Once Coreto64 returns, additional processing is needed for functions returning a signed value, as explained below.

With this design, here is how the four stub functions would behave:

Atoi64: Preserves esi, sets it to 0, sets a register to point to the numeric string, then calls Coreto64. It then restores esi and checks the sign of the returned number. If signed, the number has overflowed; if ecx indicates a negative string, minimum overflow occurred and the value 0x8000000000000000 is returned, otherwise positive overflow occurred and the value 0x7fffffffffffffff is returned. If the returned string is positive, ecx is checked; if a negative string is indicated, the value edx:eax is negated and returned to the caller; otherwise edx:eax is returned unchanged.

Atou64: Preserves esi, sets it to 0, sets a register to point to the numeric string, then calls Coreto64 which returns the proper result in edx:eax. After restoring esi, if ecx indicates a positive string, edx:eax is returned to the caller unchanged. Otherwise the string is negative; if edx indicates the value returned from Coreto64 has the sign bit already set, minimum overflow occurred and the value 0x8000000000000000 is returned to the caller.

Strtoi64: Preserves esi, sets esi equal to the haltChar address pointer, sets a register to point to the numeric string, then calls Coreto64. When Coreto64 returns, it performs the same processing as Atoi64, in order to check validity of the signed value to be returned, prior to returning to the caller.

Strtou64: Preserves esi, sets esi equal to the haltChar address pointer, sets a register to point to the numeric string, then calls Coreto64. When Coreto64 returns, it performs the same processing as Atou64, in order to check validity of the signed value to be returned, prior to returning to the caller.

When done in this way, the caller need not know or care that the signed and unsigned functions are stub functions 208; in addition, the total size of the code 206 needed to handle multiple variants of the core function 210 is reduced considerably. And using just one core function (such as Coreto64) to do the main converting for all the functions simplifies code maintenance. Following this same pattern, a skilled implementer can create other related functions that use the same core, if desired.

Note that in some language implementations (come versions of C++, for example), the above level of detail to handle overflows may or may not be performed. Microsoft Visual Studio C++ appears to process conversions in the manner just described, while other implementations may not do much processing in the event of overflows (some instead document that result values returned in the event of overflow are undefined). In some embodiments, any overflow results in the value 0 or −1 being returned to the caller.

Note that in some implementations, the address pointer to the haltChar address is always assumed valid and the address of the halt char will be stored at that location without checking the parameter first; this operates a bit more quickly (avoiding the instructions needed to quickly validate haltChar) but can produce unpredictable results if the address is incorrect.

Coreto64 can be nearly identical to the Atou64_Lea function described in the present disclosure, with additional changes made in order to handle updating the halt-char address (and to handle not updating it) as herein explained. When called by the stub functions, Coreto64 needs to know the start of the string to process and the address for the halt char. When designed in assembly language, these can be passed in registers, and the stub functions can easily identify the string's sign from the ecx register returned from Coreto64.

Due to limitations for most C, C++, or similar languages, a prototype for the core function would need to provide pointers to variables or a structure that can hold the sign and halt char; one possible solution is this:

unsigned long long Coreto64(char *str, char **haltChar, int *sign);

This allows the core function to process the string, return the value as an unsigned 64-bit integer, and update a pointer to the halt char and return the sign, although it would also require parameters to be repushed on the stack (or, a pointer to those original pointers is pushed). Some of the issues are simplified in 64-bit software where parameters are passed in registers, eliminating some or all repushing of parameters; however, accommodation for returning the sign is still necessary so that stub functions can do any needed processing for returning signed values (or smaller-bit values, if so desired).

A complete example, written in FASM assembly language, is described in the “Coreto64_B10 Core Function” section.

Converting Base-2 Character Strings

In base-2 strings, the data to extract from each valid char is the single bit at offset 0. In each character string, there can be whitespace characters, and/or an optional sign character, followed by any number of leading ‘0’ characters before the first valid ‘1’ digit; there can be up to 64 valid significant digits (if there are more, the calculated value would exceed 64 bits and is thus invalid for 64-bit conversions). Leading ‘0’ characters do not impact the final value of the converted string; in some embodiments, all leading ‘0’ characters are first identified and then quickly skipped.

The function Strtou64_b2, shown below, converts a signed base-2 Unicode8 string into a 64-bit signed integer. It has the following prototype:

_u64_stdcall Strtou64 b2(char *str, char **haltChar);
where ‘str’ points to the string to be converted, and ‘haltChar’ points to the memory address of a pointer to be updated with the position address of the halt char; note that the parameters and output of this function are similar to the C++ function _strtoui64, although it lacks the ‘radix’ input parameter (in this example, it is known that the base is 2; therefore, a radix parameter is unneeded).

The tables BaseTbl.b2 and BaseTbl.ws are required by the function Strtou64_b2. The entries in the .b2 table for each valid digit entry will equal the value represented by that character. For example, the entry represented by the digit ‘1’ (located at offset 0x31 of the table, or at entry .b2[0x31]) will contain the value 1. This information, which is stored in the low bits of each valid digit entry, is not actually needed when converting base-2 or base-8 strings; but the fact that the high bit (the sign bit) is set for all invalid entries, and that it is clear for all valid entries, is used as detailed in the algorithms below. (For other base tables, such as the .b16 table used to convert base-16 strings, the actual value represented by that character is used during the conversion; see “Converting Base-16 Strings”). In any event, all valid digit entries for each base-conversion table normally have the .invalid bit clear (an exception is shown for the .b16 word table elsewhere in the present disclosure).

The bits of each entry provide information needed by the algorithm. If a character is invalid, its upper bit (at offset 7) is set; for valid digits, no bits are set and the CPU's zero flag will be set when the .invalid bit is tested. Note that when the table entries for valid digits contain the value of that digit, a valid entry can be tested by accessing the table in at least three different ways (this applies to any base): the sign bit can be tested (if set, it's invalid; this works only when .invalid affects the high bit, which is also the sign bit); the .invalid bit can be tested (if set, it's invalid; note that as described herein, the .invalid bit is also the sign bit for an 8-bit byte); or the value of the entry can be tested by comparing it with the base—if it's less than the base, it's valid (because the .invalid bit is not set). Note that for a base-2 conversion, the table is not actually required in order to differentiate between valid digits and non-valid characters. Any character with any set bits other than the bit at offset 0 is invalid (.i.e., if all the upper bits are clear, it's a valid digit).

For this example, assume the following base-2 string is to be converted:

| str: db ′ -0010111010111010100001101111101010000ABC′ , 0 | | | |
|---|---|---|---|
| offset: | 1 | 2 | 3 |

xxxxx01234567890123456789012345678901234567

Conversion starts by first processing whitespace, the sign, and any leading zeroes; once completed, the first significant digit is identified (the first ‘1’ in the string, at offset 0 above; the ‘x’ offsets represent characters skipped over; see “Filtering Whitespace and Leading Zeroes”) and the captured sign (‘−’) is preserved (it can be saved to a variable or register, or pushed on the stack); it is accessed after the digits are processed to determine if the string is negative.

When coding the algorithm in assembly language, the skilled implementer can delay creating a stack frame with local variables until it is determined that the string starts with a valid character; this allows the function to exit more quickly when invalid strings are encountered, and this can be done so it does not slow down execution speed when valid data is encountered. Once it is determined the data is valid, the stack frame can be created and stack memory can be allocated for any needed local variables, as is known in the art. This applies to conversions of any base, not just this base-2 example.

At this point, the main loop is entered. In a 32-bit execution environment, 4 bytes are processed together; 8 can be processed in a 64-bit execution environment. With base-2 strings, the low bit at offset 0 is extracted, but only if the character is valid. Any character is valid if, after clearing the low bit, the result is exactly 00110000b; the 7 upper bits can be isolated by ANDing each byte with the mask 0xfe. If it's a valid digit, the result will be the value 0x30. To illustrate further, here is the binary representation of the two valid digits:

| | | |
|---|---|---|
| ′0′ hex: 0x30 binary: | 00110000b | |
| ′1′ hex: 0x31 binary: | 00110001b | |
| | ------- | <-- upper 7 bits |

underlined

At each iteration of the loop, 4 bytes from the string are obtained, a copy is made, the upper 7 bits of each byte are isolated via the mask 0xfefefefe (result is in ebx). Then if ebx is equal to 0x30303030, all four bytes are valid, and the bit to extract is in the low-bit offset of each byte in ecx; the lower bits in ecx can be isolated by ANDing ecx with the mask 0x1010101.

Assume that registers esi and edx are used to obtain the next group of bytes from the string (edx is a negative count-down register, while esi points to the end of the chunk of characters that will be processed in the loop), the following code can be used to determine if all four bytes are valid:

| | | | |
|---|---|---|---|
| mov | ecx, | [esi+edx] | ; get four bytes |
| mov | ebx, | ecx | ; ebx is temp copy |

; See if the lo bit of each byte is the only difference

| | | | |
|---|---|---|---|
| and | ebx, | 0xfefefefe | ; clear lo bit |
| cmp | ebx, | 0x30303030 | ; are all bytes valid? |

| | | |
|---|---|---|
| jne | .last3 | ; no, so handle one byte at a time |

The register ebx contains the isolated high 7 bits of each byte; if ebx is not equal to 0x30303030, at least one of the bytes is invalid, which means there are 0 to 3 possible valid bytes; these are then inspected starting at the .last3 branch. Otherwise, all 4 bytes are valid and the data bits, one from each byte, are extracted and moved into an accumulating register (eax, in the following example). These data bits are shifted into proper position, the registers are ORed with each other, the accumulator is shifted to accommodate 4 more bits, and the resulting bits are ORed into the accumulator. This can be done as follows:

| | | |
|---|---|---|
| and | ecx, 0x1010101 | ; isolate lo bit for all bytes |

| | | |
|---|---|---|
| shl | eax, 4 | ; open up bit positions in eax |
| mov | ebx, ecx | ; treat ecx as temp copy |
| shr | ebx, 16 | ; 9: cx has first 2 bytes, bx has next 2 |

| bytes | | |
|---|---|---|
| shl | cl, 3 | ; move data from first byte to hi |
| position | | |
| shl | ch, 2 | ; move data from second byte to |
| next pos | | |
| shl | bl, 1 | ; move data from third byte to next |

| pos | |
|---|---|
| | ; bh (4th byte)already in proper pos |

| ; Combine the data | |
|---|---|
| or | bl, bh |
| or | cl, ch |
| ; Move into accumulator eax | |
| or | al, bl |
| or | al, cl |

A skilled implementer can insert the above code into a loop of 8 iterations in order to extract up to 32 data bits from 32 source bytes, accumulating the bits in the 32-bit eax register. If fewer than 32 characters are valid, control will branch to the ‘.last3’ path, described below. Otherwise, with 32 valid characters converted, the accumulator is saved to a variable ‘hiDword’, and source pointers and counters are adjusted to allow the next group of up to 32 characters to be handled, 4 at a time, until either too many valid characters have been processed, or until an invalid character is found. When modifying this algorithm to convert into larger-bit integers, such as 128-bit integers, the main loop may be processed multiple times, and separate storage and/or accumulators can be used as each group of 32 characters is converted (or 64, when 64-bit accumulators are used, as for example, in 64-bit code); then when a non-valid character is found, the accumulated values will be concatenated appropriately by methods known to those skilled in the art. The skilled implementer could unroll the core process, if desired, using techniques known in the art.

A slightly faster method depending on the LEA instruction can be used, instead of the above, once it has been determined that the next four bytes are valid digit characters. Here is the code:

| ; use LEA method to combine bits... | |
|---|---|
| ; ebx is available | |
| movzx | ebx, cl |
| lea eax, | [eax*2+ebx−‘0’] |
| movzx | ebx, ch |
| shr ecx, | 16 |
| lea eax, | [eax*2+ebx−‘0’] |
| movzx | ebx, cl |
| lea eax, | [eax*2+ebx−‘0’] |
| movzx | ebx, ch |
| lea eax, | [eax*2+ebx−‘0’] |

In this method, the addressing modes available on the Intel CPU are used via a shortcut that allows the accumulator to be shifted left one bit (i.e., multiplied by two), have the character found added to it, and have the base value ‘0’ subtracted from the total . . . all in a single, very fast instruction.

As an alternative method on CPUs with the BMI2 instruction set (such as Intel Haswell processors), the PEXT instruction can be used to quickly move all the data bits from ecx into proper position and to eliminate the need for most of the above bit-shuffling instructions; the resulting value can then be ORed into the eax register, after eax is shifted to make room for the new data bits. This can be done by replacing the instructions that first load the four bytes, test them, and then insert the data bits into the register:

| ; if BMI2 pext instruction available... | | | |
|---|---|---|---|
| mov | ecx, | [esi+edx] | ; get four bytes |

| mov | ebx, | ecx ; ebx is temp copy | |
|---|---|---|---|
| ; See if the lo bit of each byte is the only difference | | | |
| and | ebx, | 0xfefefefe | ; clear lo bit |
| cmp | ebx, | 0x30303030 | ; are all bytes valid? |

| | | |
|---|---|---|
| jne | .last3 | ; no, so handle one byte at a time |

| ; Four valid bytes, so convert | | | |
|---|---|---|---|
| bswap | | ecx | ; change order of bytes so bits arrive |
| in order | | | |
| | | ; for little-endian CPU | |
| shl | eax, | 4 | ; open up bit positions in eax |
| pext | ecx, | ecx, | 01000000010000000100000001b |
| or | eax, | ecx | |

One more alternative uses the PMOVSMKB instruction to more quickly collect the data bits. For example, the following code uses this instruction with an xmm register:

| ; if using PMOVMSKB instruction... | | | |
|---|---|---|---|
| mov | ecx, | [esi+edx] | ; get four bytes |

| | | | |
|---|---|---|---|
| mov | ebx, | ecx | ; ebx is temp copy |

| ; See if the lo bit of each byte is the only difference | | |
|---|---|---|
| and | ebx, | 0xfefefefe ; clear lo bit |
| cmp | ebx, | 0x30303030 ; are all bytes valid? |

| | | |
|---|---|---|
| jne | .last3 | ; no, so handle one byte at a time |

| ; Four valid bytes, so convert | | |
|---|---|---|
| bswap | ecx | ; change order of bytes so bits |
| arrive in order | | |

| | | | |
|---|---|---|---|
| shl | eax, | 4 | ; open up bit positions in eax |

| | | | |
|---|---|---|---|
| shl | ecx, | 7 | ; move all data bits to sign bit |

| movd | xmm0, ecx | |
|---|---|---|
| pmovmskb ecx, xmm0 | | |
| or | eax, | ecx |

When too many valid characters are found, or when the number has otherwise exceeded the maximum allowable value, the number has overflowed, and the result is handled as described in the section “Detecting Overflow When Converting Strings”.

When control branches to the .last3 address, there are fewer than 4 valid digits remaining. The accumulator holds the converted data from 0 or more characters, and .hiDword holds valid data if the main loop already completed 32 bytes (it is 0 otherwise). The next three bytes are inspected in sequence (the fourth need not be inspected, since if it and the prior three were all valid, control would not have branched to this code path). A separate accumulator is then used; if the next byte is invalid, there are no more bytes to extract. Otherwise, its low bit is captured in the accumulator and this process repeats for each of the next two bytes, stopping as soon as an invalid byte is identified. Then, those one to three bits are shifted from the separate accumulator to the main accumulator used in the main loop. If the value at .hiDword is 0, the high dword returned will be 0, otherwise it is valid and is combined with the bits just accumulated.

During the process, it is important to keep track of exactly how many valid data bytes have been converted during each loop iteration. The loop continues until 32 characters have been aggregated into the accumulator. If there are 32 or fewer, they all fit within the low dword of the value to return to the caller, in which case the high dword will have the value 0. If there are more, the upper dword and the lower dword are eventually combined (and a loop counter is reset); the valid bits from the most recent accumulator are properly combined with the bits from .hiDword. Alternatively, in some embodiments, the address of the halt character is not needed; in such case, any code used to track that position can be eliminated, resulting in a faster algorithm. The skilled implementer can make such a change, if desired.

In an initial embodiment, when .hiDword has valid data, its value is placed into the edx register. The eax register is the accumulator that obtained the most recent valid data bits from the last valid string characters; the number of valid data bits in eax is known (nBits, which is the cl register in the example below), and the register is shifted left such that the valid bits are shifted as far left as possible (equal to lenShift=32−nBits). Once this is done, the 64-bit value edx:eax is shifted right by that same value (lenShift); the result in edx:eax is the absolute value of the base-2 string, as follows:

| | | | | |
|---|---|---|---|---|
| | shl | eax, | cl | ; move bits into far left of eax |
| | shrd | eax, | edx, | cl ; shift eax right, fill with edx lo |
| bits | | | | |
| | shr | edx, | cl | ; shift edx, edx:eax is proper value |

Immediately before returning the converted value to the caller, two additional steps are taken. First, the ‘haltChar’ address is updated with the offset of the first invalid byte (also called the halt char; this could be a null termination character, or any other invalid character; it can also be an otherwise valid digit if there were too many); care is taken, however, in the event the address for ‘haltChar’ is null, in which case the address is not updated. Then, the .sign value is inspected to determine if the number is negative, and the number is handled as described in the “Detecting Overflow When Converting Strings” section.

As is known to the skilled implementer, coding in a 64-bit execution environment can eliminate some of the complexity of the code since all registers are 64 bits wide; only one accumulator is needed, and twice as many characters can be handled in each loop. In testing in 32-bit execution environments, this algorithm can run 9× to 11× faster than the Microsoft equivalent strtoint64 function. When running in 64-bit execution environments, or when using either the PEXT or (V)PMOVMSKB instruction, the execution speed can increase again.

Here is a complete section of code, Strtou64_b2, written in FASM assembly language:

;;;;;;;;;;;;;;;;;;;;;;;;;;;;;;;;;;;;;;;;;;;;;;;;;;;;;;;;;;;;
; Strtou64_b2
; Convert base-2 character string into _u64
alignf Strtou64_b2.loop
Strtou64_b2:
; _u64 _stdcall Strtou64_b2(char *str, char **haltChar);
; Inputs:
; str points to string to convert
; haltChar points to pointer that is updated w/ pos of
char that stopped conversion
; Returns:
; edx:eax will be result

Can be converted to a core function by removing code that updates haltChar, adjusting register usage at end so that ecx returns with .sign and esi

; if string is negative, ecx is ‘-’; otherwise, ecx is
not ‘-’
; if esi is NOT pushed at start and popped at end, it can
be returned
; with the address of the halt char
; Functions in 32-bit, collecting 8 nibbles at a time
; esi and edi used to inspect bytes...

The first character must be either a sign or a digit; otherwise, the process will immediately terminate.

| ; Then, all leading ‘0’ characters are skipped; when a non- | |
|---|---|
| zero digit is found, the process starts in 4-byte mode. | |
| .maxBytes = BaseTbl.b2.maxDigits | ; max number of valid |
| digits | |

| .nParms = 2 | | ; # parameters |
|---|---|---|
| ; Local vars... | | |
| .loopBytes | = 32 | ; This is the number of bytes |

| we handle for each loop | | |
|---|---|---|
| .loopBits | = 32 | |
| .nLocals | equ 4 | ; # local vars |
| .cumBytes | equ esp | ; Keeps track of how many bits |

| we've processed | | |
|---|---|---|
| .hiDword | equ esp+4 | ; stores first 32-bit value |

| | | |
|---|---|---|
| .sign | equ esp+8 | ; stores sign of the number |

| | | |
|---|---|---|
| .startPos | equ esp+12 | ; digits start counting from |

| here (for updating **haltChar) | |
|---|---|
| PAGE 68 | |
| .parmBase | equ esp+(.nRegs+.nLocals)*4+4 |
| .str | equ .parmBase |
| .haltChar | equ .parmBase+4 |

| | |
|---|---|
| .nRegs = 3 | ; # of pushed reqs |

| ; Very quickly, determine if there is anything to do! | | |
|---|---|---|
| mov | edx, [esp+4] | ; get ptr to string |

| | SkipWsAndZeroes edx, ecx | | |
|---|---|---|---|
| | ; ecx has sign | | |
| | ; Found either ‘1’ or halt char, assume valid string | | |
| | pushregs ebx, esi, edi | | |
| ; | sub | esp, .nLocals*4 | ; use for local storage! |

; instead of adjusting esp, just push values on

stack... saves one instruction!

| | | |
|---|---|---|
| push | edx | ; init .startPos |
| push | ecx | ; store .sign |

| ; | mov | byte [.sign], cl | ; store sign here - if bh is |
|---|---|---|---|
| neg, num is neg, else it's positive | | | |
| ; | mov | [.startPos], edx | ; remember where the digits |

start counting from...

| | | |
|---|---|---|
| xor | eax, eax | ; accumulator for new data bits |
| xor | edi, edi | ; used as .hiDword |
| push | eax | ; init .hiDword |
| push | eax | ; init .cumBytes |

| ; | mov | [.cumBytes], eax | ; # bits already |
|---|---|---|---|
| processed | | | |
| ; | mov | [.hiDword], eax | ; .hiDword starts out as |
| 0 | | | |
| | lea | esi, [edx+.loopBytes] | ; allows us to process 32 |

bytes

If we max out, we move eax into [.hiDword] and keep processing

| | |
|---|---|
| mov edx, −.loopBytes | ; edx is neg counter |
| .loop: | |
| if defined USE_BMI2 | |

; if BMI2 pext instruction available...

| | | |
|---|---|---|
| mov | ecx, [esi+edx] | ; get four bytes |

| | | |
|---|---|---|
| mov | ebx, ecx | ; ebx is temp copy |

; See if the lo bit of each byte is the only difference

| | | |
|---|---|---|
| and | ebx, 0xfefefefe | ; clear lo bit |
| cmp | ebx, 0x30303030 | ; are all bytes valid? |

| | | |
|---|---|---|
| jne | .last3 | ; no, so handle one byte at a time |

; Four valid bytes, so convert

| | | |
|---|---|---|
| bswap | ecx | ; change order of bytes so bits |
| arrive in order | | |

| | | |
|---|---|---|
| shl | eax, 4 | ; open up bit positions in eax |
| pext | ecx, ecx, | 01000000010000000100000001b |
| or | eax, ecx | |

else if defined USE_PMOVMSKB
; if using PMOVMSKB instruction...

| | | |
|---|---|---|
| mov | ecx, [esi+edx] | ; get four bytes |

| | | |
|---|---|---|
| mov | ebx, ecx | ; ebx is temp copy |

; See if the lo bit of each byte is the only difference

| | | |
|---|---|---|
| and | ebx, 0xfefefefe | ; clear lo bit |
| cmp | ebx, 0x30303030 | ; are all bytes valid? |

| | | |
|---|---|---|
| jne | .last3 | ; no, so handle one byte at a time |

; Four valid bytes, so convert

| | | |
|---|---|---|
| bswap | ecx | ; change order of bytes so bits |
| arrive in order | | |

| | | |
|---|---|---|
| shl | eax, 4 | ; open up bit positions in eax |

| | | |
|---|---|---|
| shl | ecx, 7 | ; move all data bits to sign bit |
| movd | xmm0, ecx | |

pmovmskb ecx, xmm0

| | |
|---|---|
| or | eax, ecx |

else ; do this if no USE_BMI2 and no USE_PMOVMSKB...

| | | |
|---|---|---|
| mov | ecx, [esi+edx] | ; get four bytes |

| | | |
|---|---|---|
| mov | ebx, ecx | ; ebx is temp copy |

; See if the lo bit of each byte is the only difference

| | | |
|---|---|---|
| and | ebx, 0xfefefefe | ; clear lo bit |
| cmp | ebx, 0x30303030 | ; are all bytes valid? |

| | | |
|---|---|---|
| jne | .last3 | ; no, so handle one byte at a time |

Four valid bytes, so convert; can select either of two methods, both work, second is a bit faster.

| | |
|---|---|
| .method = 1 | ; set to either 1 or 2 |

| | |
|---|---|
| if .method = 1 | ; this method works, tested Aug 19, |
| 2014 | |

; avg = 1.040 secs for 30 million tests

of .num
; need to test both methods!!!

| | | |
|---|---|---|
| and | ecx, 0x1010101 | ; isolate lo bit for all bytes |

| | | |
|---|---|---|
| shl | eax, 4 | ; open up bit positions in eax |
| mov | ebx, ecx | ; treat ecx as temp copy |
| shr | ebx, 16 | ; 9: cx has first 2 bytes, bx has next 2 |
| bytes | | |

| | | |
|---|---|---|
| shl | cl, 3 | ; move data from first byte to hi |
| position | | |
| shl | ch, 2 | ; move data from second byte to |
| next pos | | |
| shl | bl, 1 | ; move data from third byte to next |
| pos | | |

; bh (4th byte)already in proper pos

; Combine the data

| | |
|---|---|
| or | bl, bh |
| or | cl, ch |

; Move into accumulator eax

| | |
|---|---|
| or | al, bl |
| or | al, cl |

| | |
|---|---|
| ; end if | ; if method = 1 |

| | |
|---|---|
| else if .method = 2 | ; this works, tested Aug 19, |
| 2014 | |

; avg = 0.8733 secs for 30 million tests

```
of .num
      ; use LEA method to combine bits...
      ; ebx is available
```

| | |
|---|---|
| movzx | ebx, cl |

| | |
|---|---|
| lea | eax, [eax*2+ebx−‘0’] |

| | |
|---|---|
| movzx | ebx, ch |

| | |
|---|---|
| shr | ecx, 16 |
| lea | eax, [eax*2+ebx−‘0’] |

| | |
|---|---|
| movzx | ebx, cl |

| | |
|---|---|
| lea | eax, [eax*2+ebx−‘0’] |

| | |
|---|---|
| movzx | ebx, ch |

| | |
|---|---|
| lea | eax, [eax*2+ebx−‘0’] |

| | |
|---|---|
| end if | ; if method = 2 |

; Finished 4 bytes, so prepare for next 4

| add | edx, 4 | |
|---|---|---|
| js | .loop | ; 23 instructions to handle 4 |
| bytes! | | |
| end if | ; if defined BMI2 | |

At this point, we've filled up eax, need to shift into edi: .hiDword . . .

| | |
|---|---|
| mov edi, [.hiDword] | ; loDword just shifted 32 |
| bits to become .hiDword! | |
| mov [.hiDword], eax | ; and store eax... |
| edi:loDword is the current value! | |

| ; Assume no overflow, so adjust count, reset, and | |
|---|---|
| continue | |
| add dword [.cumBytes], .loopBits ; show we finished | |
| all these bytes | |
| ; And reset regs so we can keep going | |
| add esi, .loopBytes | |
| mov edx, −.loopBytes | |
| ; Now, see if we've overflowed... | |
| ; If .cumBytes is already equal to .loopBits*2, for | |
| signed strings, this means we have | |
| ; just converted 64 bytes, which is one too many... so | |
| if this is the second time, we | |
| ; have overflowed | |
| test edi, edi | ; is this still 0? |
| jz .loop | ; yes, so can still loop |
| around | |

Need to check overflow now . . . if one more valid byte, we've overflowed.

| ; edi:eax is current value... | | |
|---|---|---|
| mov | edx, edi | ; edx:eax is now 64-bit value |
| movzx | ecx, byte [esi−.loopBytes] ; get 65th byte... | |
| test | byte [BaseTbl.b2+ecx], BaseTbl.invalid | |
| jnz | .finish3 | ; next byte not valid, so normal |

| finish | | |
|---|---|---|
| ; Max overflow found, so process... | | |
| ; First, update haltChar... | | |
| mov | esi, [.startPos] | |
| add | esi, 64 | ; overflowed 64 bytes after |

| first valid sig digit | | |
|---|---|---|
| mov | ebx, [.haltChar] | |
| test | ebx, ebx | |
| jz | @f | ; can't update, haltChar is invalid |

| | | |
|---|---|---|
| mov | [ebx], esi | ; update |

| @@: | |
|---|---|
| ; now see if signed overflow | |
| mov | ecx, dword [.sign] |
| cmp | cl, ‘-’ |
| je | .signedMinOverflow |
| ; no, normal unsigned overflow | |
| or | eax, −1 |
| or | edx, −1 |
| add | esp, .nLocals*4 |
| popregs ebx, esi, edi | |
| ret | .nParms*4 |
| .signedMinOverflow: | |
| xor | eax, eax |
| mov | edx, 0x80000000 |
| add | esp, .nLocals*4 |
| popregs ebx, esi, edi | |
| ret | .nParms*4 |
| align 16 | |
| .last3: | |

Always come here to process the last few bytes. eax has the data in process, and there is room to add the extra bytes. data is in ecx, mask in ebx.

```
      ; edx is neg count... so adjust it and update .cumBytes
      ; it is possible to use LEA instruction to combine
valid values, rather
      ; than using SHIFT and OR below (similar to .method = 2
above), would be quicker
```

| | | | |
|---|---|---|---|
| and | ecx, | 0x1010101 | ; isolate lo bit for all bytes |
| add | edx, | .loopBits | ; add loop value |

| | | |
|---|---|---|
| add | [.cumBytes], edx | ; .cumBytes now has total |

```
processed, need to check next 3 bytes
      ; use edx to accumulate remaining valid bits
      ; there will be a max of 3 valid bytes when we get here
      ; dl will be used to collect the bits
      ; check first byte
```

| | | |
|---|---|---|
| cmp | bl, 0x30 | ; is mask correct? |

| | | |
|---|---|---|
| jne | .done0 | ; no, so exit |

| | | |
|---|---|---|
| movzx | edx, cl | ; yes, so put bits into |
| dl | | |

; check second byte

| | | |
|---|---|---|
| cmp | bh, 0x30 | ; is mask correct? |

| | | |
|---|---|---|
| mov | cl, 1 | ; proper value if second byte |
| not valid | | |
| jne | .finish | ; no, so finish |
| shl | dl, 1 | |
| or | dl, ch | ; grab value of second byte |

; finally, check third byte

| | | |
|---|---|---|
| shr | ebx, 16 | ; prepare for 3rd byte |
| cmp | bl, 0x30 | |
| mov | cl, 2 | ; proper value if third byte |
| invalid | | |
| jne | .finish | ; no, so exit |

; There were three valid bytes, converted into edx

| | | |
|---|---|---|
| shr | ecx, 16 | ; ” |
| shl | dl, 1 | |
| or | dl, cl | ; combine data from last byte |

; OK to combine edx into eax

| | | |
|---|---|---|
| mov | cl, 3 | ; proper value if three valid |

bytes
.finish:
; cl has # bytes just added, and they are the lo bits
of edx

| | |
|---|---|
| shl | eax, cl |

; next instruction may not be needed

| | | |
|---|---|---|
| ; movzx | ebx, cl | ; ebx is # new bits |

| | | |
|---|---|---|
| add | cl, byte [.cumBytes] | ; update to show total |

bits processed in cl

| mov | byte [.cumBytes], cl | |
|---|---|---|
| or | eax, edx | ; eax now has all bits this loop |

; Now, combine eax and .loDword

| | |
|---|---|
| mov | edx, [.hiDword] |

If edx is 0, there's nothing to combine.

| test | edx, edx | |
|---|---|---|
| jnz | .combineBig | |
| .finish3: | | |
| ; edx:eax has absolute value, so exit now... | | |
| ; time to update haltChar to show position of | | |
| terminating char | | |
| mov | esi, dword [.cumBytes] | |
| add | esi, [.startPos] | ; ecx is now position of char |

| that stopped conversion | | |
|---|---|---|
| mov | ebx, [.haltChar] | |
| test | ebx, ebx | ; is haltChar 0? |
| jz | @f | ; yes, so skip |

| ; Need to update, value is in esi | | |
|---|---|---|
| mov | [ebx], esi | |
| @@: | | |
| ; Now see if need to convert to neg | | |
| cmp | byte [.sign], ‘-’ | ; negative? |
| je | .returnNeg | |
| add | esp, .nLocals*4 | |

| | |
|---|---|
| popregs | ebx, esi, edi |

| ret | .nParms*4 | |
|---|---|---|
| align 16 | | |
| .returnNeg: | | |
| ; Need to return negative value... | | |
| ; But first, if sign is set, return signed min overflow | | |
| test | edx, edx | |
| js | .signedMinOverflow | ; it's set, so show overflow |

| Negate eax, edx | |
|---|---|
| add | esp, .nLocals*4 |

| | |
|---|---|
| popregs | ebx, esi, edi |

| | |
|---|---|
| ret | .nParms*4 |

Come here if first char is invalid; since there's no stack frame, this executes a bit faster.

```
.firstCharInvalid:
      ; edx is ptr to start of string
      ; ecx is undefined, could make it ‘-’ if this is a core
function, which
      ;  saves an instruction or two in the stub
```

| | | |
|---|---|---|
| mov | esi, edx | ; halt char is first char |

| mov | eax, [esp+8] | ; get haltChar, see if valid |
|---|---|---|
| test | eax, eax | |
| jz | .firstCharInvalid.skip | |
| mov | [eax], edx | ; update haltChar to char that |

stopped conversion
.firstCharInvalid.skip:

| | |
|---|---|
| xor | eax, eax |
| xor | edx, edx |
| ret | .nParms*4 |
| align 16 | |
| .done0: | |

; If we didn't process any additional bytes in the
loop, then edi has hiDword...

| | | |
|---|---|---|
| test | edx, edx | ; will be 0 if we didn't even |

finish first loop!

| | | |
|---|---|---|
| mov | edx, edi | ; pick it up tentatively to avoid |
| extra jmp | | |

| | |
|---|---|
| movzx | ecx, byte [.cumBytes] |

| | |
|---|---|
| jz | .finish3 |

; Need to put current .hiDword into edx...

| | | |
|---|---|---|
| mov | edx, [.hiDword] | ; grab the value |

```
      ; need to combine edx and eax, after shifting eax up...
      ; Fall thru, need to combine lo and hi dwords
.combineBig:
      ; eax is all bits in lo portion, edx is hiDword
      ; esi has current neg counter
      ; cl is .cumBytes
      ; Now combine with hiDword -- need to shift eax up to
match
```

Can be sped uP by using lookup table to get proper value for cl . . .

| | | |
|---|---|---|
| and | cl, .loopBits−1 | ; cl is now total bits in |
| eax | | |

| | | |
|---|---|---|
| sub | cl, .loopBits | |
| neg | cl | ; cl is now proper shift value! |

| | | |
|---|---|---|
| shl | eax, cl | ; move bits into far left of |

eax to prepare for edx:eax shift

| | | |
|---|---|---|
| shrd | eax, edx, cl | |
| shr | edx, cl | ; edx:eax is proper value |

; time to update haltChar to show position of
terminating char

| | | |
|---|---|---|
| mov | esi, [.cumBytes] | |
| add | esi, [.startPos] | ; esi now points to char that |

ended conversion process

| mov | ebx, [.haltChar] | |
|---|---|---|
| test | ebx, ebx | ; see if .haltChar is 0 |
| jz | @f | |
| mov | [ebx], esi | |
| @@: | | |

; Now see if need to convert to neg

| | | |
|---|---|---|
| mov | cl, byte [.sign] | |
| amp | cl, ‘-’ | ; negative? |
| je | .returnNeg | |
| add | esp, .nLocals*4 | |

| | |
|---|---|
| popregs | ebx, esi, edi |

| | |
|---|---|
| ret | .nParms*4 |

; Remove equ definitions...
restore .nLocals, .cumBytes, .hiDword, .sign, .startPos,
.parmBase, .str, .haltChar, .regs
;;;;;;;;;;;;;;;;;;;;;;;;;;;;;;;;;;;;;;;;;;;;;;;;;;;;;;;;;;;

If desired, xmm (or wider) registers can be used in 32-bit execution environments to provide a 64-bit (or larger) accumulator; in fact, one of skill can adapt this method to work with base-2, base-8, and base-16 numeric strings while still within the spirit of the invention. This can simplify the entire process by using just one accumulator in some cases, thereby obviating the need to stitch multiple accumulators together and saving time. The PSLLQ instruction (from the SSE2 instruction set) can be used to shift the accumulator to the left the number of desired bits. Then the value to be combined is placed into another xmm register, and then merged into the accumulator register with the PADDQ instruction (or the POR instruction; the skilled implementer can decide which to use).

The next example, Atou64_B2Xmm, shows how wider registers (such as xmm registers) can be used. This function uses a method similar to that described in “Finding End of Significant Digits” that use PCMPGTB and PSUBB instructions. This process also uses the PMOVMSKB instruction to aggregate the data bits, after first shifting them to the sign-bit position in each byte. It also shows how the source bytes are always accessed via aligned reads, with a header that handles the first unaligned bytes (if any), a middle function to handle the aligned sections, and a footer that handles the last bytes (if any) when the last portion is fewer than 16 bytes (or the size of the SIMD register being used, if other than xmm). This therefore avoids any penalties for accessing misaligned data; combined with the SIMD instructions that allow parallel processing of multiple bytes, faster execution can occur. These policies can be adapted, by the skilled implementer, to all the inventions described detailed in the present disclosure.

```
;<<<<<<<<<<<<<<<<<<<<<<<<<<<<<<<<<<<<<<<<<<<<<<<<<<<<
; _u64  Atou64_B2Xmm(char *str);
; Use XMM reqs to convert b2 string to _u64 in core function
func Atou64_B2Xmm
macro .ExitNow {
    pop ebx
    ret 4 }
.b2Xmm:
    push ebx
    ; ebx will be ptr, ecx counter
    ; edx and eax available
```

| | |
|---|---|
| mov ebx, [esp+8] | ; grab str ptr |
| mov eax, ebx | |
| and eax, 0x0f | ; eax is # bytes misaligned (i.e., |

# invalid bytes before first valid byte)

| | |
|---|---|
| pxor xmm2, xmm2 | ; accumulator |
| jmp [.JmpTbl+eax*4] | ; handle initial bytes |
| rept 16 n:0 { | |
| .#n: | |

Special handling depending on alignment; try to avoid shifting when possible.

```
  if n = 0
    movdqa  xmm0, dqword [ebx]
  else if n = 8
    movq xmm0, qword [ebx]
  else if n = 12
    movd xmm0, dword [ebx]
  else if n = 14
    movzx eax, word [ebx]
    movd xmm0, eax
  else if n = 15
    movzx eax, byte [ebx]
    movd xmm0, eax
  else
    movdqa xmm0, dqword [ebx-n]
    psrldq xmm0, n
  end if
    mov ecx, 16-n ; max # valid bytes from this alignment
  if n<15
    jmp .FirstBatch
  end if
  }
.FirstBatch:
```

Come here for each first access, will be faster if <16 bytes.

```
  movdqa xmm1, xmm0  ; make copy
  ; Push to floor, any bytes greater than 1 are invalid
  psubb xmm0, dqword [.Floor]  ; adjust
  pcmpgtb xmm0, dqword [.MaxVal]
  ; Instead of above, could PAND each byte with 0xfe to
zap lo bit, then compare with 0x30. BUT . . . the way it's done
here makes all valid bytes mask as 0, and invalid as 1,
simplifying the counting of valid bytes
  pmovmskb eax, xmm0  ; get count
  bsf eax, eax  ; eax is count
  jz .AlignedEnter  ; enter .AlignedLoop process,
we have 16 valid digits to process
  ; eax is # valid digits
  mov edx, [.ptrShufb+eax*4] ; get ptr to proper shufb
pattern
  pshufb xmm1, dqword [.Shufb+edx]
    ; adjust bytes in order to collect bits
  psllq xmml, 7
    ; shift left 7 bits, data is in sign bit of
each byte
  cmp eax, ecx
    ; Before zapping eax, compare with max we
could get
  pmovmskb eax, xmm1 ; collect data bits
  ; Did we get all the bytes we could?
  je .AlignedLoopInit ; yes, so keep getting bytes
  ; No more valid digits, so exit now
  xor edx, edx
  .ExitNow
.AlignedLoopInit:
  movd xmm2, eax  ; capture bits from first batch
.AlignedLoop:
  movdqa xmm0, dqword [ebx+ecx]  ; grab bytes from
memory
```

Deal with aligned loop until finished; could loop four times.

```
  movdqa xmm1, xmm0  ; make copy
  psubb xmm0, dqword [.Floor]  ; adjust
  pcmpgtb xmm0, dqword [.MaxVal]
  pmovmskb eax, xmm0  ; get count
  bsf eax, eax  ; eax is count
  jnz .Finish  ; less than 16, so finish up
  add ecx, 16  ; point to next dqword, show
we found 16 more bytes
.AlignedEnter:
  ; eax is # valid digits
  pshufb xmm1, dqword [.Shufb]  ; switch order of
bytes
  psllq xmml, 7  ; shift left 7 bits, data
is in sign bit of each byte
  pmovmskb edx, xmm1  ; collect data bits
  ; edx has 16 new data bits, so shift accumulator and
insert into position . . .
  pslldq xmm2, 2  ; shift 2 bytes
  pinsrw xmm2, edx, 0  ; insert into low dword
position
  jmp .AlignedLoop
.Finish:
```

Not a full 16 bytes, so adjust and prepare to exit!

| ; But if eax is 0, there are no additional bytes -- | |
|---|---|
| test it | |
| test eax, eax | |
| jz .NoMore ; skip all further processing | |
| ; eax is # valid digits, so use to shift xmm2 after | |
| preparing bits for POR into xmm2 | |
| movedx, [.ptrShufb+eax*4] ; get ptr to proper shufb | |
| pattern | |
| pshufb xmm1, dqword [.Shufb+edx] ; adjust bytes in | |
| order to collect bits | |
| psllq xmm1, 7 ; shift left 7 bits, data | |
| is in sign bit of each byte | |
| pmovmskb edx, xmm1 ; collect data bits | |
| ; eax is count, so shift accumulator and OR in bits | |
| movd xmm0, eax ; shift counter | |
| movd xmm1, edx ; bits to OR | |
| psllq xmm2, xmm0 | |
| por xmm2, xmm1 | |
| add ecx, eax | |
| ; see if overflow | |
| .NoMore: | |
| cmp ecx, 64 | |
| ja .overflow | |
| pextrd edx, xmm2, 1 | |
| movd eax, xmm2 | |
| .ExitNow | |
| .overflow: | |
| or eax, −1 | |
| or edx, −1 | |
| .ExitNow | |
| .isZero: | |
| xor eax, eax | |
| xor edx, edx | |
| .ExitNow | |
| label .JmpTbl dword | |
| rept 16 n:0 { dd .#n } | |
| align 16 | |
| .Floor: times 16 db ‘0’ − 128 | ; value to subtract |
| .MaxVal: times 16 db −128+1 | ; compare each byte to |
| see if > this value | |
| ; Values used to shift | |
| .ptrShufb: times 16 dd (16*(16-%+1)) and 0xff | |
| .Shufb: | ; PSHUFB entries |

```
  ; 16 entries here
  ; - First entry at offset 0 has 16 valid digits
  ; - Second entry at offset 16 has 15 valid digits
  ; - etc.
```

The PSHUFB entry reverses all valid digits, moves them to lo offset of xmm reg.

```
  rept 16 n {
      reverse
    ; create PSHUFB mask . . .
    repeat n
        db n-%
    end repeat
    repeat 16 - n
        db 0x80 ; make all invalid bytes convert to
null
    end repeat
  }
purge .ExitNow
endf ; Atou64_B2Xmm
;>>>>>>>>>>>>>>>>>>>>>>>>>>>>>>>>>>>>>>>>>>
```

Converting Base-8 Character Strings

When converting base-8 strings, a separate table BaseTbl.b8 is created to handle base-8 (octal) character strings. It contains the same data as BaseTbl.b2 described above, with the addition of valid entries representing digits ‘2’ through ‘7’ (with values 2 through 7) added to the ‘0’ and ‘1’. Here are the valid base-8 digits:

| ‘0’ hex: 0x30 binary: 00110000b | |
|---|---|
| ‘1’ hex: 0x31 binary: 00110001b | |
| ‘2’ hex: 0x32 binary: 00110010b | |
| ‘3’ hex: 0x33 binary: 00110011b | |
| ‘4’ hex: 0x34 binary: 00110100b | |
| ‘5’ hex: 0x35 binary: 00110101b | |
| ‘6’ hex: 0x36 binary: 00110110b | |
| ‘7’ hex: 0x37 binary: 00110111b | |
| ----- | <-- upper 5 bits |
| underlined | |

Base-8 strings can be converted to integer very quickly using one of two frameworks. One method is to use the same framework, or skeleton for the function, as was used for the Strtou64_b2 function. In this method, four bytes can be processed at a time, isolating the bits as needed. Key adjustments are made to accommodate the fact that each data character has 3 bits of data, found at offsets 0 through 2, rather than just one; such a base-8 algorithm can be referred to as Strtou64_b8.

The upper 5 bits are the same in each valid base-8 character; when the lower 3 bits are cleared, each valid byte will have the value 00110000b. In the main loop, the mask value 0xf8f8f8f8 is used to isolate the upper 5 bits of each byte, and the mask value 0x7070707 is used to isolate the lower 3 bits of each byte. Four character bytes can be processed at each loop iteration, meaning up to 12 new data bits are aggregated each iteration. After two iterations, 24 bits will have been captured; but if a third iteration is performed, data would be lost when using a 32-bit accumulator (36 bits do not fit in a 32-bit register). Therefore, the accumulated data bits are captured and preserved in a new and separate accumulator each time 24 bits have been obtained; when finished, the accumulators would be properly stitched together using shift methods as shown in examples in the present disclosure, and as customized by the skilled implementer. Alternatively, in 64-bit execution environments, the rax register can be used as the main accumulator, and can capture the data from 63 characters; if there are more, the data from the 64th character can be processed manually and added to rax, with overflow indicated if there are more than 64 bits of data.

A different method can be used. In an initial embodiment, a skeleton similar to that used in the Atou64_Lea function, described in the “Atou64_Lea” section, is used. The number of valid bytes can be counted with an algorithm similar to that in the “Finding End of Significant Digits” section. During the conversion process, there are three sections. Both the lower- and middle-section portions handle 10 digits (this provides 30 bits in both accumulators), and the upper-section portion handles up to 2 bytes. Any base-8 numeric character string of 21 or fewer digits will not overflow. When the upper-section accumulator is merged with the others, overflow should be detected and handled.

The core LEA instruction needed to insert each valid digit's value into the accumulator is similar to this:

```
.Digit8: ; part of base-8 conversion for 8 lower bytes
  movzx edx, byte [esi+12] ; get byte
  ; multiply eax by 8 and add value
  lea eax, [eax*8+edx−‘0’]
```

If the upper-section portion contains two bytes, and the highest byte has a value greater than 1, the value will overflow and is handled as explained elsewhere. Signed octal strings have a maximum of 21 digit characters which will translate to, at most, 63 bits. Unsigned octal strings have up to 22 digit characters; overflow when combining the bits should be detected and properly handled (if the first digit's value is greater than 1 when there are 22 valid digits, the value will overflow).

Also, as explained above at the end of the previous section on converting base-2 strings, xmm registers can be used to provide a 64-bit accumulator even in 32-bit environments.

Converting Base-16 Character Strings

A separate table BaseTbl.b16 is used when converting base-16 (hexadecimal) character strings. It contains the same data as BaseTbl.b2 described above, with the addition of valid entries representing digits ‘2’ through ‘9’ (with values 2 through 9, respectively) and the additional digits ‘A’ through ‘F’ and ‘a’ through ‘f’ (with values 10 through 15, respectively, for each of the upper- and lower-case letter groups).

Since the base-16 alphabet has valid digits scattered amongst the 256-entry table, the value represented by each digit is obtained by accessing the table for each byte; that value can then be merged into the accumulator. A 32-bit accumulator is exactly filled with the data bits from 8 source digits, meaning 2 accumulators are used to accommodate up to 64-bits of data being captured. Or, a 64-bit accumulator can be used (edx:eax for 32-bit execution environments, or rax for 64-bit). If desired, the skilled implementer could also use xmm registers to provide a 64-bit accumulator in 32-bit environments, as explained at the end of the “Converting Base2 Character Strings” section, thereby simplifying the code by eliminating the need to use multiple accumulators that need to be stitched together before returning to the caller. To do this, the (V)PINSRW instruction can be used to insert each batch of gathered bits into the xmm (or ymm) register at the appropriate spot, and a combination of shift and shuffle instructions can be used to rearrange the bits and bytes as needed.

Three different methods are considered. The first (Strtou64_b16_A) and third (Strtou64_b16_C) use the above 8-bit .b16 table, while the second (Strtou64_b16_B) uses the 16-bit .b16_word table described below.

The Strtou64_b16_A method. This method processes the digit characters in a loop. The loop can be unrolled up to 8 times, if desired, when using a 32-bit accumulator (or more for larger accumulators). Each digit is loaded and then used as an index into the .b16 table to retrieve the value for the digit just loaded. If that value is less than 16, it is valid and is inserted into the accumulator; otherwise, the process exits appropriately (by updating haltChar, and adjusting the return value for possible overflow and negative string, as explained previously). The core part of processing each byte can be as follows:

| ; Assumes eax is the accumulator, | |
|---|---|
| ; esi is pointer, and ecx is counter | |
| movzx ebx, byte [esi+ecx] ; load a byte | |
| movzx ebx, byte [BaseTbl.b16+ebx] ; use as index | |
| into .b16 table | |
| cmp ebx, 16 | ; is it valid? |
| jae .d0 | ; if >= 16, done processing new |

```
digits
  ; multiply accumulator by 16, add digit's value
  lea eax, [eax*8] ; x 8
  lea eax, [eax*2+ebx] ; x 2, then add value
```

If the above is unrolled 8 times, then the code at target addresses .d0 through .d7 would add to the count the values 0 through 7, respectively, which can then be used to update the address of the halt char; control would then branch to a path where the end processes are completed and the proper value is returned to the caller. The method above can work when using two accumulators; just before exiting, the two accumulators are combined (using logic similar to that of the Strtou64_b2 algorithm detailed in the present disclosure) and edx:eax is adjusted to handle a negative string and/or overflow. Alternatively, one could use a 64-bit accumulator (for example, edx:eax; in a 64-bit execution environment, rax can be used, instead of eax, in the example immediately above); this eliminates the need to stitch accumulators together when an invalid character is found.

Here's an example of using edx:eax as a 64-bit accumulator:

```
; Assumes edx:eax is the accumulator,
; esi is pointer, and ecx is counter
    movzx  ebx, byte [esi+ecx] ; load a byte
    movzx  ebx, byte [BaseTbl.b16+ebx] ; use as index
into .b16 table
```

| | |
|---|---|
| cmp ebx, 16 | ; is it valid? |
| jae .d0 | ; if >16, done processing new |

```
digits
    ; multiply accumulator by 16, add digit's value
    shld edx, eax, 4  ; shift upper 32 bits
    ; Then use either of the next methods to adjust lower
32 bits;
.selectMethod:
```

| | |
|---|---|
| if 0 | ; “if 1” means the first method is used, or |
| | ; “if 0” means the second is used |

| | |
|---|---|
| shle ax, 4 | ; multiply by 16 |
| add eax, ebx | ; add digit's value |

else

| | |
|---|---|
| lea eax, [eax*8] | ; multiply by 8 |
| lea eax, [eax*2+ebx] | ; multiply by 2, add digit's |

value
end if

The above code first shifts edx to the left 4 bit positions, filling the vacated bits with the upper 4 bits from eax; this has the effect of multiplying edx by 16; when eax is shifted 4 bits, the entire value edx:eax will have been properly multiplied by 16. Above are shown two ways of adjusting eax, either can be used; to use the second method, use “if 0” in the line at .selectMethod, otherwise use “if 1” to use the first method. The skilled implementer ensures that the pointer to the halt char is updated, and that overflow and negative strings are handled properly as explained elsewhere in the present disclosure.

The Strtou64_b16_B method. This method requires a special 16-bit table, .b16_word, which is created as follows:

| label .b16_word word | ; start of base-16 word |
|---|---|
| table | |
| ; Base-16 conversion table - lo byte for lo value, hi byte | |
| for hi | |
| .b16.maxDigits = 16 | |
| .b16.invalid = (.invalid shl 1) + .invalid ; equal to 0x0180 | |
| macro Tb1SetHex digit, val { | |
| Tb1Set digit*2, val | ; store normal val in lo byte |
| Tb1Set digit*2+1, val shl 4 | ; shift left 4 for hi |
| byte | |
| } | |
| times 256 dw .b16.invalid | ; default is .b16.invalid |
| TblSetlnit .b16_word | ; table to work with |

```
; Identify valid digits
  Tb1SetHex ‘0’, 0
  Tb1SetHex ‘1’, 1
  Tb1SetHex ‘2’, 2
  Tb1SetHex ‘3’, 3
  Tb1SetHex ‘4’, 4
  Tb1SetHex ‘5’, 5
  Tb1SetHex ‘6’, 6
  Tb1SetHex ‘7’, 7
  Tb1SetHex ‘8’, 8
  Tb1SetHex ‘9’, 9
  Tb1SetHex ‘A’, 10
  Tb1SetHex ‘B’, 11
  Tb1SetHex ‘C’, 12
  Tb1SetHex ‘D’, 13
  Tb1SetHex ‘E’, 14
  Tb1SetHex ‘F’, 15
  Tb1SetHex ‘a’, 10
  Tb1SetHex ‘b’, 11
  Tb1SetHex ‘c’, 12
  Tb1SetHex ‘d’, 13
  Tb1SetHex ‘e’, 14
  Tb1SetHex ‘f’, 15
```

The TblSetHex macro above calls the TblSet macro twice for each entry (the TblSet macro is defined elsewhere in the present disclosure). The low byte of each entry has the same structure as entries in other tables, i.e., the value is 0x80 if invalid, otherwise the value is equal to that represented by the digit character; this allows quick transfer of a value to bits 0 through 3 of a register. The high byte is different; the value to signal invalid entries is 0x01, while the value for valid character digits is equal to the normal value represented by that digit, but shifted left 4 bits, allowing quick transfer of a value to bits 4 to 7 of a register. This enables values to be ORed into an accumulator with fewer instructions, as further shown below.

Each entry in the table is comprised of a low-byte and a high-byte entry: the low byte is used to test validity of any character, and also when the value is to be inserted into the low portion of a register, while the high byte is used when the value is to be inserted into a higher position of a register. The way this table is designed restricts the target registers to being byte-sized registers when the value is ORed into a register (they can be accessed via the MOVZX instruction to move the byte into a larger register, which also clears the upper bits). If desired, one of skill could make each entry of this table 8 bytes wide, for example, which allows the low and the high portions of each entry to be 32-bits-wide entries whose values can be directly ORed with 32-bit registers; also, if desired, the table could be restructured, or utilized in combination with another companion table, to allow for more bit positions than provided by the .b16 table described above.

Some hexadecimal strings start with the characters “0x” or “0X” as a signature that indicates “hexadecimal”; these characters are identified and skipped (or if desired, a skilled implementer may decide that these characters should exist; in such case, an error would be returned if this signature is not present, or vice versa—if the signature exists, the ‘X’ is a halt char and the returned value is 0). If a process similar to that described in the section “Filtering Whitespace and Leading Zeroes” is used, and if the signature exists, the leading ‘0’ character will be skipped and the ‘X’ will be pointed to; but if there is no such signature, the first significant digit (or the halt char) will be pointed to . If desired, that filtering process can be customized, using techniques known to those of skill in the art, to account for this. In an initial embodiment, it is determined that if ptrReg still points to the start of the string after the SkipWsAndZeroes process, there can be no hex signature; otherwise, a word is loaded starting one byte prior to the position pointed to by ptrReg, and then tested. This can be done as follows (assuming all leading whitespace, any sign, and the ‘0’ prior to the ‘X’ have been skipped over; assume edx was used as ptrReg):

| movzx eax, word [edx-1] | |
|---|---|
| ; Code to isolate “0x” or “0X”. . . | |
| and eax, 0xdfff | ; clear lower-case bit |
| cmp eax, 0x5830 | ; compare to “0X” |
| jne .noHexSig | ; not found |

```
  ; found, so skip over the ‘X’. . .
  add edx, 1
.noHexSig:
```

In some embodiments, the hex signature will be checked via byte-oriented reads to eliminate the possibility of a stall due to the two bytes straddling a cache-line boundary. In such case, the following code could be used:

| mov al, [edx-1] | |
|---|---|
| mov ah, [edx] | |
| ; Code to isolate “0x” or “0X”. . . | |
| and ax, 0xdfff | ; clear lower-case bit |
| amp ax, 0x5830 | ; compare to “0X” |
| jne .noHexSig | ; not found |

```
  ; found, so skip over the ‘X’. . .
  add edx, 1
.noHexSig:
```

Each valid base-16, or hexadecimal, digit has 4 bits of data. However, note that valid digits include not just the digits ‘0’ through ‘9’, but also the alphabetic characters ‘A’ through ‘F’ (and/or ‘a’ through ‘f’). Since the values do not exist contiguously in the table, the BaseTbl.b16_word table is used to provide the proper values to move into an accumulator. Once the initial process is completed (skipping over whitespace, obtaining the sign, skipping over hex signature and leading zeroes), the main loop is entered, where each character is analyzed separately. The possible valid values from the three ranges are not contiguous; therefore, the BaseTbl.b16_word table is accessed by using each valid character digit, in turn, as an index into this .b16_word table. And when a valid digit is identified, the indexed value from the .b16_word table can be ORed into the accumulator.

Here is a listing, using FASM assembly-language instructions, for an initial implementation of the Strtou64_b16_B algorithm:

;<<<<<<<<<<<<<<<<<<<<<<<<<<<<<<<<<<<<<<<<<<<<
; Strtou64_b16_B
; Convert base-16 (hexadecimal) character string into _u64
; _u64 _stdcall Strtou64_b16_B (char *str, char **haltChar);
; Inputs:
; str points to hex string to convert (hex strings are,
by definition, unsigned)
; . . .but. . . will accept and apply negative if minus
is found!
; haltChar points to pointer that is updated w/ pos of
char that stopped conversion
; edx:eax will be result

The string could start with “0x” or “0X”—that is checked and skipped if necessary (after first checking for a sign).

| ; Whitespace will first be skipped, then any “0x” header, | |
|---|---|
| then any leading | |
| ; zeros, THEN the conversion will start! | |
| alignf Strtou64_b16_B.loop | |
| Strtou64_b16_B: | |
| .base = 16 | |
| .maxBytes = BaseTbl.b16.maxDigits | ; max number of valid |
| digits | |
| .nParms = 2 | ; # parameters |
| .tbl equ BaseTbl.b16_word | |
| ; Local vars . . . | |
| .accumBytes = 8 | ; # bytes to fill accumulator |
| .loopBytes = 4 | ; # bytes handled per loop |
| .nLocals equ 2 | ; # local vars |
| .hiDword equ esp+4 ; stores first 32-bit value | |
| .sign equ esp+8 | ; stores sign of the number |
| .parmBase equ esp+ (.nRegs+.nLocals)*4+4 | |
| .str equ .parmBase | |
| .haltChar equ .parmBase+4 | |
| .nRegs = 3 | ; # of pushed reqs |
| ; Very quickly, skip over any whitespace | |
| mov edx, [esp+4] | ; get ptr to string |
| SkipWsAndZeroes edx, ecx | |
| movd xmm0, ecx ; store sign here | |
| ; Could have stopped at ‘x’ or ‘X’, need to test | |
| ; but first, have we skipped any bytes? | |
| cmp edx, [esp+4] | |
| je .prepLoop ; no, so don't test for ‘0x’ | |
| ; Yes, skipped over at least one, so now see if this is | |
| 0x or 0X | |
| movzx eax, word [edx-1] ; grab word starting 1 | |
| byte just before, test both together | |
| ; Code to isolate “0x” or “0X”. . . | |
| and eax, 0xdfff | ; clear lower-case bit |
| cmp eax, 0x5830 | ; compare to “0X” |
| jne .noSig | ; no hex signature found |

; we found it! (so skip over it)
inc edx ; skip over x or X
.noSig:

There could be additional leading zeroes, skip over them.

cmp byte [edx], ‘0’
jne .prepLoop

@@:

; keep looking for leading ‘0’ chars...
inc edx
cmp byte [edx], ‘0’
je @b

.prepLoop:

| ; Skipped over everything, now time to convert! | |
|---|---|
| ; Found first non-zero char, so setup stackframe... | |
| pushregs ebx, esi, edi | |
| sub esp, .nLocals*4 | ; use for local storage! |

| mov esi, edx | |
|---|---|
| mov dword [.hiDword], 0 | ; .hiDword starts out as 0 |
| mov edi, −.accumBytes | ; use as neg counter |
| add esi, .accumBytes | ; position to the end |

.loop:

| ; Make room in eax for the data | |
|---|---|
| shl eax, 16 | ; assume all bits from 4 bytes will fit |

; upper bits are garbage first time in

loop

| ; Inspect first 2 bytes | |
|---|---|
| movzx ebx, byte [esi+edi] | ; use non-ecx reg for |

first

; use ebx, edx is needed soon

| movzx ecx, byte [esi+edi+1] | |
|---|---|
| ; Test them | |
| mov dl, byte [.tbl+ebx*2] | |
| or dl, byte [.tbl+ecx*2] | |
| js .invalid1 | ; exit if either was invalid |
| ; Valid, so combine into ah | |
| mov ah, byte [.tbl+ebx*2+1] | |
| or ah, byte [.tbl+ecx*2] | |
| ; Inspect next 2 bytes | |
| movzx ebx, byte [esi+edi+2] | |
| movzx ecx, byte [esi+edi+3] | |
| ; Test them | |
| mov dl, byte [.tbl+ebx*2] | |
| or dl, byte [.tbl+ecx*2] | |
| js .invalid2 | ; exit if either was invalid |

; Valid, so combine into al
mov al, byte [.tbl+ebx*2+1]
or al, byte [.tbl+ecx*2]

Finished with 4 source bytes, see if more to do this loop.

| add edi, .loopBytes | |
|---|---|
| js .loop | ; repeat |
| ; Finished filling accumulator, see if more to do | |
| cmp dword [.hiDword], 0 | ; if second time, all is full |

jne .filled
; First time, so adjust and loop around
add esi, .accumBytes
mov edi, −.accumBytes
mov [.hiDword], eax
jmp .loop

align 16
.filled:

; If any more valid digits, signal overflow
movzx ecx, byte [esi]
cmp byte [.tbl+ecx*2], .base
jb .overflow
; Load edx, adjust for sign, update haltChar, then exit
mov edx, [.hiDword]

.finish:

; ready to exit: test sign and haltChar, update as

needed

| ; esi has proper value for updating haltChar... | |
|---|---|
| movd ecx, xmm0 | ; get sign |

cmp cl, ‘−’
je .finishNeg
; update haltChar

.finishPtr:

| cmp dword [.haltChar], 0 | |
|---|---|
| jz @f | ; skip if 0 |

; Update haltChar
mov ebx, [.haltChar]
mov dword [ebx], esi
; time to exit!

@@:

add esp, .nLocals*4
popregs ebx, esi, edi
ret .nParms*4

align 16
.finishNeg:

Negate eax, edx
jmp .finishPtr

.overflow:

or edx, −1
or eax, −1
jmp .finishPtr

.invalid1:

At this point, eax has been shifted left 16 bits, lower 16 bits=0; if edi is −8, eax upper bits are unknown, else must be preserved (and edi=−4)

| ; byte in ebx needs to be added if valid | |
|---|---|
| ; But first, branch if upper dword is valid | |
| mov edx, [.hiDword] | ; load w/proper value |

| | |
|---|---|
| test edx, edx | ; are already 32 bits? |

| jnz .invalid1.got32 | ; upper 32 bits valid |
|---|---|
| ; here, edx is 0, so eax needs to be manipulated | |
| ; now determine if upper bits of eax are valid | |
| cmp edi, −8 | |
| jne .invalid1.got16 | ; upper 16 bits valid |

| ; edi = −8 so there are no valid bits in eax | |
|---|---|
| ; clear eax, adjust if ebx is valid | |
| cmp byte [.tbl+ebx*2], .base | |
| ja .invalid1.zero | ; no valid bytes, return 0 |

; use lo value for digit
movzx eax, byte [.tbl+ebx*2]
sub esi, 7
jmp .finish

.invalid1.zero:

xor eax, eax
sub esi, 8
jmp .finishPtr

.invalid1.got16:

| ; edx is 0, upper 16 bits of eax are valid, | |
|---|---|
| ; eax is shifted left 16 bits | |
| ; edi = −4 | |
| cmp byte [.tbl+ebx*2], .base | |
| ja .invalid1.got16.nomore | |
| ; got a value, so first shift eax down and | |
| ; then OR in value into al | |
| shr eax, 12 | ; leave room for 4 bits! |

or al, byte [.tbl+ebx*2]
sub esi, 3
jmp .finish

.invalid1.got16.nomore:

; shift eax back, adjust esi, then finish
shr eax, 16
sub esi, 4
jmp .finish

.invalid1.got32:

| ; edx has hi dword, must be combined with eax | |
|---|---|
| ; after eax is finalized | |
| cmp edi, −8 | |
| jne .invalid1.got48 | ; upper 48 bits valid |
| ; edi = −8, so no valid eax bits | |
| ; adjust if ebx is valid, remember edx is valid! | |
| cmp byte [.tbl+ebx*2], .base | |
| ja .invalid1.got32.nomore | ; no more valid bytes |

; one more valid byte, adjust edx:eax
xor eax, eax
shrd eax, edx, 28
shr edx, 28
or al, byte [.tbl+ebx*2]
sub esi, 7
jmp .finish

.invalid1.got32.nomore:

; only upper 32 bits valid, move into eax
mov eax, edx
xor edx, edx
sub esi, 8
jmp .finish

.invalid1.got48:

; edx is good, upper 16 bits of eax are valid,
; eax already shifted left 16 bits
; edi = −4
cmp byte [.tbl+ebx*2], .base
ja .invalid1.got48.nomore
; one more valid byte, adjust edx:eax
shrd eax, edx, 12
shr edx, 12
or al, byte [.tbl+ebx*2]
sub esi, 3
jmp .finish

.invalid1.got48.nomore:

; only upper 48 bits valid, adjust and exit
shrd eax, edx, 16
shr edx, 16
sub esi, 4
jmp .finish

.invalid2:

At this point, eax has been shifted left 16 bits, 8 bits in ah are valid; if edi is −8, eax upper bits are unknown, else must be preserved (and edi=−4).

| ; byte in ebx needs to be added if valid | |
|---|---|
| ; But first, branch if upper dword is valid | |
| mov edx, [.hiDword] | ; load w/proper value |

| | |
|---|---|
| test edx, edx | ; are already 32 bits? |

| jnz .invalid2.got40 | ; upper 48 bits valid |
|---|---|
| ; here, edx is 0, so eax needs to be manipulated | |
| ; now determine if upper 16 bits of eax are valid | |
| cmp edi, −8 | |
| jne .invalid2.got16 | ; upper 16 bits valid |

| ; edi = −8 | |
|---|---|
| ; upper 16 bits of eax are invalid, need to zap | |
| ; clear eax, adjust if ebx is valid | |
| and eax, 0xffff | ; clear upper bits |
| cmp byte [.tbl+ebx*2], .base | |
| ja .invalid2.nomore | ; no valid bytes, return 0 |
| ; use lo value for digit | |
| shr eax, 4 | ; leave room for valid bits |

or al, byte [.tbl+ebx*2]
sub esi, 5
jmp .finish

.invalid2.nomore:

| | |
|---|---|
| shr eax, 8 | ; preserve only 8 bits |

sub esi, 6
jmp .finish

.invalid2.got16:

| ; edx is 0, upper 24 bits of eax are valid, | |
|---|---|
| ; eax is shifted left 16 bits | |
| ; edi = −4 | |
| cmp byte [.tbl+ebx*2], .base | |
| ja .invalid2.got16.nomore | |
| ; got a value, so first shift eax down and | |
| ; then OR in value into al | |
| shr eax, 4 | ; leave room for 4 bits! |

or al, byte [.tbl+ebx*2]
sub esi, 1
jmp .finish

.invalid2.got16.nomore:

; shift eax back, adjust esi, then finish
shr eax, 8
sub esi, 2
jmp .finish

.invalid2.got40:

edx has hi dword, must be combined with eax; upper 24 bits of eax are valid.

| cmp edi, −8 | |
|---|---|
| jne .invalid2.got56 | ; upper 56 bits valid |
| ; edi = −8, so no valid eax bits | |
| ; adjust if ebx is valid, remember edx is valid! | |
| cmp byte [.tbl+ebx*2], .base | |
| ja .invalid2.got40.nomore | ; no more valid bytes |

| ; one more valid byte, adjust edx:eax | |
|---|---|
| shl eax, 16 | ; move all bits hi |

shrd eax, edx, 20
shr edx, 20
or al, byte [.tbl+ebx*2]
sub esi, 5
jmp .finish

.invalid2.got40.nomore:

upper 32 bits valid, and ah only valid bits in eax

| | |
|---|---|
| shl eax, 16 | ; shift valid bytes up |

shrd eax, edx, 24
shr edx, 24
sub esi, 6
jmp .finish

.invalid2.got56:

; edx is good, upper 16 bits of eax are valid,
; eax is shifted left 16 bits
; edi = −4
cmp byte [.tbl+ebx*2], .base
ja .invalid2.got56.nomore
; one more valid byte, adjust edx:eax
shrd eax, edx, 4
shr edx, 4
or al, byte [.tbl+ebx*2]
sub esi, 1
jmp .finish

.invalid2.got56.nomore:

; only upper 56 bits valid, adjust and exit
shrd eax, edx, 8
shr edx, 8
sub esi, 2
jmp .finish

restore .tbl, .nLocals, .hiDword, .sign, .parmBase, .str,
.haltChar
;>>>>>>>>>>>>>>>>>>>>>>>>>>>>>>>>>>>>>>>>>>>>>>>>>>>>>>>>>>>

In the above algorithm, after handling whitespace, sign, leading zeroes, and a possible hex signature, a loop is entered into (at .loop) after needed registers and variables are initialized; in an initial embodiment, a negative counter and a loop that processes four character digits at a time are used. The core part of the loop, using two 32-bit registers, continues until the maximum number of valid digits has been found (16 digits) or, if sooner, a halt char is encountered.

The eax register is used as the accumulator, and edx is used for a temporary value; used in this way, eax and edx variables are immediately available as soon as the first invalid character is available (since the result will be returned in the edx:eax pair). In 64-bit mode, additional registers are available, and the accumulator can handle 64 bits (but a similar process would occur when processing 128-bit values which could be returned in rdx:rax).

At the top of the loop, eax is shifted left 16 bits in anticipation of the 16 data bits coming from the next 4 valid digital characters; the low 16 bits are zeroed as a result of the shift. Two bytes are inspected together. Instead of testing each one separately, their validity status is ORed into the dl register and then tested once; this saves two jump instructions per loop, and allows smaller strings to be processed more quickly. When both values are determined to be valid, the proper values are ORed into the appropriate position in the eax register. The first byte (in ebx) will have its converted value moved into the upper half of ah (the value will be in the upper 4 bits and the lower 4 will be clear, ready to receive the value from the next digit character). The next byte (in ecx) will have its converted value moved into ah via an OR operation, thereby inserting its value into the low 4 bits of ah. The next two bytes are handled similarly, but their values are moved into the al register. That completes the insertion of the data bits from those four digits into the eax accumulator during an iteration of the loop.

If no invalid characters are found after filling the accumulator (in 4 iterations through the loop), then if this is the first time the loop was exited at the bottom, the accumulator is preserved and the process is repeated with control branching to .loop after resetting esi and edi. If the accumulator fills up a second time, no additional bits can accumulate. If the next char is valid, that signals an overflow condition which is handled as explained elsewhere in the present disclosure; otherwise, if the char is invalid, the value edx:eax will not overflow and is valid. The halt-char address and the negative sign, if any, are handled as explained previously.

When an invalid character is encountered inside the loop, control branches to the appropriate code path. At each branch, only the first of the two characters needs to be tested (if both are valid, control would not have branched; but once branched, only the first could possibly be valid). Proper values are moved into the accumulator; if more than one accumulator was filled (i.e., the second 32-bit batch of bits are being collected), then the two are stitched together as shown in the above code, for example, at .invalid1.got32, and also at each other portion of the code where more than 32 bits were obtained. Labels include “got32”, “got40”, “got48”, and “got56”—the SHRD instruction, used differently in each case, is part of the stitching; those skilled in the art will understand the examples. Any minus sign and halt-char-position issues are handled and the proper result in edx:eax is returned to the caller.

The code above, including initialization and end-of-process overhead, is able to convert the hexadecimal string “12345678abcdef12” to integer about 37 million times per second on a 2.66 GHz Intel Core2 Duo (versus MSVS Pro 2013 throughput of under 5 million times per second on the same laptop).

The Strtou64_b16_C method. This method processes the digit characters in a loop and is faster than the other methods, provided SSE2, SSSE3, and SSE4.1 instructions are available to the CPU. It can work in both 32-bit and 64-bit execution environments (with minor adjustments that the skilled implementer is able to make), and processes 16 source bytes inline with no loop, using a 128-bit xmm register as the accumulator. If desired, however, a skilled implementer could put this into a loop that would process 1, 2, 4, or 8 digits per iteration; if this is done, other changes to the code would need to be made (such as at the “.d#” branches), such changes being straight-forward to one skilled in the art.

In this algorithm, whitespace and leading zeroes are skipped over and the sign is obtained, as mentioned above (it is in the ecx register). At the end, the halt-char address is updated and overflow is indicated, again as explained above. No stack frame is created and no other registers need be preserved and restored at the end of the function. The core, in between, is quite different from any of the other algorithms.

When converting hexadecimal characters, each valid digit has four data bits, also known as a nibble (there are two 4-bit nibbles per byte); each pair of valid digits can combine to fit one byte exactly. If there is an odd number of valid digits, the most-significant digit will be a lone nibble unpaired with any other, and occupying the low 4 bits of its byte position in the final result. For example, when processing the numeric string “0x123”, the end result in edx:eax will be 0x0000000000000123. The ‘2’ and ‘3’ digits are paired up and occupy the lowest byte of eax (at bit positions 0-7), while the ‘1’ digit is in the low position of the next-higher byte (at bit positions 8-15).

At the start of the core is code that processes each of up to 16 valid digits; there can be a maximum of 16 valid significant digits in a plain base-16 string. Each digit is validated, one at a time. If not valid, control branches to a “.d#” branch to continue processing; if valid, the value for the digit, as obtained from the .b16 table when indexed by the digit, is inserted into the highest available byte offset of the xmm0 register. The next digit is then accessed (one byte past edx, the string pointer) and validated; if valid, it is inserted at the next-lower byte position in xmm0. The process continues with the other valid digits. If all 16 digits are valid, one more is tested; if it is valid, that means overflow has occurred. If not, there is no overflow, and the final .finish process takes place after adding 16 to edx (to make edx point to the halt char). Overflow, negative, and haltChar processing occur the same as explained above for the other .b16 methods.

The following code shows how the first two bytes are validated (edx is the pointer index, pointing to the most significant digit, and xmm0 is the accumulator; in this implementation, xmm0 need not be initialized). The process is duplicated, for each digit to be tested, with adjustments to the offset added to edx when fetching each byte; the branch destination is different for each case; and the insertion point at each byte is reduced by one byte position:

; First digit...
movzx eax, byte [edx+0]
cmp [BaseTbl.b16+eax], 16
jae .d0
pinsrb xmm0, byte [BaseTbl.b16+eax], 15
; Second digit...
movzx eax, byte [edx+1]
cmp [BaseTbl.b16+eax], 16
jae .d1
pinsrb xmm0, byte [BaseTbl.b16+eax], 14

The (V)PINSRB instruction comes from the SSSE4.1 instruction set; it moves a byte into the byte position indicated with the immediate constant at the end of the instruction. This (V)PINSRB line moves the value represented by the digit from BaseTbl.b16 and into xmm0.

If the first byte is invalid, the result to return is equal to 0. Otherwise, when an invalid digit is encountered, the branch location adjusts xmm0 so it will be processed properly. For example, if the second byte tested by the above code is invalid, control would jump to the .d1 branch. At this point, only one byte is valid; therefore, this valid byte is shifted into the low position of xmm0 by shifting it 15 bytes to the right with the PSRLDQ instruction from the SSE2 instruction set. Bytes of zero are shifted in from the left to fill the bytes shifted over. Since edx is used as the pointer, it can be made to point to the halt char by adding the number of valid bytes found; at this code offset, it is known that only one byte was valid, so the code looks like this:

| | |
|---|---|
| .dl: psrldq xmm0, 15 | ; shift by (16-# bytes valid) |

| | |
|---|---|
| add edx, 1 | ; point to halt char |

jmp .finish

| | |
|---|---|
| .d2: psrldq xmm0, 14 | ; shift by (16-# bytes valid) |

| | |
|---|---|
| add edx, 2 | ; point to halt char |

jmp .finish

Note that when the code branches to .d2, there are exactly two valid bytes. Therefore, xmm0 is shifted to the right 14 bytes in order to move those to the low position, and the value 2 is added to edx to make it point to the halt char. Control then jumps to .finish, which is the same point at which the code flows if all 16 bytes were valid; so at .finish, xmm0 will contain all valid digits converted into nibbles, with the lowest-order nibble at offset 0 of xmm0. This pattern is followed to create code for the remaining .d3 to .d15 branches. (Note that each 4-bit nibble occupies its own 8-bit byte.)

If desired, the (V)PSHUFB instruction can be used to shift the bytes into the proper position, instead of using the (V)PSRLDQ instruction; at each of the .d# branches, the proper shift bytes (prepared by the skilled implementer) would be used to ensure that the bytes of xmm0 are moved to proper position, and there would be one 16-byte pattern for each of the .d# branches. This would also permit loading the xmm0 register in either left-to-right or right-to-left order (the (V)PSHUFB instruction would take that into account and rearrange the bytes in the proper order, while simultaneously zeroing out unused bytes).

.finish:

| ; No overflow detected (yet!), so process... | |
|---|---|
| movdqa xmm1, xmm0 | ; make a copy |
| psrlq xmm0, 4 | ; shift 4 bits to the right |
| por xmm1, xmm0 | ; combine the two |

pshufb xmm1, [.IsolateBytes]; move bytes to proper

position
.finish2:

| ; lo 64 bits of xmm1 are the result to return | |
|---|---|
| ; edx points to halt char | |
| ; ecx is ‘−’ if string is negative | |
| ; first, update haltChar | |
| mov eax, dword [esp+8] | ; load ptr to haltChar |

| | |
|---|---|
| test eax, eax | ; anything there? |
| jz @f | ; no, so skip |

; Yes, so update haltChar ptr
mov [eax], edx

@@:

| ; Finally, extract edx and eax and check sign | |
|---|---|
| pextrd edx, xmm1, 1 | ; move bits 32-63 into |

edx

| | |
|---|---|
| movd eax, xmm1 | ; move bits 0-31 into eax |

; Now, see if negative
cmp cl, ‘−’
je .finishNeg
; positive, so exit now!
ret .nParms*4

Upon arriving at .finish, xmm1 contains the valid digits, one per nibble, with all nibbles shifted as far to the right as possible. Assume the numeric string “0x9876abcdef123” is to be processed. Its value, in hexadecimal form, looks virtually identical to the string representation; this string's hexadecimal value is exactly equal to 0x9876abcdef123. Immediately after the movdqa instruction (which copies xmm0 to xmm1), the two registers appear internally as follows:

| | | | | |
|---|---|---|---|---|
| offset: | 15 12 | | | 0 |
| xmm0: | 00000009 | 0807060A | 0B0C0D0E | 0F010203 |
| xmm1: | 00000009 | 0807060A | 0B0C0D0E | 0F010203 |

Each valid source digit occupies the lower 4 bits of its respective byte position in xmm0, with the upper 4 bits clear (xmm1 is an exact copy of xmm0); the data is pushed to the right as far as it can go, such that the least-significant nibble is at offset 0. Next, xmm0 is shifted 4 bits (one nibble) to the right via the (V)PSRLQ instruction; the two registers now appear like this:

| | | | | |
|---|---|---|---|---|
| offset: | 16 | | | 0 |
| xmm0: | 00000000 | 90807060 | A0B0C0D0 | E0F01020 |
| xmm1: | 00000009 | 0807060A | 0B0C0D0E | 0F010203 |

One can see, visually, that if the two strings are merged, a result close to the final desired value starts to emerge. Using the ‘por’ instruction, the two registers are combined into xmm1, and the registers appear like this:

| | | | | |
|---|---|---|---|---|
| offset: | 16 | | | 0 |
| xmm0: | 00000000 | 90807060 | A0B0C0D0 | E0F01020 |
| xmm1: | 00000009 | 9887766A | ABBCCDDE | EFF11223 |
| desired: | \hat{ }\hat{ } | \hat{ }\hat{ } \hat{ }\hat{ } | \hat{ }\hat{ } \hat{ }\hat{ } | \hat{ }\hat{ } \hat{ }\hat{ } |

The nibbles identified with the ‘A’ characters show the nibble pairs (which are specific bytes) that comprise the final desired result. They are in the correct order, but separated. Therefore, the ‘pshufb’ command is used to shuffle the bytes into the correct position. This command can quickly rearrange bytes to any desired order; a 16-byte template is used, where each byte of the template specifies (if the value is positive) the byte offset of the byte to be placed at this offset in the destination, or if negative, a zero to be placed at that offset. The variable used (.IsolateBytes) is comprised of the following 16 bytes, in this order: 0, 2, 4, 6, 8, 10, 12, 14, −1, −1, −1, −1, −1, −1, −1, −1. After the ‘pshufb’ instruction, the registers appear as follows:

| | | | | |
|---|---|---|---|---|
| offset: | 16 | | | 0 |
| xmm0: | 00000000 | 90807060 | A0B0C0D0 | E0F01020 |
| xmm1: | 00000000 | 00000000 | 0009876A | BCDEF123 |
| desired: | | | \hat{ }\hat{ }\hat{ }\hat{ }\hat{ }\hat{ } | \hat{ }\hat{ }\hat{ }\hat{ }\hat{ }\hat{ }\hat{ }\hat{ } |

All desired bytes are brought together, in order, to the low end of xmm1. The 8 lower bytes can then be easily extracted into edx:eax (or rax, for 64-bit execution environments). Then, prior to exiting, the haltChar, sign, and overflow issues are handled as explained previously. In testing, the Strtou64_b16_C function described above, including initialization and end-of-process overhead, is able to convert the hexadecimal string “12345678abcdef12” to integer over 44 million times per second on a 2.66 GHz Intel Core2 Duo. (Note that the Coreto64_B16 function below, shown in FASM code below, is very similar to the Strtou64_b16_C function just described; the difference is that the former is implemented as a core function that can be called by stub functions, whereas the latter is a fully implementation that does not call a core function.)

One additional method, Coreto64_B16, is implemented as a Core function and is to be called by a stub function; this Core function processes a 16-byte hexadecimal string at over 61 million times per second on a 2.66 GHz Intel Core2 Duo. It achieves the increase in speed due to four crucial features: first, the invalid bit of the .b16 table is at offset 7 of each byte, which is the same as the sign bit, which can then allow the (V)PTEST and (V)PMOVMSKB instructions to operate directly on the data bytes; second, the PTEST instruction can test all sign bits of all bytes in an xmm register, setting the ZF flag if all sign bits are clear, or clearing it if any one of the sign bits is set; third, the PMOVMSKB instruction can collect and aggregate all the sign bits, allowing for a quick BSF instruction that tells how many valid digits are found; and fourth, the PSHUFB instruction can clear bytes and reorder selected bytes into the exact order needed.

In Coreto64_B16, two instructions are used to load each byte into xmm0. In an initial embodiment (shown below), after every 4 bytes, a check is made to determine if any invalid bytes are found; this allows an early exit to the load process, speeding up processing of smaller strings. A skilled implementer could either increase or decrease (or even eliminate) this checking interval; fewer checks makes the process faster when handling larger numbers, but slower when handling smaller numbers.

Once the bytes are collected, processing ends up similar to the process described for Strtou64_b16_C. Here is an example written with FASM code:

;<<<<<<<<<<<<<<<<<<<<<<<<<<<<<<<<<<<<<<<<<<<<<<<<<<<<<<<<<<
; Coreto64_B16
; _u64 Coreto64_B16(edx=char *str, esi=char **haltChar);
; Input:

| | |
|---|---|
| ; | edx −> string to convert |
| ; | esi −> *haltChar (is 0 if none to update) |

; Output:

| | |
|---|---|
| ; | edx:eax = converted value |
| ; | ecx = ‘−’ if neg, else other value |
| ; | [esi] updated if not 0 |

Use xmm instructions to quickly convert base-16 numeric strings

| | |
|---|---|
| ; - | byte by byte, convert digit using .b16 table, load into |

xmm0 and xmm1

| | |
|---|---|
| ; - | after every 4 bytes (or so, user can modify), test sign |

bits via PTEST

| | |
|---|---|
| ; - | as soon as invalid, then finish up |
| ; - | this core function DOES NOT do anything regarding |

negative string, other than

| | |
|---|---|
| ; | to return the sign to the caller. The caller will |

decide what to do!

| | |
|---|---|
| ; - | if not invalid, finish up -- but see if next byte is |

valid; if so, return

| | |
|---|---|
| ; | invalid. |
| ; - | if esi != 0, find halt char and update [esi] |

;
func Coreto64_B16
; Constants...
.tbl equ BaseTbl.b16
; Macros...
macro .mExit {

ret }

macro .ScanB16String xreg, ofs, doTest=1 {

local .x
.x = 0
repeat 4

movzx eax, byte [edx+ofs+.x]
pinsrb xreg, byte [.tbl+eax], (ofs+.x)
.x = .x + 1

end repeat
if doTest

ptest xreg, [.TestSignBits]

end if

}
; The code...

| | |
|---|---|
| mov eax, edx | ; preserve copy for a bit |

| SkipWsAndZeroes edx, ecx | ; at end, sign is in ecx |
|---|---|
| ; Could have stopped at ‘x’ or ‘X’, need to test | |
| ; but first, have we skipped any bytes? | |
| cmp edx, eax | |
| je .noSig | ; no, so don't test for ‘0x’ |

; Yes, skipped over at least one, so now see if this is

0x or 0X

; eliminate chance of straddling cache-line by doing

bytes

mov al, [edx−1]
mov ah, [edx]

Code to isolate “0x” or “0X” . . .

| | |
|---|---|
| and ax, 0xdfff | ; clear lower-case bit |
| cmp ax, 0x5830 | ; compare to “0X” |
| jne .noSig | ; no hex signature found |

@@:

| ; we found it! (so skip over it) | |
|---|---|
| inc edx | ; skip over x or X |

; There could be additional leading zeroes, skip over

them

| cmp byte [edx], ‘0’ | |
|---|---|
| je @b | ; keep looking for leading ‘0’ chars... |

.noSig:

| ; ecx is sign, edx −> most-significant digit | |
|---|---|
| push ecx | ; preserve sign until end |

; Init -- zap xmm regs, then start
pxor xmm0, xmm0
; Load xmm0 first
.ScanB16String xmm0, 0
jnz .Finish0
.ScanB16String xmm0, 4
jnz .Finish
.ScanB16String xmm0, 8
jnz .Finish
.ScanB16String xmm0, 12, 0

.Finish:

| | |
|---|---|
| .Finish0: | ; jmp here if nothing in xmm1 |

; sign bits are set only for invalid bytes, so use the

mask now

| pmovmskb eax, xmm0 | |
|---|---|
| bsf ecx, eax | ; ecx is count (or 0 if all 16 are |

valid)

| | |
|---|---|
| jz .checkOverflow | ; see if one more digit |

; ecx is # valid bytes, edx −> MSD
; see if time to update halt-char address

.checkHaltChar:

test esi, esi
jz .noHaltChar
; Yes, update...
lea eax, [edx+ecx]
mov [esi], eax

.noHaltChar:

; need to rearrange bytes properly, zap invalid bytes,

then create data

| | |
|---|---|
| jecxz .isZero | ; handle if no valid |

digits

| | |
|---|---|
| mov edx, [.ptrShufb+ecx*4] | ; get ptr to proper shufb |

pattern

| | |
|---|---|
| pshufb xmm0, dqword [.Shufb+edx] | ; adjust bytes in |

order to collect bits

Only valid bytes exist, so now merge upper and lower portions of bytes.

| movdqa xmm1, xmm0 | |
|---|---|
| psrlq xmm1, 4 | |
| por xmm0, xmm1 | ; xmm0 has all the bytes, |

intermingled...

| | |
|---|---|
| pshufb xmm0, [.IsolateBytes] | ; xmm0 is aggregated |

value!

| | |
|---|---|
| pop ecx | ; sign |

movd eax, xmm0
pextrd edx, xmm0, 1
; no need to see if negative, caller will handle

that...

.mExit

.isZero:

; If halt-char ptr is updated, need to reset to start

of orig string

| test esi, esi | |
|---|---|
| jz @f | |
| ; Need to re-update with start of string | |
| mov eax, [esp+16] | ; pushed ecx, plus ret addr |

when this function was called,

; so 8 more on stack than from

caller's .str

| | |
|---|---|
| mov [esi], eax | ; store orig address to halt- |

char ptr
@@:

| | |
|---|---|
| pop ecx | ; recover sign, then return 0 |

xor eax, eax
xor edx, edx
.mExit

.checkOverflow:

If next byte is valid, there is overflow

| movzx eax, byte [edx+16] | |
|---|---|
| cmp byte [.tbl+eax], 15 | |
| jb .Overflow | ; next char is valid, so overflow |

occurred

; no overflow, so update halt-char ptr...
test esi, esi
jz @f
lea eax, [edx+16]
mov [esi], eax

@@:

| | |
|---|---|
| pshufb xmm0, [.Shufb] | ; reverse the bytes, then |

continue

| movdqa xmm1, xmm0 | |
|---|---|
| psrlq xmm1, 4 | |
| por xmm0, xmm1 | ; xmm0 has all the bytes, |

intermingled...

| | |
|---|---|
| pshufb xmm0, [.IsolateBytes] | ; xmm0 is aggregated |

value!

; move into edx:eax, see if neg overflow
pop ecx
pextrd edx, xmm0, 1
movd eax, xmm0
ret

.Overflow:

| ; see if we need to check for end of string, otherwise | |
|---|---|
| test esi, esi | ; update halt-char address? |

| jz .OverflowExit | ; no, so exit |
|---|---|
| ; handle need to find end and update | |
| mov ecx, 17 | ; there are 17 digits so far |

@@:

movzx eax, byte [edx+ecx]
inc ecx
cmp byte [.tbl+eax], 15
jbe @b
; update halt-char ptr...
lea eax, [edx+ecx−1]
mov [esi], eax

.OverflowExit:

| | |
|---|---|
| pop ecx | ; restore sign |

or eax, −1
or edx, −1
.mExit

align 16

| | |
|---|---|
| label .TestSignBits dqword | ; tests all sign bits (if |

any set, there's an invalid char)

times 16 db 0x80

label .IsolateBytes dqword

Pattern moves every other byte together in proper position

```
repeat 8
  db (%−1)*2
end repeat
  db 8 dup (−1)
```

; Values used to shift
label .ptrShufb dword

times 16 dd (16*(16-%+1)) and 0xff

| | |
|---|---|
| label .Shufb dqword | ; PSHUFB entries |

```
  ; 16 entries here
  ; - First entry at offset 0 has 16 valid digits
  ; - Second entry at offset 16 has 15 valid digits
  ; - etc.
  ; The PSHUFB entry reverses all valid digits, moves
```

them to lo offset of xmm reg

;
rept 16 n {

reverse

```
  ; create PSHUFB mask...
  repeat n
```

db n-%

```
  end repeat
  repeat 16 − n
```

| | |
|---|---|
| db 0x80 | ; make all invalid bytes convert to |

null

end repeat
}

restore .tbl
purge .ScanB16String, .mExit
endf ; Coreto64_B16
;>>>>>>>>>>>>>>>>>>>>>>>>>>>>>>>>>>>>>>>>>>>>>>>>>>>>>>>>>

Converting Base-10 Character Strings

Converting base-10 strings to integer has certain steps similar to those used when converting other bases. Whitespace is filtered, the sign of the string is identified, and leading zeroes are skipped (see the section “Filtering Whitespace and Leading Zeroes”). With Coreto64_B10 and Atou64_Lea (below), prior to converting characters, the last valid digit is first identified (which informs as to the number of characters to convert); see the section “Finding End of Significant Digits”. (In alternative embodiments of Atou64_Lea, it is possible to start converting as soon as characters are loaded and validated; this can be faster, especially for numbers that fit within a single accumulator.) At the end of the process, the return value is negated if the string was negative. In some variants, a careful skilled implementer could adjust the code to preserve and also return to the caller the address of the halt char (or update it before returning); the address pointing to it is equal to ptrReg+countReg immediately upon exit from the CountValidBase10Digits macro and prior to starting the main code body.

The binary encoding of each base-10 character is as follows:

‘0’ hex: 0x30 binary: 00110000b
‘1’ hex: 0x31 binary: 00110001b
‘2’ hex: 0x32 binary: 00110010b
‘3’ hex: 0x33 binary: 00110011b
‘4’ hex: 0x34 binary: 00110100b
‘5’ hex: 0x35 binary: 00110101b
‘6’ hex: 0x36 binary: 00110110b
‘7’ hex: 0x37 binary: 00110111b
‘8’ hex: 0x38 binary: 00111000b
‘9’ hex: 0x39 binary: 00111001b

Note that all ten valid digits are contiguous; therefore, the value of any valid base-10 character can be determined by subtracting the base character (the ‘0’ character) from that character (or by adding its negative). This feature is used in the algorithms described below in order to avoid unnecessary accesses of the BaseTbl.b10 table once the validity of the character being converted has been verified.

The two algorithms below, Coreto64_B10 and Atou64_Lea, have similar initialization and termination code, but the bodies differ. In both, whitespace is filtered, a sign is detected, the first valid digit is identified, and the number of valid characters is determined; then the main process in the body takes over. At the end, both return a 64-bit value in edx:eax which is negated if the character string is negative; if overflow occurs, it is signaled as explained elsewhere in the present disclosure. If desired, either or both can update a caller's pointer to the halt char. Additionally, either one could be modified by a skilled implementer to accept a parameter telling the exact length of the characters to convert, and with a pointer to the first valid character; this would run faster, and such a function is helpful, for example, when converting floating-point strings to integer format (see “Converting Floating-Point Numeric-Character Strings to Double” and “Atou64_Exact”).

Coreto64_B10 Core Function

The Coreto64_B10 algorithm uses ADD instructions to accumulate valid values during conversion of the character digits into an integer; no MULTIPLY or SHIFT instructions are needed. On entry to the main body, a pointer points to the most-significant digit, and the total number of valid characters is known. It is quickly determined if there are too many significant digits; if so, the operation will overflow before attempting to convert any digits. If not, a series of very fast ADD instructions is used to add, from the TensTbl table, a value representing the appropriate value for each position of the string. For example, for the string “3814”, the digit ‘3’ is in the thousands position; it's value, 3000, is first moved into an accumulator by accessing the appropriate point in TensTbl to obtain that value. The next digit ‘8’ is in the hundreds place; by indexing TensTbl appropriately, the value 800 is added to the accumulator. In similar fashion, the ‘1’ results in adding 10, and the ‘4’ results in adding 4, to the accumulator, thereby obtaining the proper final result which, in this case, is 3,814.

The table TensTbl (comprised of 64-bit entries) is required for this algorithm; the structure of this table is now described. At the very end, an extra entry of 0 is added, since additional bytes beyond the end of the table could be accessed; its value does not matter, but this ensures there is some data there so that if PADDQ instructions are used, such as is the case with Coreto64_B10, none of the instructions will fail. In some embodiments, the 90 lowest entries, all of which are known to require just 32 bits, can be created as 32-bit numbers. However, if this is done, the table cannot easily be used with 64-bit accumulators, such as xmm registers.

Any method desired can be used to create the table. One method is to simply enter the proper values in a list; or, the entries can be created programmatically at runtime, or converted to text that can then be copied in as source code. The skilled implementer can decide whether to create the table dynamically at run time, or whether to load it from a memory-storage device. The maximum value for a 64-bit unsigned integer is 18,446,744,073,709,551,615; there are 20 digits in this number, each representing a different magnitude, or tens place. And for each place there are 10 possible values, i.e., for the one's place, the ten values are 0 through 9; for the ten's place, the ten values are 10, 20, 30, 40, 50, 60, 70, 80, and 90; this pattern continues for each digit position.

A simple way to envision this table is to consider it as 20 separate 10-entry tables, one for each position of the decimal string being converted. Each table can be given an easy-to-use name, such as TensTbl.20 to represent the table handling the most significant digit to the far left (at position 20, counting from 1 and starting from the right). TensTbl.19 would hold the next-lower order table, and so on, with the last table called TensTbl.1.

To create the ten entries for each of the 20 tables, first identify the proper power-of-ten value (call it Base, a 64-bit unsigned integer) that represents that position. Then, each entry is equal to Base multiplied by the values 0 through 9 to create ten entries. Care is taken, though, for handling the high-order position. Refer to the example below that shows three section boundaries and aligns two strings on their least-significant digits.

Consider that for a 20-digit numeric string (see StrMax in the example below), there is no valid case where the high-order position can hold any digit other than ‘0’ or ‘1’. To create entries for that high-order position (labelled with the address name TensTbl.20 in our example), Base will be 10,000,000,000,000,000,000. The first entry, starting at the address TensTbl.20, is equal to Base times 0, which is 0; the next entry, Base times 1, will be equal to Base. But the following 8 entries, since they exceed the capacity of 64-bit integers, are set to 0. That completes the TensTbl.20 portion of the table.

To continue, divide Base by 10 and create the next 10 entries starting at the address TensTbl.19. Base will be 1/10 the previous value, or 1,000,000,000,000,000,000. The next ten entries now created will be 0; then 1,000,000,000,000,000,000; then 2,000,000,000,000,000,000; then 3,000,000,000,000,000,000 then 4,000,000,000,000,000,000; then 5,000,000,000,000,000,000; then 6,000,000,000,000,000,000; then 7,000,000,000,000,000,000; then 8,000,000,000,000,000,000; and then 9,000,000,000,000,000,000. Base is divided again by 10, and the next ten entries are created, and so on, until all 20 tables are created.

A key element of the TensTbl-creating algorithm is that it is known exactly what power-of-ten position is being processed for each digit, so that the proper value is placed at each entry and will be accessed when and as intended.

When implementing this algorithm in a high-level language such as C or C++, it might be tempting to simply create an array such as “unsigned long long TensTbl[20][10]” or “unsigned long long TensTbl[200]”. That can work; but due to how arrays are indexed in C/C++, the compiler may embed multiplication commands, or extra shift commands, when the table is accessed. It may be faster, execution-wise, to allocate 20 different tables, say “TensTbl_{—}20”, “TensTbl_{—}19”, . . . “TensTbl_{—}1” and then to access each table by name as needed. On the other hand, a skilled programmer can test the output of the compiler and then create and utilize a method of addressing TensTbl that is efficient.

It is known that, because of the composition of the table and the processes followed, there is no overflow for any unsigned calculated number unless it is comprised of more than 19 character digits. And if the numbers are added together intelligently, additional CPU instructions can be avoided. For example, when a register of fewer bits is added to a register (or register pair) having more bits, any carry is added to the higher-order bits after the low-order bits are combined. For example, to add the 32-bit value 1 to the 64-bit register pair edx:eax, the following instructions are used:

add eax, 1
adc edx, 0

The second instruction adds 0, unless the carry flag is set, in which case it adds one to the edx register containing the upper 32 bits of the number in the edx:eax pair. If the second instruction is eliminated, additions to this edx:eax pair will eventually be corrupted, possibly even on the first addition. But if a 32-bit accumulator is used to accumulate a number known to be not greater than 32 bits, a single 32-bit register can be used (such as eax) and the second line, where the upper 32-bit value is adjusted, can be eliminated; note that this applies not only to final results that fit within 32 bits, but also to final results that require more, but where a 32-bit accumulator can be used to purposely avoid the ADC instruction by delaying any addition operations that could exceed 32 bits.

Therefore, for any plain string comprised of 9 or fewer significant digits, the eax register can be used as the accumulator (it can hold a maximum value of over four billion, while the maximum value of a 9-character string is one less than one billion). As an example, to convert the numeric string “123456789”, the following instructions are used (assume esi points to the first digit, eax is the accumulator, and the string is known to consist of 9 valid characters):

.Digit9:

movzx ecx, byte [esi+0]
mov eax, [TensTbl.9+ecx*8−0x30*8]
movzx ecx, byte [esi+1]
add eax, [TensTbl.8+ecx*8−0x30*8]
movzx ecx, byte [esi+2]
add eax, [TensTbl.7+ecx*8−0x30*8]
movzx ecx, byte [esi+3]
add eax, [TensTbl.6+ecx*8−0x30*8]
movzx ecx, byte [esi+4]
add eax, [TensTbl.5+ecx*8−0x30*8]
movzx ecx, byte [esi+5]
add eax, [TensTbl.4+ecx*8−0x30*8]
movzx ecx, byte [esi+6]
add eax, [TensTbl.3+ecx*8−0x30*8]
movzx ecx, byte [esi+7]
add eax, [TensTbl.2+ecx*8−0x30*8]
movzx ecx, byte [esi+8]
add eax, [TensTbl.1+ecx*8−0x30*8]
xor edx, edx ; edx:eax has result
jmp .exit

Note that the table names and offsets are hard coded. The code segment above works perfectly when it is known that there are exactly 9 characters. For each ADD instruction, the base address of the TensTbl is specified with an offset to the power-of-ten unit being processed. The valid digit character in ecx is multiplied by 8 in order to access the proper entry of the table; and since the value in ecx is 0x30 units greater than the value we want to add by the value, the value (0x30x8) is subtracted from the register in order that the correct value from the TensTbl is accessed.

It is possible to have a similar fragment of code, one for each of the 20 possibilities (with adjustments made as needed to handle edx and carries), with each containing all instructions to execute in its code path. For example, the segment of code handling exactly 5 characters can be as follows:

.Digit5:

movzx ecx, byte [esi+0]
mov eax, [TensTbl.5+ecx*8−0x30*8]
movzx ecx, byte [esi+1]
add eax, [TensTbl.4+ecx*8−0x30*8]
movzx ecx, byte [esi+2]
add eax, [TensTbl.3+ecx*8−0x30*8]
movzx ecx, byte [esi+3]
add eax, [TensTbl.2+ecx*8−0x30*8]
movzx ecx, byte [esi+4]
add eax, [TensTbl.1+ecx*8−0x30*8]
xor edx, edx ; edx:eax has result
jmp .exit

In each of the above examples, the first two lines move the first value into the accumulator (eax) while the subsequent pairs of lines add the values from the other positions to the accumulator; this effectively initializes the accumulator with the value of the first table listed at the top, with values from the other tables aggregated to that as execution progresses. The above works due to the fact that all characters in the string are first pre-scanned and it is known that all characters are valid digits for the target base (which in this case is base 10). At this point, edx can be set to 0 and the value returned to the caller. Typically, however, once the number has been converted, the third part of the conversion process will determine if the number is to be negated and/or if a halt-char pointer is updated.

There are 9 code chunks similar to the above (from .Digit1 to .Digit9), with each chunk doing exactly enough to process its respective number of digits. At the end of each, the edx register is zeroed (it will always be zero at this point); the number is then negated if the string is negative, and control returns to the caller. The process can be extended to handle more than 9 digits by following the basic pattern above but with provision to manage multiple accumulators (one method to do this is shown below). The proper bytes are loaded as indexed by esi and an index, while also ensuring the proper table is accessed each time, and that edx is properly adjusted; and as soon as values could exceed 32 bits, an additional register or accumulator is used, and all accumulators are stitched together (as explained elsewhere in the present disclosure) to return the proper value to the caller. But the process can be simplified and the code made shorter with some changes, as follows.

First, it is known that any decimal string with 9 or fewer digits can easily fit within 32 bits, allowing use of a 32-bit accumulator. (Note that these issues are simplified in 64-bit programming, where a 64-bit accumulator can be used; no carry needs to be addressed, and no overflow occurs, until the highest-order digit is added to the accumulator, and all accumulation instructions can be put in line to quickly convert a 20-digit string.) Therefore, no carry needs to be addressed when aggregating up to 9 decimal digits in an accumulator. But when handling a tenth digit (and more), the code changes. It is quickest, however, when converting plain strings with more than 9 digits, to first accumulate the lower nine, avoiding dealing with the carry. Then when the tenth and higher digits are added, the carry is handled with each 32-bit add instruction (or, as in alternative embodiments, multiple 32-bit registers are used such that there is no carry to worry about until the accumulators are aggregated at the end prior to returning to the caller).

One change is facilitated by the fact that the pointer register need not always point to the first character of the group it is being used to index; this is due to having an optional offset value when accessing the byte, which adds either a positive or negative offset to the esi register in the above code. For example, in the .Digit9 code fragment above, on the first line, 0 is added to esi, meaning that esi plus the offset (of nothing) points to the proper character to load into ecx. However, if esi pointed backward 11 bytes, and an offset of 11 was used with it, the two would combine to achieve the exact same address, and the same byte would be loaded.

This is what is done to allow a single large fragment to handle any of the cases from 1 to 9 nine digits; the main pointer is adjusted backward by an amount equal to the number of valid digits minus 20. Each section of the number is handled by its own group, based on which of three sections is being processed.

In practice, it has been found useful to divide the processing of plain numeric strings into three parts, each of which is handled by its own code section. The lower section will handle all plain strings of 0 to 9 characters; the middle section will handle all strings of 10 to 18 characters; and the upper section will handle all strings of 19 to 20 characters. Note that when converting to larger than 64-bit integers, these sections can be adjusted to accommodate 64-bit accumulators, or larger, if desired, and/or additional sections can be used.

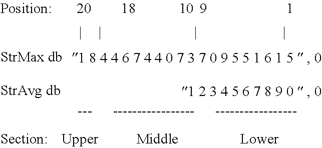

Two numeric strings are shown (with no preceding whitespace). Note that the numbers are lined up according to their least-significant digits on the right. StrMax is the maximum value for a 64-bit unsigned integer, and it contains the maximum of 20 digits, with digits in each section. Note that the upper section comprises bytes 19 and 20; the middle section comprises bytes 10 through 18; and the lower section comprises bytes 1 through 9. StrAvg contains digits in both the lower and middle sections.

When processing numeric strings with this method, the following occurs after the number of valid digits has been determined; if there are more than 20, overflow is detected and no values need to be aggregated (an overflow code section returns the proper overflow indicator to the caller). Before using the jump table to branch to the target that will quickly process the number of digits found in countReg (at the end of the CountValidBase10Digits process), the accumulator eax is cleared and esi is adjusted; esi is made equal to esi+countReg−20. Then the jump table is used to branch to the appropriate target. The lower-section code can be as follows:

; Lower-section code...
.Digit9:

movzx ecx, byte [esi+11]
add eax, [TensTbl.9+ecx*8−0x30*8]

.Digit8:

movzx ecx, byte [esi+12]
add eax, [TensTbl.8+ecx*8−0x30*8]

.Digit7:

movzx ecx, byte [esi+13]
add eax, [TensTbl.7+ecx*8−0x30*8]

.Digit6:

movzx ecx, byte [esi+14]
add eax, [TensTbl.6+ecx*8−0x30*8]

.Digit5:

movzx ecx, byte [esi+15]
add eax, [TensTbl.5+ecx*8−0x30*8]

.Digit4:

movzx ecx, byte [esi+16]
add eax, [TensTbl.4+ecx*8−0x30*8]

.Digit3:

movzx ecx, byte [esi+17]
add eax, [TensTbl.3+ecx*8−0x30*8]

.Digit2:

movzx ecx, byte [esi+18]
add eax, [TensTbl.2+ecx*8−0x30*8]

.Digit1:

movzx ecx, byte [esi+19]
add eax, [TensTbl.1+ecx*8−0x30*8]
xor edx, edx ; edx:eax has result
jmp .exit

This allows for branching to the proper location, with the code paths merging onto the same code, significantly reducing the length of the code. Note that the top two lines have been adjusted to ADD, rather than MOVE, the value from TensTbl.9 (this works because the accumulator eax is cleared before jumping to the target).

The code for the middle-section requires, for each size from 10 to 18, a small stub of code executed at the start of the branch, that calls a function (.ProcessLowerSection) that is similar to the lower-section code but with a return instruction at the end; it returns a 32-bit value with eax containing the total represented by all digits of the lower section of the plain string. This eliminates nine instances of the “adc reg, 0” instruction that would be needed if these values were added to a 64-bit accumulator after first accumulating values from the middle section. The stub for each of the nine possibilities (.Digit10 to .Digit18) is similar to the following:

; Sample for .Digit 14... others are similar, but jmp
location
; is modified to represent the number of the digit to
process
.Digit14:

; control comes here
call .ProcessLowerSection ; return aggregate of lower

section

xor edx, edx ; make sure it's zero to start
jmp .Digit14cont

Before jumping to the main middle-section code, the edx register is cleared. The middle-section code looks similar to the following:

; Middle-section code...
.Digit18cont:

movzx ecx, byte [esi+2]
add eax, [TensTbl.18+ecx*8−0x30*8]
adc edx, 0

.Digit17cont:

movzx ecx, byte [esi+3]
add eax, [TensTbl.17+ecx*8−0x30*8]
adc edx, 0

.Digit16cont:

movzx ecx, byte [esi+4]
add eax, [TensTbl.16+ecx*8−0x30*8]
adc edx, 0

.Digit15cont:

movzx ecx, byte [esi+5]
add eax, [TensTbl.15+ecx*8−0x30*8]
adc edx, 0

.Digit14cont:

movzx ecx, byte [esi+6]
add eax, [TensTbl.14+ecx*8−0x30*8]
adc edx, 0

.Digit13cont:

movzx ecx, byte [esi+7]
add eax, [TensTbl.13+ecx*8−0x30*8]
adc edx, 0

.Digit12cont:

movzx ecx, byte [esi+8]
add eax, [TensTbl.12+ecx*8−0x30*8]
adc edx, 0

.Digit11cont:

movzx ecx, byte [esi+9]
add eax, [TensTbl.11+ecx*8−0x30*8]
adc edx, 0

.Digit10cont:

movzx ecx, byte [esi+10]
add eax, [TensTbl.10+ecx*8−0x30*8]
adc edx, 0
jmp .exit

At this point, edx:eax has the aggregate result. And when this algorithm is not in a core function, it is negated for negative strings, and the value edx:eax returns to the caller (for core functions, the stub functions take care of handling negative strings as mentioned elsewhere in the present disclosure).

In alternative embodiments, the middle section uses a separate accumulator. When both the middle and lower sections have been processed, the accumulators are stitched, or aggregated, by multiplying the middle-section accumulator by one billion, then adding the lower accumulator to that value (and adjusting for any carry).

The code for the upper-section portion will now be explained; the upper-section portion is used when there are 19 or 20 valid digits. The lower-section portion is processed first to eliminate code handling a potential carry (by calling the same .ProcessLowerSection function). Then, a similar function that processes the middle section is called (.ProcessMiddleSection) that is virtually identical to the middle-section code, but without any labels intermixed with the code and with a return instruction so that it returns to the caller. Then, the one or two bytes of the upper section are handled with a few instructions. The stubs for .Digit19 and .Digit20 are similar to the following:

; Sample for .Digit19...
.Digit19:

; control comes here
call .ProcessLowerSection ; returns eax
call .ProcessMiddleSection ; clears edx, then returns

edx:eax

; just one additional digit to process
movzx ecx, byte [esi+1]
add eax, [TensTbl.19+ecx*8−0x30*8]
adc edx, 0
jmp .exit
; edx:eax now has final result

; Sample for .Digit20...
.Digit20:

; control comes here
call .ProcessLowerSection
call .ProcessMiddleSection
; two additional digits to process
movzx ecx, byte [esi+1]
add eax, [TensTbl.19+ecx*8−0x30*8]
adc edx, 0
movzx ecx, byte [esi+0]
add eax, [TensTbl.20+ecx*8−0x30*8]
adc edx, 0
jc .foundOverflow ; carry is set if edx overflowed

; edx:eax now has final result
.exit:

Convert to negative if needed, handle neg overflow, pop registers, clean up stack, etc., then return to caller.

...

.foundOverflow:

; Process overflow, for example set edx:eax to max
or eax, −1
or edx, −1
; pop registers, clean up stack, etc., then return to

caller

...

.foundNegOverflow:

xor eax, eax
mov edx, 0x80000000
...

.Digit0:

; No valid digits, set result to 0
xor eax, eax
xor edx, edx
; pop registers, clean up stack, etc., then return to

caller

The above code shows the core details needed to create a working version of the Coreto64_B10 function; a skilled implementer can create the jump table to use and tie the above fragments together.

The Coreto64_B10 function uses the xmm0 register functioning as a 64-bit accumulator, and does away with the need for managing addition carries unless there are more than 18 digits. This is a Core function that can be called by stub functions, as explained elsewhere in the present disclosure; note that it calls the CountB10Digits function that is detailed in the “Finding End of Significant Digits” section. The following FASM code shows one embodiment of the algorithm using xmm registers and the (V)PADDQ instruction:

| ;;;;;;;;;;;;;;;;;;;;;;;;;;;;;;;;;;;;;;;;;;;;;;;;;;;;;;;;;; | |
|---|---|
| ;-------------- Beginning of Function --------------------; | |
| ; _u64 Coreto64_B10(edx=*str, esi=**haltChar); | |
| ; Core base-10 function that can be used for Atou, Atoi, | |
| Strtou, Strtoi, etc., for any byte size up to 64 bits | |
| ; Simple, unrolled version that does everything while | |
| keeping small code size and maintaining acceptable speed | |
| ; Input: | |
| ; | edx −> str |
| ; | esi −> *haltChar; if null, no need to search for end or |
| to update haltCharPtr | |
| ; Returns: | |
| ; | edx:eax = result (reflects unsigned result or pos |

| overflow) | |
|---|---|
| ; | caller will handle minus sign |

| | |
|---|---|
| ; | esi −> updated halt char (if value not null) |
| ; | ecx = ‘−’ if negative, else some other char |

;
func Coreto64_B10
macro .mExit {

pop ebx
ret

}

SkipWsAndZeroes edx, ecx ; edx is ptr, eax is test, ecx

for sign

| | |
|---|---|
| call CountB10Digits | ; eax = # digits |

| cmp eax, BaseTbl.b10.maxDigits | |
|---|---|
| ja .FastOverflow | |
| push ebx | |
| test esi, esi | ; need to update halt char? |

| jz .noHaltUpdate | |
|---|---|
| lea ebx, [edx+eax] | ; ebx −> halt char |
| mov [esi], ebx | ; update address |

.noHaltUpdate:

eax has # digits, so jmp to proper location!

pxor xmm0, xmm0
call [.JmpTbl+eax*4]

If 19 or fewer digits, never any overflow for core

.mExit

.FastOverflow:

; ebx not yet pushed/popped
; Add code: if esi not null, need to find end...
test esi, esi
jz .noHaltUpdate2
; Need to find end of valid digits...
cmp eax, CountB10Digits.MAX_DIGITS
jb .FastOverflow.update

; max returned was 32, may need to continue search

for

; valid digits if it's anticipated there could be

more

; than 32 consecutive valid digits

push ecx
dec eax

@@:

; look at next byte...
inc eax
movzx ecx, byte [edx+eax] ; get next byte
cmp byte [BaseTbl.b10+ecx], 9
jbe @b
; found halt char, so update now
pop ecx

.FastOverflow.update:

add edx, eax
mov [esi], edx

.noHaltUpdate2:

or eax, −1
or edx, −1
ret

.d20:

Since we have to check the first digit in all cases, check it now—if >1, definite overflow.

| ; now, check first digit to see if valid | |
|---|---|
| movzx ebx, byte [edx] | ; get first byte |

| ; If > 1, we overflowed... | |
|---|---|
| cmp bl, ‘1’ | ; if digit > ‘1’, definite |

overflow

| ja .overflow | |
|---|---|
| ; No overflow yet, so process lower 19 digits first | |
| call .d19 | ; process lower 19 digits |

; result in edx:eax, so add final value, see if

overflow

add eax, [TensTbl.20+8]
adc edx, [TensTbl.20+8+4]
jc .overflow
retn

.overflow:

or eax, −1
or edx, −1
retn

rept 19 n {

common
local ofs
ofs = 1
reverse

.d#n:

| movzx ebx, byte [edx+eax−20+ofs] | |
|---|---|
| ofs = ofs+1 | |
| movq xmm1, [TensTbl.#n+ebx*8−‘0’*8] | ; subtract out ‘0’ |

values, one for each scale

paddq xmm0, xmm1

}

; At end, extract edx and eax, then return
pextrd edx, xmm0, 1
movd eax, xmm0
retn

.d0:

Value is 0, so exit . . . but to match MS _strtoui64 behavior, if halt-char address is to be updated, need to correct it and store the starting ptr

test esi, esi
jz @f
; need to grap ptr from caller's stack
; this happens ONLY when ngstrto... function is the

caller

mov edx, [esp+20]

; this function pushed esi, plus retn, plus ret

when

; it was called, so ofs = 12 more than caller's

.str

mov [esi], edx

@@:

| ; eax is already 0 (used to index .JmpTbl to get here) | |
|---|---|
| xor edx, edx | |
| retn | ; return to caller |

| label .JmpTbl dword | |
|---|---|
| rept 21 n:0 { dd .d#n } | ; need entries from 0 thru 20, |

or 21 total!
purge .mExit
endf ; func Coreto64_B10
;--------------- End of Function ------------------------;

Atou64_Lea

The Atou64_Lea algorithm uses the LEA instruction to aggregate values into the accumulator while processing base-10 numeric strings. This instruction on Intel-compatible CPUs allows a value to be immediately multiplied by 2, 4, or 8 . . . and with special care, it can multiply by 5 in one instruction and by 10 in two instructions. As shown below, immediately after a digit is moved into ecx, the accumulator (which is eax when processing the lower-section portion) is multiplied by 5: the value of the register is added to the result of that register multiplied by 4. Then with the next instruction, the accumulator is doubled (effectively multiplying it by 10), its original value of the new digit is added as a value to the result, and the value ‘0’ is subtracted in the same instruction. The LEA instruction is very fast, operating in one clock cycle (and often less) even with the multiplication and addition of registers and offsets at the same time.

The algorithm is quite similar to that of the Coreto64_B10 algorithm. The same three sections are kept segregated, but are handled slightly differently, as now explained. The core of the algorithm requires three instructions to read and then combine the value via LEA instructions for each digit (rather than the instructions used to add the value with the (V)PADDQ instruction, for example, to process digits in the Coreto64_B10 algorithm).

Prior to using a jump table to jump to the proper location (based on the number of valid digits), the esi register is adjusted so that esi, plus the offset indicated, will address the proper byte at each command. The following instruction is used to update esi:
lea esi, [esi+ecx-20]; makes esi+offset->proper start!

Considering the lower-section code, here is what happens. When there are 9 valid digits (ecx will therefore equal 9), the above operation makes esi point 11 characters prior to the first byte of the string; but when the offset 11 is added, it points to the proper byte. And when there are 8 valid bytes, the above operation makes esi point 12 bytes prior to the start of the string; but at offset .Digit8, the offset 12 is added to this, making the location point to the proper byte. As the code flows down, each offset is one less than for the prior byte, meaning that the proper byte is accessed at each point. This same logic applies to both the upper- and middle-section portions of the code.

Here is what the lower-section code can look like:

; Lower-section code...
; esi points to
.Digit9:

movzx edx, byte [esi+11]
lea eax, [eax*4+eax]
lea eax, [eax*2+edx−‘0’]

.Digit8:

movzx edx, byte [esi+12]
lea eax, [eax*4+eax]
lea eax, [eax*2+edx−‘0’]

.Digit7:

movzx edx, byte [esi+13]
lea eax, [eax*4+eax]
lea eax, [eax*2+edx−‘0’]

.Digit6:

movzx edx, byte [esi+14]
lea eax, [eax*4+eax]
lea eax, [eax*2+edx−‘0’]

.Digit5:

movzx edx, byte [esi+15]
lea eax, [eax*4+eax]
lea eax, [eax*2+edx−‘0’]

.Digit4:

movzx edx, byte [esi+16]
lea eax, [eax*4+eax]
lea eax, [eax*2+edx−‘0’]

.Digit3:

movzx edx, byte [esi+17]
lea eax, [eax*4+eax]
lea eax, [eax*2+edx−‘0’]

.Digit2:

movzx edx, byte [esi+18]
lea eax, [eax*4+eax]
lea eax, [eax*2+edx−‘0’]

.Digit1:

movzx edx, byte [esi+19]
lea eax, [eax*4+eax]
lea eax, [eax*2+edx−‘0’]

; finished, so prepare to exit

xor edx, edx ; edx:eax has result
jmp .exit

There is not an easy way to use the LEA instruction to shift part of one register into another, such as is performed when the edx:eax pair has a value added to it; the LEA instruction does not affect the flags, so any overflow from using the LEA instruction cannot be detected after the fact. So, the structure of the present invention eliminates any chance of an overflow by processing a maximum of 9 digits when using 32-bit accumulators (when using 64-bit accumulators, such as rax in 64-bit code, up to 19 digits can be processed; the 20^{th} digit, if present, is processed separately to catch any overflow). So, rather than trying to manipulate a register pair, a separate accumulator register is used to accumulate the values from each section; this has the added advantage of avoiding any carry or overflows until the very end, when the accumulators are combined to produce the final result.

As described above, each time a valid digit is accessed to be aggregated into the accumulator, esi is offset by an appropriate value each time. Also, there are three code chunks, one for each section, but three 32-bit accumulators are used: a first one for the digits 1 to 9, a second for the digits 10 to 18, and a third for digits 19 to 20; the second and third accumulators are used only if the number of digits requires them.

As soon as CountValidBase10Digits has completed, esi points to the start of the string and ecx is the count of the number of valid digits. The eax accumulator is then cleared, and control branches to the appropriate point via a jump table that lists all needed addresses. Whether the section branched to is part of the lower-, middle-, or upper-section portion, the various accumulators are used to aggregate values from the digits of each respective section, following the above pattern (note that eax is always used as the first accumulator, regardless of which section is first branched to). Note that in the lower-section code immediately above that the edx register is used as the temporary register to hold each byte; this helps to eliminate unnecessary shuffling of registers if more than one section is used, as it allows the edx register to be updated via a MULTIPY command (since it's not used as an accumulator, it can be immediately used at the end of the section with no need to preserve its value, as shown below).

50, if the plain string has 9 or fewer bytes, control can branch to the above .Digit9 through .Digit1 addresses and the proper value will be returned; not all code is shown, as the skilled implementer will know how to negate the value, clean up the stack, and return properly to the caller, and can review other algorithms from the present disclosure to help finish the function.

If there are 10 to 18 bytes, a chunk of code to process the middle-section portion is branched to . This handles the addresses .Digit18 to .Digit10, at the bottom of which eax has accumulated the value of all middle-section digits from the plain string being processed. But rather than modifying edx and exiting, instead, all the digits of the lower section are accumulated in the 32-bit ebx register, similar to the lower-section code. A function named .ProcessLowerSection can accumulate the value of the digits 1 to 9 in the ebx register (using edx as the temporary register that obtains each digit character in turn), or the code could be placed in line.

When done correctly, the value of all digits of the lower-section portion are accumulated in ebx, and the digits from the middle-section portion are accumulated in eax; these two sections are combined. There will be 9 digits for the lower section; its value, aggregated in eax, can range from 0 to 999,999,999. There will be 1 to 9 digits in the middle section; its value will range from 1 to 999,999,999 (it won't be zero, since leading zeroes were skipped), and is aggregated in eax. At this point, the value in eax is multiplied, with one instruction, by the value one billion (1,000,000,000). This converts the value to a 64-bit value using edx to hold the upper 32-bit value from the MULTIPLY instruction, with eax holding the lower 32 bits, of the proper aggregated total for the middle-section portion of the string. Then ebx is properly added to edx:eax, resulting in the proper result in the edx:eax pair as follows:

| | |
|---|---|
| mul [.billion] | ; memory variable = to one billion |

| add eax, ebx | |
|---|---|
| adc edx, 0 | ; edx:eax is proper value! |

; Exit now

When there are 19 or 20 digits, the above strategy is replicated. Since eax was just cleared immediately before .Digit19 or .Digit20 gets control, eax is used to aggregate the values of the one or two bytes, respectively, of the upper-section portion. Once aggregated, the maximum value of the upper section is 18 (this represents the maximum possible value of the two left-most digits for the largest possible 64-bit unsigned integer). These can be tested now; if the value in eax is greater than 18, the value has overflowed (jump to .overflow); no further processing need be done, and overflow can be indicated when returning to the caller.

The ecx register can be used to accumulate the 9 middle-section digits (either inline code, or a function .ProcessMiddleSection is called), and the ebx register is used to accumulate the 9 lower-section digits (again, either inline code, or call .ProcessLowerSection). Then, the three accumulators are ready to be combined, which can be done with the following code:

| ; eax is the first accumulator, ecx is 2nd, ebx is 3rd | |
|---|---|
| ; need to multiply ecx by 1,000,000,000 and add ebx | |
| mov esi, eax | ; preserve for a while so we don't |
| | ; have to check overflow |

; explode 2nd accumulator (ecx)
mov eax, ecx
mul [.billion]
; combine with 3rd (ebx)
add eax, ebx
adc edx, 0
; and combine with 1st, checking for CF!
add eax, dword [.HugeNum+esi*8]
adc edx, dword [.HugeNum+esi*8+4]
jc .overflow
; edx:eax is proper value!
; Ready to exit now

When the eax accumulator for the upper-section portion is combined with the middle and lower accumulators, this upper-section accumulator is multiplied by the value 1,000,000,000,000,000,000 (one quintillion). This is a costly multiplication, but it can be done. However, in an initial embodiment, the eax register is used as in index into a 19-entry table .HugeNum. This table contains the appropriate 64-bit values to add to the edx:eax pair: 0, 1 quintillion, 2 quintillion, 3 quintillion, . . . , 18 quintillion. The appropriate value of this table is indexed by esi (which is a copy of the eax accumulator; and since eax is first tested to see if it is greater than the maximum allowable value of 18, there is no need for more than 19 entries in the table); the indexed entry value is added to the already combined middle- and lower-section accumulators as shown above.

A skilled implementer could customize this lea-based algorithm to handle any base conversion. The core section for each such base would need to be customized, but since any value from 2 through 36 can be created by using no more than a few LEA instructions, such an algorithm might execute more quickly than one using the MULTIPLY instruction.

Note that the skilled implementer will use care when calling .ProcessMiddleSection or .ProcessLowerSection, to ensure the proper registers are used as accumulators; upon return from the call, the returned value may need to be moved to a different accumulator.

Atoi_Mult

Another numeric-string-conversion method that is now described uses MULTIPLY instructions. This algorithm takes advantage of the fact that SIMD instructions allow vector-multiplication instructions to perform several multiplications simultaneously, which lowers the cost of a MULTIPLY sufficiently to make it perhaps the fastest method for converting base-10 numeric strings to integers.

This algorithm recognizes the fact that each digit occupies a specific “power-of-ten place” and, if handled correctly, the proper power-of-tens values can be multiplied against 4 digits at a time (or 8, for example, if using ymm registers) and the results accumulated via (V)PADDD and (V)PHADDD instructions. Each valid base-10 numeric string can be divided into up to five 4-digit blocks, each of which is handled separately, and then aggregated with the others with proper scaling of the accumulators used.

For example, assume the base-10 numeric string “1000234567895” is to be converted to an unsigned 64-bit integer; there are 13 digits, and the string can be divided into four sections of up to 4 bytes each. Assume the first section A contains the first 4 characters “1000”, the second section B contains the next characters “2345”, the third section C contains “6789”, and the fourth section D contains “5”. Each of these sections can be processed separately, but in similar ways.

Sections A, B, and C can be converted as follows. For each of these sections, there are 4 valid characters, and each character can be quickly converted into an integer by subtracting the value ‘0’ from each character. For A, the first character “1” is converted to the value 1, and the remaining “0” characters are each converted to the value 0. The value 1 is in the thousands place, so it is multiplied by 1000. Each of the other characters is multiplied by 100, 10, or 1, respectively; since they are all 0, the product is 0. Then the four products (1000+0+0+0) are added together, arriving at the total 1000 for section A. Section B is handled similarly, and after multiplying each value by the power of ten indicated by the position of each digit, the four products (2000+300+40+5) are added, to arrive at the aggregated total 2,345 for section B. Section C is handled similarly, with the aggregated total 6,789.

The last section, section D, is handled a bit differently after all characters in the section are reduced by subtracting the value ‘0’ from each. The number of valid digits for this last section must be known, and that count is used to access the proper set of multipliers to use to multiply against all characters in section D. There can be invalid characters (in this example, there will be 3 invalid characters), and so to get rid of any harm they may cause, those invalid characters, whatever value they have, are multiplied by the value 0, which eliminates any effect they would otherwise have. Since there is one valid character, it is multiplied by 1 and the other three values are multiplied by 0. If there were two valid digits, the first two would be multiplied by 10 and 1, with the others by 0. If there were three valid digits, the multipliers would be 100, 10, 1, and 0; and for four valid digits, the multipliers would be 1000, 100, 10, and 1. Therefore, after processing, the aggregated value for section D is the value 5.

Next, the sections are then combined. But to combine them, each of the higher sections needs to be adjusted, or scaled, sufficiently—by multiplying the value by the proper power-of-ten value—that will then allow the section values to be added together to arrive at the final aggregated total to return to the caller.

The value in Section D needs no further adjusting, but the fact that there is just one valid digit is the key used to determine the index into tables containing the values used to scale, or adjust, the other section totals. So, since there is only one digit in section D, it could be combined with the total of section C if the section C total is first multiplied by the value 1.0e01 (or 10). The total of section B can be combined with C and D if it is scaled sufficiently to make room for the five digits below it, and this is accomplished by multiplying it by 1.0e05 (or 100,000). And the total of section A can be combined with the others if it is multiplied by 1.0e09 (or 1,000,000,000). If there were two valid digits in section D, the values used to scale the other sections would be scaled up by one order of magnitude; and the pattern continues for three and for four valid digits. The proper values used are listed in the .TensAccumHi, .TensAccumMid, and .TensAccumLo tables.

32-bit accumulators can easily hold the value of a string of 8 valid digits. Any time there are at least 8 digits, processing can be simplified (and therefore sped up) by multiplying the first four characters by power-of-ten values that are already scaled by the value 1.0e4. The following explanation shows in detail how to use this algorithm to convert a base-10 numeric string into a 64-bit unsigned integer.

For each numeric string, the number of valid digits is first determined, then control branches to a section that processes the characters based on the number of digits found. Each such section converts the valid characters into 32-bit integers which are then multiplied by the proper power of 10 such that the values can then be added together. When multiple accumulators are used, values can be scaled as the accumulators are aggregated, resulting in a final 64-bit value that is returned to the caller.

An initial FASM-based 64-bit implementation is as follows, with details for each part of the process interspersed between the sections of code below:

;;;;;;;;;;;;;;;;;;;;;;;;;;;;;;;;;;;;;;;;;;;;;;;;
; _u64 Atoi_Mult(char *Str);
; Using SIMD regs, convert decimal string to _u64 using
multiplication
; of 4 (with xmm regs) or 8 (with ymm regs) digits at a time
; Speed could increase 50% when using ymm regs
;
proc Atoi_Mult Str

; Assume there is no whitespace, that first char is

valid digit (or halt char)

| ; Use offset to determine how to load SIMD regs... | |
|---|---|
| mov r8, rex | |
| and r8, 15 | ; r8 is index into jmp tbl |
| jz .isAligned | ; aligned, so do fast mode |

only!

; not aligned, so jmp to proper path to load xmm0 (and

xmm1, if more than 15 chars found in xmm0)...

jmp [.contJmp+r8*8−8]
; first entry is for alignment=1, so back off one entry

This is a 64-bit implementation; upon entry, rcx is a pointer to the string to be converted. The r8 register is used to determine the alignment of the string; if aligned on 16-byte boundaries, control quickly branches to the section that deals with aligned strings. Otherwise, control will jump to the section of code that will deal in a fast way with the unaligned strings. The table .contJmp contains the target jump addresses that manage the various offsets for unaligned strings.

rept 15 n:1 {
.cont#n#:

| ; load first 16 bytes... | |
|---|---|
| movdqa xmm1, xword [rcx−n] | |
| movdqa xmm0, xword [rcx+16−n] | |
| palignr xmm0, xmm1, n | |
| ; now, see if all is valid | |
| movdqa xmm2, xmm0 | ; preserve original bytes |

so we don't have to reload

| ; Data to be loaded in 2 xmm regs | |
|---|---|
| psubb xmm2, [.floor] | |
| pcmpgtb xmm2, [.cmpgtb] | ; identify valid |

bytes

| pmovmskb r11, xmm2 | |
|---|---|
| bsf r11, r11 | ; r11 is count |
| jz @f | ; first 16 valid, so continue |

| | |
|---|---|
| jmp [.finishTbl+r11*8] | ; fewer than 16 bytes, so |

finish up
@@:

; need to read next block...
movdqa xmm2, xword [rcx−n+16]
movdqa xmm1, xword [rcx+16−n+16]
palignr xmm1, xmm2, n
jmp .contSecondBlock

}

When the numeric string is not aligned, control will jump to a code path that deals with the specific offset; the above FASM instructions create 15 sections of code that create target addresses and handle each of the 15 possible unaligned offsets. Two aligned consecutive blocks are read (the unaligned string is contained within these two blocks) and the first 16 bytes of the numeric string become available in xmm0 after the (V)PALIGNR instruction; xmm0 is copied to xmm2, and xmm2 is then tested as follows. The value 0xb0 is subtracted from each byte, effectively pushing all valid digits to the floor of the signed-byte range. Each byte is then compared to see if it is greater than the value 0x89; if so, it is invalid, otherwise it is a valid digit. This creates a byte mask of all clear bits for each byte that represents a valid digit, and all set bits for all invalid digits.

The byte mask is then moved to the r11 register as a bit mask, and the position of the first byte is determined via the BSF instruction. If at least one bit is set, r11 will contain the number of valid bytes, and control will then branch based on the count in r11 being used to index the .finishTbl table; the count will be a value in the range of 0 to 15. If all bits of r11 are clear, the zero flag is set (meaning all 16 bytes are valid); in this case, control skips to the code that loads the next 16 bytes via two (V)MOVDQA instructions followed by the (V)PALIGNR instruction. Control then branches to .contSecondBlock where the data in xmm1 is processed.

align 16
.isAligned:

| ; data is 16-byte aligned... load max of two blocks | |
|---|---|
| ; Push all byte values to floor, then find all > 0x71 | |
| movdqa xmm0, xword [rcx] | |
| movdqa xmm2, xmm0 | ; preserve original bytes |

so we don't have to reload

| ; Data to be loaded in 2 xmm regs | |
|---|---|
| psubb xmm2, [.floor] | |
| pcmpgtb xmm2, [.cmpgtb] | ; identify valid |

bytes

| pmovmskb r11, xmm2 | |
|---|---|
| bsf r11, r11 | ; r11 is count |
| jz @f | ; first 16 valid, so continue |

| | |
|---|---|
| jmp [.finishTbl+r11*8] | ; fewer than 16 bytes, so |

finish up

| | |
|---|---|
| @@: | ; need to read next block... |
| | movdqa xmm1, xword [rcx+16] |

.contSecondBlock:

| | |
|---|---|
| movdqa xmm2, xmm1 | ; preserve original bytes |

so we don't have to reload

| psubb xmm2, [.floor] | |
|---|---|
| pcmpgtb xmm2, [.cmpgtb] | ; identify valid |

bytes

| pmovmskb r11, xmm2 | |
|---|---|
| bsf r11, r11 | ; r11 is count |
| jz .overflow | ; 32 is too many, so show overflow |

| | |
|---|---|
| add r11, 16 | ; add the previous valid bytes |

jmp [.finishTbl+r11*8]

When the numeric string is aligned, the first 16 data bytes can be loaded from memory via a single (V)MOVDQA instruction. These bytes are then processed the same as is done when the string is unaligned, with xmm2 containing a copy of xmm0. If not all bytes in the first batch are valid, control will then branch based on the count being used to index the .finishTbl table. If all bytes in the first batch are valid, the second batch of 16 bytes is loaded and then processed in the same way, with the original bytes being kept in xmm1. If an unaligned string is processed and it is determined the first 16 bytes are all valid, control will eventually flow to join the above code at the .contSecondBlock label.

Then, if all bits are cleared when the bit mask is tested via the BSF instruction after it is moved into r11, that means there are at least 32 valid digits—and since the maximum allowed when calculating a 64-bit result is 20 digits, the string value overflowed and the code branches to the .overflow path. Otherwise, r11 will be in the range 0 to 15; and since there were 16 valid digits in the first group, the value 16 is added to r11 so that r11 is the proper count of valid digits. The count is then used to branch to the section of code that processes that number of valid digits; due to the way in which the .finishTbl table is created (see below), any time count is greater than 20, code will branch to .overflow to handle the overflow.

.finish0:

; value is 0, so return 0
xor rax, rax
ret

.finish1:
.finish2:
.finish3:
.finish4:

| ; 1 block to process, very easy... | |
|---|---|
| psubb xmm0, [.ZeroChar] | |
| pmovzxbd xmm1, xmm0 | ; grab original 4 bytes |

| ; Now, multiply each of the above... | |
|---|---|
| ; get index for last block... | |
| movzx r8d, [.TensRemainderIndex+r11−1] | |
| movdqu xmm0, [.Tens+r8d*4] | ; load dwords to multiply |

by

pmulld xmm1, xmm0
; add up values
phaddd xmm1, xmm1
phaddd xmm1, xmm1
movd eax, xmm1
ret

When there are no valid digits, rax is set to 0 and control returns to the caller. Otherwise, when the count is from 1 to 4, the processing is the similar and is handled as follows; assume for this example that the numeric string “123” is being processed. After the (V)PSUBB instruction (which subtracts the value 0x30 from each byte to force each digit into the range 0 to 9), xmm0 will look like the following:

offset: 15 12 8 4 0
xmm0: xx.xx.xx.xx.xx.xx.xx.xx.xx.xx.xx.xx.xx.03.02.01

The values other than the lower three bytes can be ignored, and are denoted by xx. It is important to note that, as depicted herein, the values are loaded into the CPU registers in Little-Endian order; the skilled implementer would realize the order would be swapped for Big-Endian CPUs, and such a person of skill would adapt the algorithm appropriately for Big-Endian CPUs by a combination of swapping the bytes and/or rearranging the order of entries in the .Tens table and/or using the (V)PSHUFB instruction each time several bytes are being prepared to be multiplied.

The (V)PMOVZXBD instruction is used to convert the 4 lower bytes into 32-bit dword integers, preparatory to multiplying them by values from the .Tens table; (V)PSHUFB could be used to shuffle the bytes into proper position instead, if desired. After this instruction, xmm1 looks like this (shown as four 32-bit dwords):

| | | | | |
|---|---|---|---|---|
| dword offset: | 3 | 2 | 1 | 0 |
| xmm1: | xxxxxxxx. | 3. | 2. | 1 |

The upper 32 bits (in this example there are only three valid digits, not four) do not matter; due to the MULTIPLY instruction, any extra bytes due to invalid digits will be converted to the value 0, which when aggregated with the other valid entries will cause no harm. The core of this algorithm depends on accessing the correct values from the .Tens table, and then multiplying those values against the dwords in xmm1. The four products are then added together, with the result being the converted value of the numeric string.

The .Tens table (which is unique to this algorithm, and should not be confused with the TensTbl table used by other algorithms) consists of 32-bit entries, each of which can handle values up to 9 digits; therefore, it can be used for up to 8 digits that need to be multiplied for ymm registers, or 4 for xmm registers, and the results of two xmm registers can be merged when the proper values are loaded from the .Tens table. The combination of using the offset pulled from the .TensRemainderindex table, indexed by the count of valid digits minus one, allows the proper offset of the .Tens table to be accessed. The .Tens table consists of twelve 32-bit integers, each a multiple of 10. The first value is 10,000,000 and each subsequent value is 1/10 the previous. This results in 8 entries greater than 0, followed by 4 entries equal to 0 (see below for the list of value for .Tens). The .TensRemainderindex table is used to obtain an adjusted index into the .Tens table; it consists of the byte values 7, 6, 5, and 4.

In the present example for the three-digit string “123”, it is known that the ‘1’ is in the hundreds place, the ‘2’ is in the tens place, and the ‘3’ is in the ones place. Therefore, we want to multiply the value at dword 0 of xmm1 by 100, the value at dword 1 by 10, the value at dword 2 by 1, and the value at dword 3 by 0 (to eliminate all erroneous bytes for that dword since it is known there is not a fourth valid digit). This can be done by loading the four consecutive entries of the .Tens table that start with the fifth entry of .Tens; and this is done by using the count (which is in the r11 register, and adjusted by 1) to load the r8d register with the proper index from the .TensRemainderindex table with the movzx instruction above. In other words, r8d=.TensRemainderIndex[r11-1]. So in this case, after xmm0 is loaded with the proper values from the .Tens table, the two registers look like this:

| | | | | |
|---|---|---|---|---|
| dword offset: | 3 | 2 | 1 | 0 |
| xmm1: | xxxxxxxx. | 3. | 2. | 1 |
| xmm0: | 0. | 1. | 10. | 100 |

The two registers are multiplied against each other with the result stored in xmm1, which will then have these values:

| | | | | |
|---|---|---|---|---|
| dword offset: | 3 | 2 | 1 | 0 |
| xmm1: | 0. | 3. | 20. | 100 |

After the two (V)PHADDD instructions, the result is this:

| | | | | |
|---|---|---|---|---|
| dword offset: | 3 | 2 | 1 | 0 |
| xmm1: | 123. | 123. | 123. | 123. |

It does not matter that the total is replicated in all four 32-bit dword elements of the xmm1 register (that is an artifact of how the (V)PHADD instruction works); the value from the low dword of xmm1 is then transferred to eax, which provides the proper return value in rax (the upper bits are automatically zeroed when eax is modified by the MOVD instruction).

If there were four valid digits, the values starting at entry 4 of the .Tens table would have loaded; this algorithm adjusts based on the count. But for each block below, the offset used to adjust the count is increased by 4 more than for the previous block-processing section in order to adjust the range so that the proper value from the four entries of the .TensRemainderindex table is loaded.

| .finish5: | | |
|---|---|---|
| .finish6: | | |
| .finish7: | | |
| .finish8: | | |
| ; 2 blocks to process | | |
| psubb | xmm0, [.ZeroChar] | |
| pmovzxbd | xmm2, xmm0 | ; grab original 4 bytes |
| psrldq | xmm0, 4 | ; prepare for next |
| pmovzxbd | xmm3, xmm0 | |

| ; xmm2 is first 4 digits, xmm3 is remaining... | |
|---|---|
| ; scale each block according to number of valid digits | |
| in last block | |
| movzx | r8d, [.TensRemainderIndex+r11−5] |
| movdqu | xmm0, [.Tens+r8d*4−4*4] |
| pmulld | xmm2, xmm0 |
| movdqu | xmm0, [.Tens+r8d*4] |
| pmulld | xmm3, xmm0 |
| ; combine blocks | |
| paddd | xmm2, xmm3 |
| ; and combine totals | |
| phaddd | xmm2, xmm2 |
| phaddd | xmm2, xmm2 |
| movd | eax, xmm2 |
| ret | |

For this block above with the count ranging from 5 to 8, two four-digit blocks are processed. Assume in this case the numeric string “87654321” is to be converted; the count (in r11) would be equal to 8. The characters are first adjusted by (V)PSUBB and xmm2 receives the first four digits which are converted into dword values. The next four digits are shifted down in xmm0, and moved into xmm3 as dword values. At this point, the key registers would look like this:

| | | | | |
|---|---|---|---|---|
| dword offset: | 3 | 2 | 1 | 0 |
| xmm2: | 5. | 6. | 7. | 8 |
| xmm3: | 1. | 2. | 3. | 4 |

The r8d register is loaded with the proper index from .TensRemainderindex (adjusted by 5 to keep the range proper). The value loaded from .TensRemainderindex would be equal to .TensRemainderIndex[r11-5]=4. Since we are using two blocks, and the first block has the higher-order values, the values of the .Tens table to load are four entries prior to this, so the values starting at .Tens[4−4=0] are loaded into xmm0 which is then multiplied against xmm2; xmm0 is then reloaded with the values starting at .Tens[4] and then multiplied against xmm3. After these two vector multiplications, the registers look like this:

| | | | |
|---|---|---|---|
| dword offset: | 3 | 2 | 1 0 |
| xmm2: | 50000. | 600000. | 7000000.80000000 |
| xmm3: | 1. | 20. | 300. 4000 |

After xmm3 is added to xmm2, xmm2 looks like this:

| | | | |
|---|---|---|---|
| dword offset: | 3 | 2 | 1 0 |
| xmm2: | 50001. | 600020. | 7000300.80004000 |

And after the two horizontal-add operations, xmm2 looks like this:

| | |
|---|---|
| dword offset: | 3 2 1 0 |
| xmm2: | 87654321.87654321.87654321.87654321 |

When the value from the low dword of xmm2 is loaded into eax, the process is complete and the calculated value of 87,654,321 is returned to the caller.

Processing for the remaining sections is similar to the above, with the goal being to reduce the total number of MULTIPLY and ADD instructions. In this next section, three blocks are used; and since it is known there are at least 9 valid digits, the first 8 valid digits can be loaded into the first two blocks and combined without using the .TensReaminderIndex table; but that table is needed when adjusting the third block. This section shows how that is done:

.finish9:
.finish10:
.finish11:
.finish12:

| ; 3 blocks to process | |
|---|---|
| psubb | xmm0, [.ZeroChar] |
| pmovzxbd | xmm2, xmm0 ; grab original 4 bytes |
| psrldq | xmm0, 4 ; prepare for next |
| pmovzxbd | xmm3, xmm0 |
| psrldq | xmm0, 4 |
| pmovzxbd | xmm4, xmm0 |
| ; Now, multiply first two blocks, and combine... | |
| pmulld | xmm2, [.Tens] |
| pmulld | xmm3, [.Tens+4*4] |
| ; combine pairs of blocks | |
| paddd | xmm2, xmm3 |
| ; and combine totals | |
| phaddd | xmm2, xmm2 |
| phaddd | xmm2, xmm2 |

; At this point, accumulator xmm2:0 has first 8 digits

combined, accumulator xmm4 has remaining 1 to 4 digits

; To combine them, we need to know how many digits are

in the last block.

| ; get index for xmm4... | |
|---|---|
| movzx | r8d, [.TensRemainderIndex+r11−9] |

| | |
|---|---|
| movdqu | xmm0, [.Tens+r8d*4] ; load dwords to multiply |

by

| pmulld | xmm4, xmm0 |
|---|---|
| ; add up values | |
| phaddd | xmm4, xmm4 |
| phaddd | xmm4, xmm4 |
| movd | r8d, xmm4 |
| ; scale xmm2... | |
| movd | eax, xmm2 ; mid accumulator |

mul [.TensAccumLo+r11*8−9*8] ; rax is new accumulator
add rax, r8 ; mid and lo accumulators are combined

into rax

ret

The xmm2 and xmm3 registers are loaded with the 8 highest-order digits, and multiplied by the respective values from .Tens starting at .Tens[0] for the first block, and at .Tens[4] for the second. The values are combined as shown above, with the low dword of xmm2 containing the combined value of those first 8 digits; but this value will need to be shifted when it is combined with the value of the third block.

The value of the third block is calculated similar to the way the calculation is performed if there is only one block above (when the number of valid digits is from 1 to 4; but the index is adjusted by 9 entries instead of 1 when accessing .TensRemainderindex and .TensAccumLo), and its aggregated value is then moved into the r8 register (moving to r8d clears the high bits of r8). Then, the value of the third block is combined with the value of the first two. To do this, the value of the first two (currently in xmm2) is moved to the eax register (which clears the high bits of rax; rax and eax are now equal) and then multiplied by the proper value from the .TensAccumLo table. If there are 9 total digits, the value in rax is multiplied by 10; if there are 10, rax is multiplied by 100; if 11, rax is multiplied by 1,000; and if there are 12 digits, the value in rax if multiplied by 10,000; these multipliers are stored in the .TensAccumLo table. The proper value is indexed by the value equal to 9 less than the count, or by the entry at .TensAccumLo[r11-9]. After multiplying rax by the proper value, r8 is added to rax, which now has the proper value that is returned to the caller.

The next section shows how four blocks are processed when the count ranges from 13 to 16 valid digits.

.finish13:
.finish14:
.finish15:
.finish16:

| ; 4 blocks to process | |
|---|---|
| psubb | xmm0, [.ZeroChar] |
| pmovzxbd | xmm2, xmm0 ; grab original 4 bytes |
| psrldq | xmm0, 4 ; prepare for next |
| pmovzxbd | xmm3, xmm0 |
| psrldq | xmm0, 4 |
| pmovzxbd | xmm4, xmm0 |
| psrldq | xmm0, 4 |
| pmovzxbd | xmm5, xmm0 |
| ; Now, multiply first two blocks and combine... | |
| pmulld | xmm2, [.Tens] |
| pmulld | xmm3, [.Tens+4*4] |
| paddd | xmm2, xmm3 |
| phaddd | xmm2, xmm2 |
| phaddd | xmm2, xmm2 |
| movd eax, | xmm2 ; rax is accumulator for first two |

blocks

; now scale eax to combine with remaining blocks

below...

mul [.TensAccumMid+r11*8−13*8] ; rax is new

accumulator
; 3rd & 4th blocks need special care, based on # digits in
last block

| | |
|---|---|
| movzx | r8d, [.TensRemainderIndex+r11−13] |
| movdqu | xmm0, [.Tens+r8d*4−4*4] ; load dwords to |

multiply by

| pmulld | xmm4, xmm0 |
|---|---|
| movdqu | xmm0, [.Tens+r8d*4] |
| pmulld | xmm5, xmm0 |
| ; now combine 3rd and 4th | |
| paddd | xmm4, xmm5 |
| phaddd | xmm4, xmm4 |
| phaddd | xmm4, xmm4 |
| movd r8d, | xmm4 |

; now, combine all accumulators and return
add rax, r8
ret

The first two blocks are combined in a manner similar to how the first two blocks are combined when the count ranges from 9 to 12 valid digits, and the total is moved into eax. The third and fourth are combined similarly to how the first two blocks are combined when there are 5 to 8 valid digits, but the value used to index .TensRemainderindex is offset by 13 entries. The aggregated total of the first two blocks is adjusted by a value from the .TensAccumMid table (which contains the proper power-of-tens values that will shift the total sufficiently to allow the next aggregated total to be combined with the adjusted value), offset by count-less-13 entries; the proper value is found at the index based on the count minus 13, or at .TensAccumMid[r11-13]. After multiplying rax by the value found at this index, the value from the second two blocks, which is moved into r8, is added to rax. The final result is returned to the caller.

The final section, below, is used when the count ranges from 17 to 20 valid digits:

.finish17:
.finish18:
.finish19:
.finish20:

| ; 5 blocks to process, could have overflow, so check | |
|---|---|
| ; Process first 4 blocks... | |
| psubb | xmm0, [.ZeroChar] |
| pmovzxbd | xmm2, xmm0 ; grab original 4 bytes |
| psrldq | xmm0, 4 ; prepare for next |
| pmovzxbd | xmm3, xmm0 |
| psrldq | xmm0, 4 |
| pmovzxbd | xmm4, xmm0 |
| psrldq | xmm0, 4 |
| pmovzxbd | xmm5, xmm0 |
| ; Now, multiply each of the above... | |
| pmulld | xmm2, [.Tens] |
| pmulld | xmm3, [.Tens+4*4] |
| pmulld | xmm4, [.Tens] |
| pmulld | xmm5, [.Tens+4*4] |
| ; combine pairs of blocks | |
| paddd | xmm2, xmm3 |
| paddd | xmm4, xmm5 |
| ; and combine totals | |
| phaddd | xmm2, xmm2 |
| phaddd | xmm4, xmm4 |
| phaddd | xmm2, xmm2 |
| phaddd | xmm4, xmm4 |

; At this point, accumulator xmm2:0 has first 8 digits,

accumulator xmm4:0 has next 8 digits
; To combine, we need to know how many digits are in the
last block.
; - if one digit, mult xmm2 by 1.0e09, xmm4 by 1.0e01, and
xmm5 by

| ; process 5th block, then combine with xmm2 and xmm4 | |
|---|---|
| psubb | xmm1, [.ZeroChar] ; prepare bytes before |

distributing

| pmovzxbd | xmm1, xmm1 |
|---|---|
| ; get index for xmm5... | |
| movzx | r8d, [.TensRemainderIndex+r11−17] |
| movdqu | xmm0, [.Tens+r8d*4] ; load dwords to multiply |

by

| pmulld | xmm1, xmm0 | |
|---|---|---|
| ; add up values | | |
| phaddd | xmm1, xmm1 | |
| phaddd | xmm1, xmm1 | |
| ; scale xmm4... | | |
| movd eax, | xmm4 | ; mid accumulator |
| movd r8d, | xmm1 | ; lo accumulator |

mul [.TensAccumLo+r11*8−17*8] ; rax is new accumulator
add r8, rax ; mid and lo accumulators are

combined into r8

| ; now, process hi accumulator | |
|---|---|
| movd eax, | xmm2 |

mul [.TensAccumHi+r11*8−17*8]
jo .overflow
add rax, r8
jo .overflow
; got it, so return!
ret

The first and second blocks are combined, and the third and fourth combined, each block having 4 valid digits. Note that at the start of this section, xmm0 has the first 16 valid digits, and xmm1 has the remaining 1 to 4 valid digits. Since xmm0 is full, the first four blocks are full, and processing is straightforward; each batch (the first and second blocks combined, and the third and fourth blocks combined) is processed similar to how the first two sections are processed when there are 9 to 12 valid digits; the aggregated totals are then in xmm2 and xmm4. The fifth block is processed in a manner similar to how the block is processed when there are 1 to 4 valid digits, except that the .TensRemainderindex entry is offset by 17 instead of by 1.

At this point, there are three accumulators: xmm2 has the highest-order values, xmm4 has the mid-level values, and xmm1 has the lowest-order values; xmm1 is already adjusted, and will be combined with the others. So, the value from xmm1 is moved into r8d. The middle accumulator from xmm4 is moved into eax, and is adjusted by multiplying it by the proper value found at .TensAccumLo[r11-17]. The value from rax is then added to r8 (which preserves the aggregated total and frees up rax for the next MULTIPLY instruction) to combine the mid and low accumulators. The value from xmm2, the high accumulator, is adjusted by multiplying it by the value found at .TensAccumHi[r11-17]; that shifts it sufficiently to combine with the value from the other accumulators (this high value is now in rax). But if the numeric string is invalid, it is possible that the MULTIPLY operation overflowed; this is checked, and control branches on overflow. Otherwise, r8 is added to rax and overflow again checked and handled. If there is no overflow, the value in rax is returned to the caller.

.overflow:

mov rax, −1
ret

When the numeric string overflows, the value −1 is returned to the caller (this is interpreted as being the highest possible value for an unsigned value). If desired, signed overflows can also be detected and handled, and the number can be negated if the numeric string is negative, using methods described elsewhere in the present disclosure.

The following tables are used to adjust the accumulated values as described above:

align 8
label .Tens dqword

dd 10′000′000, 1′000′000, 100′000, 10′000
dd 1′000, 100, 10, 1
dd 0, 0, 0, 0

| | |
|---|---|
| align 8 | |
| label .TensAccumLo qword | ; 64-bit entries |

dq 10, 100, 1′000, 10′000

| | |
|---|---|
| label .TensAccumMid qword | ; 64-bit entries |

dq 100′000, 1′000′000, 10′000′000, 100′000′000

| | |
|---|---|
| label .TensAccumHi qword | ; 64-bit entries |

dq 1′000′000′000, 10′000′000′000
dq 100′000′000′000, 1′000′000′000′000

label .TensRemainderIndex byte

db 7, 6, 5, 4

label .TensRemainderIndex byte

db 7, 6, 5, 4

The following is a jump table, created by a FASM macro, that is used to branch to the correct address depending on the number of valid digits found; note that the address for each value that is GTE 21 is equal to .overflow.

```
align 8
label .finishTbl qword
; Distance, in bytes, between various offsets
; First table here handles when < 16 valid digits
    rept 32 n:0 {
      if n < 21
    dq .finish#n
      else ; when n GTE 21
    dq .overflow
      end if
    }
```

This macro creates the jump table used to branch based on the alignment of the string to convert:

```
align 8
label .contJmp qword
    rept 15 n {
      dq .cont#n
    }
```

The following data is used to adjust the data bytes as described above:

```
align 16
label.ZeroChar dqword
    times 16 db ‘0’
align 16
label .floor dqword
    times 16 db ‘0’ + 128
label .cmpgtb dqword
    times 16 db −128+9
endp
```

If desired, a separate code path can be used to handle the cases where the number of digits is exactly divisible by 4. In these cases, since the count is known due to the jump ending up at each respective target address, and there is no section with a variable number of digits, neither the count nor the .TensRemainderindex tables would be needed; the code could be slightly simplified and sped up for these cases.

This method can also be adapted by one of skill to handle base-8 numeric strings, and/or strings representing other bases. To do so, a table of different multipliers based on powers of 8 (or powers based on the target base being converted) would be created, and the other tables and elements of the algorithm would also be adjusted to reflect different multipliers and possibly a different number of total possible sections and accumulators to process.

Atou64_Exact

To convert floating-point strings into integers, at some point a function is needed that will convert an exact number of valid digits starting at a specific position in a numeric string. The Atou64_Exact function does this, and has a prototype similar to the following:

_u64 Atou64 Exact(char *str, int len);

Its parameters are a pointer to the first valid digit of a string whose digits are all known to be valid, and a length telling the number of digits to process. It does no filtering of any kind, does not convert the number to negative, and does not update any pointer and does not attempt to identify overflow. It is lean and mean.

This function can be created by taking one of the decimal-based conversion algorithms described in the present disclosure. Then, the filtering and scanning processes at the start are stripped out, along with any extra processing at the end (other than aggregating multiple accumulators, if used). As soon as the last digit's value has been aggregated with the rest, the function returns the result as an unsigned 64-bit integer; no adjustment is made for a sign or for updating any halt-char address.

Converting Floating-Point Numeric-Character Strings to Double

Floating-point strings include the digits ‘0’ through ‘9’ and a possible decimal point. In the U.S., for example, a period is used as the decimal point to separate a floating-point number between its whole portion to the left and its fractional portion to the right, and a comma can be used to separate thousands groups left of the period; other locales switch the use of these symbols, or use other symbols and/or other groupings. A period is not required unless the number has a fractional component in the string. The algorithms described in the present disclosure apply to the conversion of plain-number strings into floating-point double numbers.

Formatted numeric strings may be converted into binary numbers by filtering out such formatting characters while copying the valid digits to a separate buffer 218; the output will be a plain-number string which can then be processed by the fast methods described in the present disclosure. One of skill can create a program that can optionally determine whether the formatted number is valid depending on the formatting rules of the selected locale. During this process, leading whitespace and leading zeroes can be skipped as the valid digits are copied to a separate buffer; a minus sign, if found, can be placed as the first character of the output string. At the end of this process, the plain string created will have a null character, or some other character that is not a valid digit or decimal point, to identify the end of the string; optionally, a length can be provided to help determine where the string ends, and/or the length of each of the whole and fractional parts.

A plain-number floating-point string can have a whole part and a fractional part. If there is no decimal point, all the valid digits comprise the whole part; the fractional part is equal to 0. If there are no non-zero numbers to the left of the decimal point, all the valid digits comprise the fractional part; the whole part is equal to 0. The process now to be described identifies the whole and fractional part of the plain string, details how to convert each into a separate 64-bit signed integer, and then combines the two as described below.

Converting plain strings poses a special problem when either the whole part or the fractional part has more than 18 significant digits. Numeric strings created by the industry-standard printf-family of functions (available in C and C++function libraries) can create valid strings, for example, with 309 digits to the left of the decimal and 512 digits to the right.

Valid signed 64-bit integers range from −9,223,372,036,854,775,808 to 9,223,372,036,854,775,807. Although they can have a maximum of 19 decimal digits, some combinations of 19 digits cause numeric overflow when converted to integer. For example, any 19-digit number where the left-most digit is ‘9’ and the next digit is ‘3’ or higher will overflow no matter the value of the other digits. This potential problem can be detected, and it exists whenever a plain number string has more than 18 digits.

For example, consider the plain string “9223372036000000000000000000.0”. This number is valid, equal to 9. 223372036e027. If each digit is to be first scanned and compared against those of the maximum 64-bit signed value, it would not be known until all of the first 11 digits were compared whether the number was valid. Now, consider the string “92233720360.0”, equal to 9. 223372036e010. One can visually determine that because it has only 11 digits—even though the first 10 exactly match those of the maximum value—it is valid and would not overflow. To resolve this problem, a method that considers length is used.

Although floating-point double numbers can have very large values, the actual precision is limited to about 17 significant digits. Allowing one more can in some cases result in a more accurate conversion. Therefore, a maximum limit of 18 significant digits will be converted, and all other digits to the right are ignored. Setting MAX_DIGITS=18 solves the problem, as shown below, by restricting the maximum number of digit characters to convert (if all digits were converted when there are more than 18, the converted value could overflow; at some point, the number of digits to convert is truncated to achieve a proper result). This applies when converting either the whole part or the fractional part, as further described below.

Note that in cases where a higher-precision double is to be created, additional digits can be allowed; in such cases, it can be useful to convert the string to a higher-bit integer, such as an 80- or 128-bit integer. A skilled implementer could modify the algorithms herein described by using an additional accumulator to handle the extra bits, or by using wider accumulators if such can be efficiently utilized by the CPU.

In the following description, unless otherwise stated, integers are assumed to be 32 bits wide. The following plain string is to be converted:

| Number: | “−00543210987654000000000000.0003456” | |
|---|---|---|
| Position: | B W | Z D F E |

The letters on the “Position” line above identify the following parts:

| | |
|---|---|
| B --> | the beginning of the plain string (the minus sign) |
| W --> | first sig. digit of whole part |
| Z --> | start of zeroes not converted |
| D --> | decimal point |
| F --> | first sig. digit of fractional part |
| E --> | end of plain string |

There are three main processes when converting to floating point: the whole-part process, the fractional-part process, and the combining process.

Whole-part process. To start, the beginning and end of the whole part are identified. As part of this process, several variables are updated: WholePart is a 64-bit integer representing the significant portion of the number; LenW is an integer that tells the number of digits of WholePart to be converted; and ExpW is an integer representing the exponent of the number.

The beginning of the string is either a sign character (‘+’ or ‘−’) or a valid digit (‘0’-‘9’), whichever is found first (it is assumed that all whitespace characters have been skipped over to find the start of the plain string). The end is identified by the decimal point or by the first non-digit character, whichever is found first. If the first character is a sign character, it is noted (a variable Sign can be set to −1 if it's negative, or 0 otherwise) and then that character is skipped. In the example above, the first character (at position B) is a minus sign; Sign is set to −1 and that character is now skipped.

If the next character is ‘0’, it is skipped, and all subsequent leading ‘0’ characters are also skipped until the first non-‘0’ character is found. If the first non-‘0’ character found is a valid digit, there is a whole part and processing continues. If it is not a valid digit (such as the decimal point, for example), there is no whole part to process; set LenW to 0 and start processing the fractional part as described below.

In the above example, the two leading zeroes are skipped; position W indicates the first significant digit of the whole part. See the section “Filtering Whitespace and Leading Zeroes” for a very fast method of determining position W and obtaining the sign of the number. Then, all characters are inspected until the first non-valid digit is found (i.e., any character from ‘0’ to ‘9’ is a valid digit, all other characters are invalid), which in this case is the decimal point found at position D. See the section “Finding End of Significant Digits” for a fast method to do this.

The difference between W and D is the number of digits in the whole part (there are 24 digits in the whole part; LenW is set to 24). Set ExpW also to this value; in the current example, ExpW is set to 24 (note that ExpW is actually one greater than the true exponent of the number, but this does not matter when these processing steps are followed). Note that if W and D are the same, the whole part is 0, so set LenW to 0 and skip to the Fractional-part step.

Since there are 24 characters in the whole part for this example, attempting to convert all of them will cause overflow; therefore LenW should be reduced. Position Z shows the end of 18 significant digits; the six digits from Z to D will be ignored. Since LenW is greater than MAX_DIGITS, it is reduced to MAX_DIGITS (its value is not modified when LenW is LTE MAX_DIGITS); for this example, then, LenW is set to 18. The 18 digits starting at W are converted into a 64-bit integer using the Atou64_Exact conversion algorithm described in the present disclosure; the result is stored in WholePart.

Fractional-part step. To continue, the fractional part is now processed. Several variables are updated: FracPart is a 64-bit integer representing the significant portion of the fractional part; LenF is an integer that tells the number of digits of FracPart to be converted; and ExpF is an integer representing the exponent of the fractional part of the number. If the first character is not a decimal point, or if there are no non-‘0’ digits in the fractional part, set LenF to 0 and skip to the combining step. Otherwise, the beginning and the end of the fractional part are now determined.

All leading ‘0’ characters immediately to the right of the decimal are identified and skipped over; as soon as a non-‘0’ digit is encountered, scanning pauses. In the above example, three ‘0’ characters are skipped; F marks the position of the first non-‘0’ character found; set the variable ExpF equal to the difference between F and D (this is also equal to the number of leading ‘0’ digits plus one); for the current example, ExpF is set to 4. If the character at ‘F’ is not a non-‘0’ digit, there is no fractional part; set LenF to 0, skip any further processing here and go to the combining step.

Next, scanning resumes and LenF is set to the number of digits from F to the end of the plain string (E), but is limited to MAX_DIGITS; for the above example, LenF is set to 4. In fact, as soon as MAX_DIGITS digits have been found, scanning can stop; all further digits can be ignored. Then, the number of digits specified by LenF (starting at position F), are converted into a 64-bit integer via the Atou64_Exact function, similarly to how WholePart is created; the result is stored in FracPart.

Combining step. At this point, the components of the plain string will be combined: LenW, WholePart, ExpW, Len F, FracPart, and ExpF will be processed to create the double floating-point variable ConvertedNum. The whole part and/or the fractional part may need to be scaled, as described below. If both LenW and LenF are 0, then set ConvertedNum to 0; processing is complete.

If LenW is 0, set ConvertedNum to 0, skip any more processing of the whole part, and continue with processing the fraction. Otherwise, set ConvertedNum equal to WholePart; this can be done via a cast-type expression or by loading the number into the FPU (or into an xmm register), as is known to those of skill in the art. Then, the number may need to be scaled. If ExpW is LTE MAX_DIGITS, skip this scaling step and continue with combining the fractional part. But if it is greater than MAX_DIGITS, ConvertedNum is scaled.

To scale the number, first set ScaleIndex equal to ExpW−MAX_DIGITS (if the value is less than one, skip this step and continue with combining the fractional part). ScaleIndex is now the index of a power-of-ten entry in the Doubles10 table which is multiplied against ConvertedNum; the offset is applied to the address Doubles10.One. In other words, set ConvertedNum equal to ConvertedNum×Doubles10.One[ScaleIndex].

Note that if ScaleIndex is greater than 308, the number may be too large to be properly converted; it may overflow, but it can still be scaled in multiple steps (and the FPU will indicate the number overflowed if, in fact, it did). If, for example, ScaleIndex is 310, this value is too large to use (it would access a value beyond the end of the Doubles10 table). But the effect can be achieved by first scaling with an index of 308, and by then scaling with an index of 2 (the difference). Note that other values can be used, such as indexes of 300 and 10, as long as they total to the original ScaleIndex.

The Doubles10 table is an array of floating-point double numbers, each occupying 8 bytes in memory; there are 618 entries in the table. The first entry is 0.0. The next entry is 1.0e-308. Each subsequent entry is equal to the previous entry×10, continuing until the last entry, which is 1.0e308. The address Doubles10.One is near the middle of the table, and is the address of the entry equal to 1.0, or 1.0e00; this is the “base” address used when scaling numbers as described herein.

The last part to be combined is the fractional part. If LenF is equal to 0, or if ExpF is so large that the number is so tiny it can't be distinguished from 0 (for 64-bit doubles, any value for ExpF greater than 324 means the fractional part is essentially 0; other limit values are used for other-sized floating-point formats), there is no fractional part; the process has completed, and ConvertedNum is the converted number. When LenF is not 0, set the floating-point double variable FracNum equal to FracPart; this converts FracPart to a double. FracNum is then scaled and added to ConvertedNum.

To scale FracNum, ScaleIndex is set equal to the sum of LenF+ExpF−1, which is then negated; in other words, for the above example, ScaleIndex is set to (0−(LenF+ExpF−1))=−7. FracNum is then multiplied by Doubles10.One[ScaleIndex], which is the same as multiplying FracNum by the value 1.0e-07. Consider that when FracNum, which is equal to 3456, is multiplied by 0.0000001, the decimal point will shift left seven places, resulting in the value 0.0003456. This value is then added to ConvertedNum, giving us the proper converted floating-point double value: ConvertedNum=ConvertedNum+FracNum.

If, when scaling FracNum, ScaleIndex is less than −308, FracNum will need to be scaled twice. Multiply FracNum by the value found at Doubles10.One[−308]. Then multiply FracNum again by Doubles10.One[ScaleIndex+308] to finish scaling FracNum. For example, if ExpF is equal to 321, this results in FracNum being multiplied first by Doubles10.One[−308] and then by Doubles10.One[−13], which results in the proper scaling for FracNum. Note that index values can be used, as long as they total the original value of ExpF.

Note that when processing floating-point numbers of other bit sizes, the maximum and minimum exponent values are changed to reflect the scale for the target format. Also, when either ConvertedNum or FracNum need to be scaled twice, other entries from the Doubles10 table can be used, provided that the indexes of the two aggregate to equal ScaleIndex.

Faster Strlen Function

There is a faster way to determine the size of a null-terminated string using SIMD registers. The following example can work in both 32-bit and 64-bit execution environments using xmm registers (assuming no string will be 2 GB or greater in length; if larger strings are also to be handled, 64-bit counters can be used in 64-bit execution environments). If desired and available, larger SIMD registers could be used instead of the 16-byte xmm registers. Note that the term ‘aligned’ is used in this section to refer to bytes that are aligned on a 16-byte boundary; this alignment would change to 32-byte boundaries if ymm registers are used. All the byte offsets between aligned boundaries are unaligned for purposes of SIMD registers.

There are several key features that make this unique. First, the code adapts very quickly to handling aligned data. Once the procedure stack frame is setup, the code quickly branches to the path that handles aligned data.

Second, a unique method is used to mask away the unwanted bytes that are loaded during the first load (which is done only when the data is unaligned). The unwanted bytes could include null bytes, or any other character. The algorithm uses the (V)CMPEQB instruction to identify the first null character by setting the bits in the destination register at the matching offset for any null byte found in the source register; it is important to ensure that no null byte is identified in those first unwanted bytes. The eax register, immediately after it is ANDed with the value _SIZE−1 (_SIZE is equal to 0x0f when using xmm registers), contains the number of unwanted bytes. But, since the unwanted bytes are at a lower address than the wanted bytes, a negative value is used to determine the position to load the mask (the value is offset from the address .zapBytesMid). The load mask is loaded into xmm1, and then ORed with xmm0; this ensures that none of the unwanted bytes have the value 0; and since eax (used as the counter) is equal to the negative of the number of unwanted bytes, then when the BSF instruction is used to find the first bit for a 0 in the first loaded bytes, that position is combined with the negative value in eax to obtain the true count. And if there is no null byte in the first bytes of the string, when control goes back to the aligned process and the value 16 is added to the count, the count is correct for the partial number of bytes processed in the first unaligned load.

For example, in the case where the offset to the string is at 0x12345, after ANDing the string's offset register with the value 0x0f, the first data will be loaded from offset 0x12340; the first 5 bytes are unwanted, and the next 11 bytes are the first bytes of the string whose length is being determined. The .zapUnwanted data section contains 15 bytes of −1 (all the bits are set; any value other than 0 will also work), followed by 15 bytes of 0 (no bits set). The portion of the mask used to update the unwanted bytes must contain at least one set bit for each unwanted byte so that, when the mask is ORed with the data, it will convert any 0 byte in the unwanted portion to a non-zero value; and since there are 16 bytes in the xmm register, and since all 16 bytes will be ORed with the target, the remainder bytes must be 0 so that they do not affect the loaded bytes that are the first bytes of the string being checked. Therefore, in this example, since 5 bytes are unwanted and 11 are wanted, loading from the .zapUnwanted area, starting at 5 bytes prior to the .zapUnwantedMiddle address, will load the proper mask into xmm1.

A third unique component is starting with a negative value for the counter. This helps with the .zapUnwanted mask as just explained, and also ensures that the counter is the proper value when a null is not found in the first loaded bytes of the string.

A fourth unique issue is that, in the unrolled version shown below, the core function uses only four fast instructions for most of the 16-byte chunks being tested, and only five for the last one in the unrolled loop (each of these sections can be shortened by one instruction by eliminating the (V)MOVDQA instruction and having the (V)CMPEQB instruction access memory directly instead; but on some CPUs, such as the inventor's Core2 Duo, that slows down execution slightly). And the code is designed such that if a null is found at the bottom of the unrolled loop, the code simply falls through to the section of code that determines the final position of the null within that last chunk and then adds it to the count, returning the correct size to the caller. When a null is found in any of the other chunks before the last, the code will branch to the final path that adjusts the count to make it proper before returning the size to the caller. Note that the (V)PTEST instruction is very fast, and eliminates the need for the combined (V)PMOVMSKB and BSF instructions from the inner loop until it is known that a terminating null is found, and the inner loop is then exited.

The skilled implementer can expand or reduce the unrolling of the inner loop, as desired, following the pattern shown in the code below. This algorithm can be adapted to handle any multiple of 16 bytes, depending on the type of SIMD register used; the larger the size of the SIMD register used, the faster the process executes. Here is an example written with FASM code that is currently implemented to use xmm registers:

;;;;;;;;;;;;;;;;;;;;;;;;;;;;;;;;;;;;;;;;;;;;;
align 16
proc ngStrlen Str
; Unroll this any number of times (shows one way to do it)

| | | |
|---|---|---|
| _LOOPS | equ 4 | ; # loops to unroll |

| | | |
|---|---|---|
| _REG0 | equ xmm0 | ; SIMD reg to use |
| _REG1 | equ xmm1 | ; SIMD reg to use |
| _REG2 | equ xmm2 | ; SIMD reg to use for (V)PTEST |

| | | |
|---|---|---|
| _SIZE | equ 16 | ; size of reg (# bytes) |

| | |
|---|---|
| _PCMPEQB equ pcmpeqb | ; (V)PCMPEQB compare |
| instruction | |
| _PMOVMSK equ pmovmskb | ; (V)PMOVMSKB mask |
| | instruction |

| | | |
|---|---|---|
| _PTEST | equ ptest | ; (V)PTEST instruction |
| mov | eax, ecx | |
| and | eax, _SIZE−1 | ; eax is # bytes to skip above the |

lower 16-byte boundary

| | | |
|---|---|---|
| neg | eax | ; make negative |

| | |
|---|---|
| movdqa | _REG2, [.ptest] |

| | |
|---|---|
| jz | .doAligned |

```
    ; not aligned, so adjust
    ; load unaligned data, plus leading unwanted bytes
```

| | |
|---|---|
| movdqa | _REG0, xword [ecx+eax] |

; load unwanted-bytes mask in _REG1, then OR unwanted
bytes so none are 0

| | |
|---|---|
| movdqu | _REG1, [.zapUnwantedMiddle+eax] ; load at |
| proper offset! | |

| | | |
|---|---|---|
| por | _REG0, _REG1 | ; make sure garbage bytes are |
| non-zero! | | |
| pxor | _REG1, _REG1 | ; zap, clear to all zeroes |

| | |
|---|---|
| pcmpeqb | _REG1, _REG0 |
| ptest | _REG1, _REG2 |

| | |
|---|---|
| jz | .aligned |

```
    ; Fewer than 16 bytes, so return count to caller
    pmovmskb ecx, _REG1
```

| | |
|---|---|
| bsf | ecx, ecx |
| add | eax, ecx |
| ret | |

; adjust so main loop below is aligned
;.alignedOfs = rva (.aligned−$$) and 15
;times (16 − .alignedOfs) db 1
times 16 − (($ + rva .aligned − .doAligned) and 15) nop
.doAligned:

| | |
|---|---|
| pxor _REG1, _REG1 | ; zap, clear to all zeroes |
| sub | eax, _SIZE |
| .aligned: | |
| rept _LOOPS n:1 { | |
| if n < _LOOPS | |

; only 4 instructions to find a null in any chunk

| | |
|---|---|
| movdqa | xmm0, [eax+ecx+n*_SIZE] |

_PCMPEQB _REG1, _REG0

| | |
|---|---|
| _PTEST | _REG1, _REG2 |

| | |
|---|---|
| jnz | .d#n |

else

. . . and only 5 instructions in the last one (that loops back when null still not found)

| | |
|---|---|
| movdqa | xmm0, [eax+ecx+n*_SIZE] |

| | |
|---|---|
| add | eax, n*_SIZE |

_PCMPEQB _REG1, _REG0

| | |
|---|---|
| _PTEST | _REG1, _REG2 |

| | |
|---|---|
| jz | .aligned |

```
    end if
  }
  ; Come here when loop exits at bottom
  _PMOVMSK edx, _REG1
```

| | | |
|---|---|---|
| bsf | edx, edx | |
| add | eax, edx | ; eax is the length! |

```
    ret
    rept _LOOPS−1 n:1 {
.d#n#:
    ; Come here when loop exits before bottom
    _PMOVMSK edx, _REG1
```

| | | |
|---|---|---|
| bsf | edx, edx | |
| lea | eax, [eax+edx+n*_SIZE] | ; eax is the length! |

```
    ret
    }
align 32
label .zapUnwanted xword
    times 15 db −1
.zapUnwantedMiddle:
    times 16 db 0
align 16
label .ptest dqword
```

| | |
|---|---|
| times 16 db 0x80 | ; used to test hi bits of |

comparison (any byte works, other than 0)
restore _LOOPS, _REG, _SIZE, _PCMPEQB, _PMOVMSK, _PTEST
endp

Improvement to Sprintf-type Functions

In a previous patent application (FLEXIBLE HIGH-SPEED GENERATION AND FORMATTING OF APPLICATION-SPECIFIED STRINGS, PCT/US2013/058410 filed 6 Sep. 2013 and its US counterpart application number 14425406 filed 1 Mar. 2015, incorporated herein by reference to the full extent permitted by applicable law), a method is described for identifying parameter specifiers in a format string used by, for example, the printf and sprintf functions. A jump table is described to permit rapid parsing of the format string to identify each ‘%’ parameter indicator, the end-of-string indicator, and various other characters that are processed.

Using SIMD registers allows a faster method to identify each ‘%’ parameter indicator. Once each ‘%’ is identified, the various flags and other commands related to that parameter are processed via jump tables as explained in the previous patent application. SIMD instructions are used to generate a mask, for several bytes at a time, that indicates the exact position of each parameter indicator in that section of the format string, thereby eliminating the need to inspect each byte one at a time to find the next parameter indicator.

This new method includes the following steps: determine the length of the format string (this can be done incrementally—process each block first by finding the terminating null, if any, and then process to find the ‘%’ characters as described herein; then process the each next block in the same way, until a null is found, and do not process any bytes beyond the null); using both SIMD and general-purpose registers, identify the next parameter indicator; copy static text from the format string to the output buffer 218; process the parameter flags and data as previously described; and repeat until the format string has been fully processed. With this new method, a very small amount of time is used to find a null character, and very little time is spent searching for the next parameter indicator.

As described elsewhere in the present disclosure, when using SIMD instructions to load and process multiple bytes simultaneously such as in this algorithm, it is desirable to access data bytes via aligned reads; a header code portion can handle the first unaligned bytes (if any), a middle function can handle the aligned sections, and a footer can handle the remaining bytes (if any) when the last portion is smaller than 16 bytes (or the size of the SIMD register being used, if other than xmm). The skilled implementer ensures that the data is accessed in aligned fashion and is able to make the changes to the steps described herein.

The following is a more detailed description of the steps used in this algorithm.

Needed variables and counters are initialized. BufPos 220 points to the location in the output buffer 218 where the next output characters 224 are to be placed; whenever characters are written to the output buffer, BufPos is adjusted appropriately so that all characters are always placed into the buffer in proper order. CurPos initially points to the start of the string. ParmOfs is used to point to each parameter indicator in the current block being processed, one at a time, as further described below. Cum is set to 0 and is adjusted after each next block of the format string is read so that it is equal to the number of bytes processed in all previous blocks; the value Cum+ParmOfs points to the position in the original format string that is equal to the position pointed to by ParmOfs in the current block being processed. ParmMask is a bit mask used to identify the position of the parameter indicators found in the portion of the format string currently being processed.

An xmm register (say, xmm5) is cleared and used to identify the terminating null for the format string. Another register (say, xmm4) is loaded such that each byte is equal to the format-indicator byte ‘%’ via a (V)MOVDQA instruction that loads the data from a 16-byte aligned memory location; this is used to determine the position of each format specifier in the string. The register xmm0 can be used to contain the characters of the current block being processed. Note that the skilled implementer may keep most or all of these variables in CPU registers for faster operation.

The alignment of the string is determined, such that aligned blocks and unaligned blocks are processed separately; a jump table can be used (similar to methods used for other algorithms explained in the present disclosure) to branch to the section of code that handles the first chunk of data. For aligned strings, every chunk will be 16 bytes long (when using xmm registers; it is larger when using larger registers), whereas unaligned chunks will be shorter. The last chunk (which could also be the first chunk) is determined when a null is present in the data, and is handled separately (control will branch to the .lastBlock address). For unaligned chunks, a process similar to that described below for aligned chunks is used; the skilled implementer will make the required adjustments to account for the fact that there are fewer than 16 bytes in the chunk being processed.

Using aligned reads via the (V)PMOVDQA function are fastest (with a bit-shifting instruction used, if needed, for the header portion), but using the (V)PMOVDQU and (V)PALIGNR instructions can also be used. Also, using the largest available registers is faster than using smaller ones; it is assumed for the rest of this description that 16-byte xmm registers are available and are used, although one of skill can readily adapt them for other-sized registers.

A label such as .getNextBlock indicates the top of the loop, where each aligned block is loaded and then tested for the terminating null and for parameter indicators. Each time a new block is loaded, Cum is increased by 16. Note that when the string is unaligned and the header portion is processed, it may be handled separately, after which variables and counters are adjusted as needed so that control can branch to the .getNextBlock address.

The label .lastBlock is branched to as soon as a null terminator is found. At .lastBlock, parameter indicators are identified (if any) and processed similar to the method described in this section, except that all processing stops at the point where the null is found; and any static characters that remain between the most recent position for CurPos and the end of the format string are copied to the output buffer, and a terminating null is written to the output buffer.

Each time a block of the format string is loaded, it is checked to see if a null terminator is present. Assuming the block is loaded into xmm0, the following code could be used:

| | | |
|---|---|---|
| pcmpeqb | xmm5, xmm0 | ; any null chars here? |

| | |
|---|---|
| ptest | xmm5, [.testBits] ; test |

| | | |
|---|---|---|
| jnz | .lastBlock | ; if yes, go to |

.lastBlock

The (V)PTEST instruction is used to see if any bits are set in the xmm5 register; it is tested against another xmm register or a memory area that has at least one bit set for each of the 16 bytes in the register. The .testBits variable is therefore a 16-byte-aligned area in memory containing 16 consecutive bytes with the value 0x80. Alternatively, the xmm3 register could used for the source, rather than the .testBits variable, if it is first initialized with bits in each byte; one simple method to do this uses the instruction:
pcmpeqb xmm3, xmm3

If a null exists in the data loaded into xmm0, the zero flag will be cleared and execution will branch to the .lastBlock address (which processes the characters from the last part of the format string). Otherwise, execution flows to the next instructions that process the data, which is processed as described in the previous patent application. Note that this works when xmm0 contains a full 16 bytes of valid characters from the format string. If processing the header portion containing fewer than 16 valid bytes, the bytes that are not part of the format string should each be treated in a manner to ensure each byte is not null; or, a different method can be used that respects the actual number of valid characters.

Next, the block is inspected to determine any and all parameter indicators in that chunk of the format string. Code similar to the following could be used:

| pcmpeqb | xmm0, xmm4 | |
|---|---|---|
| pmovmskb | eax, xmm0 | ; eax is now ParmMask |

.getNextParmOfs:

| | | |
|---|---|---|
| bsf | ecx, eax | ; ecx is now ParmOfs |

| | |
|---|---|
| jz | .getNextBlock |

.processCmd:

If there are no parameter indicators in the block in xmm0, control branches to .getNextBlock which is near the top of the loop; this is where variables are adjusted to show another block is to be loaded, and then it is loaded and tested for a null character, as above. Otherwise, control flows to the next instructions that process the format command.

At .processCmd, the value Cum+ParmOfs points to a valid ‘%’ parameter-indicator character. All characters between the position indicated by CurPos and the position indicated by (Cum+ParmOfs), if any, are copied to the output buffer, and BufPos is properly updated (the parameter indicator is not copied to the output). After the parameter indicator is processed as explained in the prior patent application, CurPos will point to the first character that is not part of the command characters related to the indicator just processed (i.e., to the first character that is to be copied when the next parameter indicator is identified or a null terminator is found).

Processing of the formatting instructions at the Cum+ParmOfs position of the format string is performed. Note that in the special case where two consecutive parameter-indicator ‘%’ characters are found, a ‘%’ character is written to the output buffer and CurPos is then equal to the position immediately after the second ‘%’ character. Alternatively, if desired, output of the ‘%’ character could be delayed and written with the next group of static characters. In either case, the position of the second ‘%’ character is skipped over (the bit can be reset, if desired, using a method similar to one of those shown below) and processing continues with identifying the position of the next parameter indicator.

ParmMask is then updated by clearing the bit representing the position ParmOfs that was just processed; this bit is the lowest set bit of ParmMask. To do so, a lookup table could be used that contains values that can be ANDed against ParmMask by using ParmOfs as an index. For example, a command similar to “ParmMask &=ClearMask[ParmOfs]” could be used, where each entry of ClearMask is created such that just one bit is cleared after the command. Alternatively, to keep the total code size smaller, and taking into account that ecx (and, therefore, the cl register) contains the position of the bit of ParmMask that is to be cleared, the following instructions could be used:

| | | |
|---|---|---|
| ror | eax, cl | ; shift bit just processed to offset 0 |
| and | eax, −2 | ; clear that bit |
| rol | eax, cl | ; and return adjusted mask |

| | |
|---|---|
| jmp | .getNextParmOfs |

If the BMI1 instruction set is available, the BSLR instruction can be the fastest way to clear the lowest set bit of ParmMask:

blsr eax, eax ; clear lowest set bit
jmp .getNextParmOfs

As soon as the flags and data for a parameter indicator have been processed, control jumps to the .getNextParmOfs address, where the BSF instruction is again applied against the mask to find the next parameter indicator. When no set bit is found (i.e., there are no more parameter indicators in the current block being processed), control transfers to .getNextBlock where the next 16-byte chunk (or block) of the format string is loaded and processed as indicated above.

When control branches to the .lastBlock address, a null has been found in the current block being inspected. The position of the null can be identified, and the main loop that is entered into can be similar to the following:

| .lastBlock: | | |
|---|---|---|
| ; This is the last block to process | | |
| pmovmskb | edx, xmm5 | ; edx is bit mask for null position |
| bsf | edx, edx | ; edx is now the position of the |
| null | | |
| pcmpeqb | xmm0, xmm4 ; process any parameter | |
| indicators | | |
| pmovmskb | eax, xmm0 | ; eax is now ParmMask |
| .getNextParmOfsLast: | | |
| bsf | ecx, eax | ; ecx is now ParmOfs |
| jz | .finish | ; no more, so copy any static text |
| and exit | | |
| ; but if we've passed the null, need to exit | | |
| cmp | eax, edx | |
| jae | .finish | ; exit if beyond end of format |
| string | | |

```
.processCmdLast:
    ; process this command
    ; should preserve eax, ecx, and edx... or use other
registers
    ;  to eliminate needed to preserve/restore GP regs
```

At this point, the parameter indicator is processed the same as for any other, as described above. Then, after CurPos is repositioned appropriately, the bit in ParmMask representing the ParmOfs just processed is cleared, and control loops up to .getNextParmOfsLast to see if there are still any parameter indicators to process. When there are no more, control branches to .finish:

```
    blsr eax, eax  ; clear lowest set bit
    jmp  .getNextParmOfsLast ; loop to see if more to do
.finish:
; copy any static text, terminate the output, exit
```

At this point, if CurPos is pointing to any character prior to the end of the format string, all the characters located from CurPos to the end to the string are copied to the output buffer, and a terminating null character is output at the end of the output. Control can then return to the caller.

Note that registers other than eax, ecx, and edx may be used in order to eliminate the need to preserve and restore these registers each time a parameter indicator is processed.

Hybrid Functions

If desired, a skilled implementer could produce a hybrid conversion function for a numeric-string conversion, once the number of valid bytes is first determined. A jump table would be used to branch to the best code, based on the number of valid digits discovered. For example, assume the following: a base-10 string is to be converted; 64-bit code is used; the number of valid digits is known and in rax; rcx points to the numeric string; and r8 contains the sign of the number. Then, the jump table could branch to the following addresses, for example, when there are 1 to 3 valid digits:

```
.d1: ; come here for 1 digit
    movzx  eax, byte [rcx]
    and  eax, 0x0f
    ret
.d2: ; come here for 2 digits
    movzx eax, byte [rcx]
    movzx r9d, byte [rcx+1]
    lea  eax,  [eax*4+eax]
    lea  eax,  [eax*2+r9d−0x330]
        ; after first byte is multiplied by 10, its value
    is
        ; too high by 0x300; and when second byte is
    added, its
        ; value is too high by 0x30; so adjust in one easy
    step
    ret
.d3: ; come here for 3 digits
    movzx eax, byte [rcx]
    movzx r9d, byte [rcx+1]
    lea  eax,  [eax*4+eax]
    lea  eax,  [eax*2+r9d−0x330]
    movzx r9d, byte [rcx+2]
    lea  eax,  [eax*4+eax]
    lea  eax,  [eax*2+r9d−0x30]
    ret
```

The various algorithms detailed herein could be tested to determine which algorithms, on average, are quickest for each size of numeric string; the jump table, used to branch based on the count, would direct the path to the best branch, based on the size, to handle the numeric conversion. It may turn out, for example, that the algorithm inside the Atoi_Mult function is fastest when there are more than 6 digits; if so, it would handle all counts GTE 6, and other methods, such as the above, would be used when there are fewer bytes.

Miscellaneous

The algorithms described in the present disclosure can be modified by one of skill to handle any desired base. The algorithm Atou64_Lea, for example, needs just a few changes; each base can have its own base table, as described herein, that provides information as to which characters are valid digits, and which are invalid. Here is a portion of code from the Atou64_Lea algorithm, and next to it is a modification to handle base 13:

```
.Digit8: ; part of base-10 conversion
    movzx  edx, byte [esi+12]
    ; Next is code to multiply eax by 10 and add digit
value
    lea  eax,  [eax*4+eax]
    lea  eax,  [eax*2+edx−‘0’]
```

In the above code, the two ‘lea’ instructions effectively multiply the eax accumulator by 10, and the value of the digit is also added to the result. Say, for some reason, a base-13 conversion is needed. To do so, the above code would be changed to look like this:

```
.Digit8:  ; part of base-13 conversion
    movzx  edx, byte [esi+12]
    ; Access the value from the new table
    movzx  edx, byte [BaseTbl.b13+edx]  ; get value from
.b13 table
    ; Next is code to multiply eax by 13 and add digit
value
    lea  ecx,  [eax*4+eax]  ; ecx is equal to eax*5, eax not
changed
    lea  eax,  [eax*8+ecx]  ; eax is now equal to eax*15
    add  eax,  edx ; the proper value from the .b13 table
```

Note that an extra register, ecx, is needed to do the above. But this requires a separate encoding for every base needed (which may not be bad, since it is rare to use a base other than bases 2, 8, 10, and 16).

Alternatively, once could simplify the above to use a MULTIPLY instruction to adjust the accumulator. This allows creation of a truly generic algorithm that uses MULTIPLY instructions, but still takes advantage of the fast structure afforded by the Atou64_Lea skeleton. If this is done, the appropriate Base can be specified in the function call. The appropriate table can be looked up (indexed by the base), along with the number of digits that could be encoded in a single accumulator (also indexed by the base). The main loop may then be just a single iteration. The core part, then would be similar to the following:

```
; prototype:
; long long Strtou64_Any(char *str, int radix, char
**haltChar);
; Before this point:
;  esi --> string
;  edi --> the selected base table
;  ebx = radix
;  ecx = count of digits processed
    ; Load the next digit, get its value from base table
    movzx  edx, byte [esi+ecx] ; edx is digit
    movzx  edx, byte [edi+edx] ; edx is now proper value
    ; Now, multiply accumulator (eax) by the base in a
manner that
    ;  does not modify edx (via IMUL instruction)
    ; RadixTbl is table of 32-bit values, one for
    ;  each radix expected (entries for radix 0 and 1
    ;  are equal to 0)
    imul eax, ebx  ; multiply accum by radix
    add  eax, edx  ; and add the new value
```

In addition, multiple accumulators may be needed; or, as soon as an accumulator has filled, it can be inserted into a master accumulator, and overflow checked for at that time. Then the accumulator can be reused. One of skill can make these adjustments, along with others that are a natural part of customizing algorithms to make them work properly, as is known in the art, combined with teachings from the present disclosure. This structure is slower than the other algorithms explained in detail in the present disclosure, but should still be noticeably faster than other algorithms used at the time this application is filed.

The section “Finding End of Significant Digits” discusses issues concerning data straddling the boundaries of a 64-byte cache line; on most modern Intel-compatible CPUs, a cache line is currently 64 bytes in size, an increase from the older 32-byte size. It is possible it could change in the future to become larger. It should not be an issue when memory is accessed with aligned reads and writes. And in the future, it is likely that the hardware issues with cache-line boundaries will diminish as technology advances.

Currently, it is known that accessing data via aligned reads and writes is always optimal. The cache-line issues are reportedly less pronounced on AMD CPUs, and Intel is reducing the impact in its newer releases.

The following macros 212 are used in some of the code shown above; they are used to push and pop multiple registers:

macro pushregs [reg] { push reg }
macro popregs [reg] { reverse pop reg }

These macros 212 are used to define functions, and allow code alignment to be specified:

```
macro func addr*, alVal=16 ; specify alignment value, else
use 16
{
    if used addr
        align alVal
        addr:
}
macro endf { end if }
```

Any time the edx:eax register pair is mentioned, in 64-bit software the rax register is used instead. 64-bit software uses 64-bit registers, which simplifies many of the examples listed in the present disclosure. And if it is desired to adapt the algorithms herein to handle 128-bit numbers, then the rdx:rax register pair can be used.

When the MOVBE instruction is supported on Intel-compatible CPUs, data can be read into (or written from) either a 32-bit or 64-bit register, with the bytes swapped to Big-Endian format; this can be quicker than a normal MOV followed by a BSWAP command. The algorithms described herein can be adapted for use on Big-Endian processors by one of skill by reversing the sequence of bytes, when needed, via MOVBE, BSWAP, (V)PSHUFB, or other commands. The inventions described in the present disclosure can be implemented for use on Big-Endian CPUs, such as ARM CPUs. The skilled implementer understands that the main issues between Big- and Little-Endian CPUs relates to the order in which bytes are stored in memory, and is able to make modifications as required to adapt the inventions to work just as well in the Big-Endian environment.

The (V)PSHUFB command can also be used to swap bytes in a xmm (or larger) register; at the same time, it can also shift and clear other bytes simultaneously; this is used in some of the algorithms described in the present disclosure.

Inside functions, there is often a loop point that is jumped to several times. Code execution can often be sped up by aligning the jump-target address such that it is 16-byte aligned; this can be done by adding NOP instructions before the function-entry point, for example. In other cases, code chunks can sometimes be sped up by ensuring the jump target is not so far into a 16-byte code segment that the instruction bytes for an instruction spill over into a new 16-byte chunk of code. If desired, the skilled implementer can test the impact of such alignment, plus the impact of aligning other jump locations, to determine the desired alignment for various jump targets.

In some cases, when a halt-char pointer is to be updated and no valid digit is found, instead of returning the position of the normal halt char, the address of the original string is returned to the caller.

For some CPU instructions, there are derivative versions that accomplish a similar function, sometimes using either different or additional registers. For example, the MOVDQA instruction can be used with xmm registers, whereas the VMOVDQA instruction can be used with either xmm or ymm instructions. To describe both of these, “(V)” is inserted immediately prior the command (such as “(V)MOVDQA”) to show that either one accomplishes the intended instruction; the skilled implementer will determine which command is appropriate based on the execution environment in which the implementation is to run. In some cases, there are alternative CPU instructions that also accomplish a similar function. The (V) pattern is intended to apply to all CPU instructions (such as PSHUFB, MOVMSKB, etc.) in the present disclosure, whether explicitly stated or not.

Speed timings and comparisons mentioned herein compare versions of code executing in a 32-bit execution environment, unless stated otherwise.

Some functions use the ‘alignf’ macro; this FASM macro aligns the specified address to a 16-byte-aligned offset in memory, making the target address a bit faster to access in some cases. The macro 212 is the following:

```
macro alignf TargetToAlign
{
; This does 16-byte alignment at this point to ensure that
the
; forward label TargetToAlign is 16-byte aligned
    times 16 − (($ + rva TargetToAlign − @f) and 15) nop
    @@:
}
```

In some cases, complex CPU instructions are used that operate on bytes in memory (they are complex because they load or write a memory object and also perform additional processing on the data). The execution speed can sometimes slightly increase by separating the complex command into two: the first command will read the bytes from memory into a register, and the second will perform the instruction using the register instead of directly accessing memory. This can apply to all the algorithms detailed in the present disclosure; the skilled implementer wanting the fastest speed could test alternative implementations in order to select the fastest.

Some of the algorithms use identical static tables or data structures that are duplicated in the present disclosure. If desired, these could be identified and combined by the skilled implementer to thereby reduce the total amount of memory otherwise required.

When AVX commands are available, the (V) form of the instructions can sometimes permit use of a version of the instruction that does not alter the specified source registers, but instead uses a different register for the destination. This can reduce the number of instructions required and speed up processing by eliminating instructions that are otherwise required to preserve, restore, and/or reload SIMD registers.

Those of skill will recognize that a given piece of information may be equally well presented and understood either as remarks (a.k.a. comments) within a source code listing or as prose text within the present specification. Accordingly, in some places text given in the form of source code remarks in an incorporated application has be reformatted and presented herein as prose text interspersed with the listing at the same location within the listing but without syntactic markers for remarks (e.g., leading semicolon) in order to better satisfy USPTO format requirements. Applicant reserves the right to reformat text in either direction (source code remarks to prose, or vice versa), as doing so is merely ministerial and does not add any new matter to the disclosure.

Those of skill will also acknowledge that text describing any step or action herein may be presented in addition as a step label in a flowchart without thereby adding new matter. Any step described herein may be performed in any order relative to any other step, unless that makes the process in question inoperable. As indicated in FIG. 3, a process may include performing 302 focal aspect step(s) 304_, using 306 focal aspect data structures 202 such as tables 204_, and/or executing other steps 308 which are stated herein but not necessarily given their own reference numeral designation.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. Reference numbers ending in underscore are category numbers which denote all reference numbers having the indicated root, e.g., 204_{—} denotes all reference numbers pertaining to tables. In such categories, the reference number without a trailing underscore or letter denotes all items in the category, e.g., 204 by itself denotes all tables, whether they have a reference number ending in a letter or not. The inventor asserts and exercises his right to his own lexicography. Quoted terms are defined explicitly, but quotation marks are not used when a term is defined implicitly. Terms may be defined, either explicitly or implicitly, here in the Detailed Description and/or elsewhere in the application file.

Although particular embodiments are expressly illustrated and described herein as processes, as configured media, or as systems, it will be appreciated that discussion of one type of embodiment also generally extends to other embodiment types. For instance, the descriptions of processes also help describe configured media, and help describe the technical effects and operation of systems and manufactures. It does not follow that limitations from one embodiment are necessarily read into another. In particular, processes are not necessarily limited to the data structures and arrangements presented while discussing systems or manufactures such as configured memories.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole.

As used herein, terms such as “a” and “the” are inclusive of one or more of the indicated item or step. In particular, in the claims a reference to an item generally means at least one such item is present and a reference to a step means at least one instance of the step is performed.

Headings are for convenience only; information on a given topic may be found outside the section whose heading indicates that topic.

All claims and the abstract, as filed, are part of the specification.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A method comprising performing at least one focal aspect, where the focal aspect is one of the “focal aspects” defined as such herein.

2. The method of claim 1, comprising performing at least two of the focal aspects.

3. The method of claim 1, comprising performing at least three of the focal aspects.

4. The method of claim 1, comprising performing at least four of the focal aspects.

5. The method of claim 1, comprising performing at least five of the focal aspects.

6. The method of claim 1, comprising performing at least six of the focal aspects.

7. The method of claim 1, comprising performing at least seven of the focal aspects.

8. A computer-readable medium configured by instructions which upon execution perform a method comprising at least one of the defined focal aspects.

9. The computer-readable medium of claim 8, wherein the method comprises performing at least two of the focal aspects.

10. The computer-readable medium of claim 8, wherein the method comprises performing at least three of the focal aspects.

11. The computer-readable medium of claim 8, wherein the method comprises performing at least four of the focal aspects.

12. The computer-readable medium of claim 8, wherein the method comprises performing at least five of the focal aspects.

13. The computer-readable medium of claim 8, wherein the method comprises performing at least six of the focal aspects.

14. A system comprising at least one processor and a memory in operable communication with the processor, instructions and adat residing in the menoty computer-readable medium configured by instructions which upon execution perform a method comprising at least one of the defined focal aspects and/or define at least one table or other data structure recited in the definition of the focal aspects.

15. The system of claim 14, wherein the memory holds at least two of the following: one or more methods which comprise performing at least one focal aspect, one or more tables or other data structures recited in the definition of the focal aspects.

16. The system of claim 14, wherein the memory holds at least three of the following: one or more methods which comprise performing at least one focal aspect, one or more tables or other data structures recited in the definition of the focal aspects.

17. The system of claim 14, wherein the memory holds at least four of the following: one or more methods which comprise performing at least one focal aspect, one or more tables or other data structures recited in the definition of the focal aspects.

18. The system of claim 14, wherein the memory holds at least five of the following: one or more methods which comprise performing at least one focal aspect, one or more tables or other data structures recited in the definition of the focal aspects.

19. The system of claim 14, wherein the memory holds at least six of the following: one or more methods which comprise performing at least one focal aspect, one or more tables or other data structures recited in the definition of the focal aspects.

20. The system of claim 14, wherein the memory holds at least seven of the following: one or more methods which comprise performing at least one focal aspect, one or more tables or other data structures recited in the definition of the focal aspects.
